(19) United States
(12) Patent Application Publication
(10) Pub. No.: US 2026/0351811 A1
(43) Pub. Date: Nov. 5, 2026

(54) Secondary Battery

(71) Applicant: LG Energy Solution, Ltd., Seoul (KR)

(72) Inventors: Hyun Hee Lee, Daejeon (KR); Sang Joon Park, Daejeon (KR); Hyun Jung Suh, Daejeon (KR)

(73) Assignee: LG Energy Solution, Ltd., Seoul (KR)

(21) Appl. No.: 19/578,553

(22) Filed: Mar. 25, 2026

(30) Foreign Application Priority Data
Apr. 22, 2025 (KR) 10-2025-0052610
Nov. 26, 2025 (KR) 10-2025-0182411
Dec. 26, 2025 (KR) 10-2025-0210849
Feb. 12, 2026 (KR) 10-2026-0028381
Mar. 24, 2026 (KR) 10-2026-0052537

(51) Int. Cl. H01M 50/536

(52) U.S. Cl. CPC H01M 50/536

(57) ABSTRACT

A secondary battery capable of reducing a risk of damage to a separator includes an electrode assembly and a current collector. The current collector includes a current collecting unit and a pole unit, where the pole unit includes a support portion coupled to an end of a current collecting protrusion. The support portion has a greater cross-sectional area than the current collecting protrusion and is accommodated in an opening of a plate of the current collecting unit. A stopper having an upper surface spaced above the plate of the current collecting unit may be positioned adjacent to the current collecting protrusion of the pole unit.

### CROSS-REFERENCE TO RELATED APPLICATION

The present application claims priority from Korean Patent Application Nos. 10-2025-0052610, filed on Apr. 22, 2025, 10-2025-0182411, filed on Nov. 26, 2025, 10-2025-0210849, filed on Dec. 26, 2025, 10-2026-0028381, filed on Feb. 12, 2026, and 10-2026-0052537, filed on Mar. 24, 2026, all of which are incorporated herein by reference.

### BACKGROUND

### 1. Technical Field

The present disclosure relates to a secondary battery, and more particularly, to a secondary battery capable of reducing a risk of damage to a separator.

### 2. Related Art

Recently, as the demand for portable electronic devices has rapidly increased and the development of electric vehicles, energy storage batteries, robots, satellites, and the like has become more active, intensive research has been conducted on high-performance secondary batteries capable of repeated charging and discharging.

Secondary batteries may be classified, according to the shape of a battery casing, into a can-type secondary battery, in which an electrode assembly is embedded in a metal can, and a pouch-type secondary battery, in which an electrode assembly is embedded in a pouch formed of an aluminum laminate sheet. The can-type secondary battery may also be classified into a cylindrical secondary battery and a prismatic secondary battery according to the shape of the metal can.

In a secondary battery, an electrode tab of an electrode assembly and a current collector are coupled to each other by welding. When the electrode tab is coupled to the current collector, the electrode tab is bent in a bending direction to increase a contact area between the electrode tab and the current collector, after which the current collector is seated on and welded to an upper portion of the electrode tab.

However, in this case, there is a risk that a separator may be damaged during a process of welding a current collector to an electrode tab disposed under the current collector. In addition, as a secondary battery increases in capacity, the number of electrode tabs that are required to be welded at one time increases, and thus, there is a risk that electrode tabs spaced apart from the current collector may not be properly welded.

Accordingly, further development and improvement of welding aspects of secondary batteries may be desirable.

### SUMMARY

According to one aspect of the disclosure the current collector may include a current collector unit, a pole unit, and a stopper. The stopper can be integrated with the current collector unit, the pole unit, or exist as a distinct element. The term stopper may encompass but is not limited to a flange, a washer, a stepped surface, a bent surface, a bent portion, or any equivalent that person of ordinary skill would recognize. These terms and concepts may be considered interchangeable throughout the disclosure.

In one aspect, the stopper may be adjacent to an opening of the current collector and define an upper surface spaced above an upper surface of the current collector.

For instance, the stopper may be part of the current collector unit, and it may be provided by a stepped surface of the upper surface of the current collector unit. In another aspect, it may be provided by a bent surface of the current collector unit that inclines above an upper surface of the current collector unit.

In another aspect, the stopper may be part of the pole unit that may also include a support part and a current collecting protrusion.

For instance, the stopper may be part of an upper surface of the support part of the pole unit. In another aspect, the stopper may be a protruding structure between the current collecting protrusion and the support part, such that it may be disposed on or at least partially received in a surface of the current collecting unit. For instance, an upper surface of the stopper may be flush with an upper surface of the current collecting unit or extend above so as to define a step or flange.

In another aspect, the stopper may be provided by a distinct structure such as a washer, a flange, or any equivalent that person of ordinary skill would recognize.

In another aspect, a height of the stopper is equal to or greater than a height of the plurality of first and second electrode tabs that are bent over and welded to the current collector unit. As a result, the stopper may provide height to compensate for the height of the tabs welded to the current collector, so as to prevent improper leveling when one or more components (e.g., a cap plate and/or terminals of a cap assembly) are placed above the current collector having the tabs welded thereon. That is, the stopper may abut the underside of the other component to prevent that component from contacting the welded tabs or to prevent that component from canting due to any differences in height between multiple groups of welded tabs, which may in turn reduce airtightness of the assembled secondary battery or lead to an assembly defect.

Accordingly, among others, an object of at least some aspects of the present disclosure is to provide a secondary battery capable of preventing influence on an electrode assembly arising from welding of electrode tabs to a current collector.

Another object of at least some aspects of the present disclosure is to provide a secondary battery capable of stably welding a relatively large number of electrode tabs to the current collector during welding of the electrode tabs to the current collector.

Another object of at least some aspects of the present disclosure is to provide a secondary battery capable of stably coupling a current collecting protrusion to the current collector.

Still another object of at least some aspects of the present disclosure is to provide a secondary battery capable of simplifying an assembly process of the secondary battery.

A secondary battery according to an aspect of the present disclosure may include an electrode assembly, a current collector, and a casing. The electrode assembly may include at least one electrode tab extending outwardly therefrom; the current collector may be electrically coupled to the at least one electrode tab; and the casing may receive the electrode assembly and the current collector therein. The current collector may include a current collecting unit and a pole unit coupled together. The current collecting unit may include a plate having an opening therein. The pole unit may include a current collecting protrusion and a support portion coupled to an end of the current collecting protrusion. In an aspect, the current collecting protrusion may extend away from the support portion along a central axis of the pole unit, and a cross-sectional area of the support portion may be greater than a cross-sectional area of the current collecting protrusion along a plane perpendicular to the central axis. Further, the support portion may be least partially accommodated in the opening and secured within the opening by a welding region disposed between a periphery of the support portion and a perimeter of the opening.

According to an aspect, the welding region may be disposed along an entirety of the perimeter of the opening.

According to an aspect, the opening may define a through hole extending through the current collecting unit, or a blind hole terminating within the current collecting unit.

According to an aspect, the opening may communicate with a recessed region defined in a lower surface of the current collecting unit, the recessed region having a larger cross-sectional area along a plane perpendicular to the central axis than the opening.

According to an aspect, the support portion may be at least partially accommodated within the recessed region, or fully accommodated within the recessed region.

According to an aspect, a depth of the recessed region may range from 30% to 50% of a height of the plate of the current collecting unit.

According to an aspect, the current collector may further include a stopper adjacent to the opening. The stopper may have an upper surface spaced above an upper surface of the plate along an axial direction parallel to the central axis of the pole unit.

According to an aspect, the stopper may be a portion of the current collector unit.

According to an aspect, the upper surface of the stopper may be provided by an upper surface of a portion of the current collecting unit that circumscribes the opening.

According to an aspect, the upper surface of the stopper may be flush with an upper surface of the support portion.

According to an aspect, the opening may define a through hole extending through the current collecting unit. The opening may communicate with a recessed region defined in a lower surface of the current collecting unit. For instance, the recessed region may have a larger cross-sectional area along a plane perpendicular to the central axis than the opening, and a cross-sectional area of the recessed region may be smaller than a cross-sectional area of the stopper.

According to an aspect, a depth of the recessed region may be equal to or greater than a height of an end of the current collecting unit.

According to an aspect, a lower surface of the support portion may be positioned above the lower surface of the current collecting unit.

According to an aspect, the stopper may be a portion of the pole unit.

According to an aspect, the upper surface of the stopper may be provided by an upper surface of the support portion.

According to an aspect, the stopper may be disposed between the current collecting protrusion and the support portion. For instance, a cross-sectional area of the stopper may be greater than a cross-sectional area of the protrusion portion and different than the cross-sectional area of the support portion along a plane perpendicular to the central axis.

According to an aspect, a lower surface of the current collecting unit may be flush with a lower surface of the support portion.

According to an aspect, a nickel plating layer may be formed on an upper end of the current collecting protrusion.

According to an aspect, the current collecting unit may further include a first current collecting portion; a second current collecting portion; and a connection portion. The first current collecting portion may be coupled to a plurality of first electrode tabs, the second current collecting portion may be coupled to a plurality of second electrode tabs, and the connection portion may be connected to the first current collecting portion and may include the opening.

According to another aspect, the plurality of first electrode tabs may be bent toward an upper surface of the first current collecting portion, and the plurality of second electrode tabs may bent toward an upper surface of the second current collecting portion in a direction opposite to a direction in which the plurality of first electrode tabs are bent; and a separation distance between the plurality of first electrode tabs and the plurality of second electrode tabs may be 5% to 15% of a length of the current collector.

According to another aspect, the plurality of first electrode tabs may be welded to the first current collecting portion, and the plurality of second electrode tabs may be welded to the second current collecting portion.

According to another aspect, the secondary battery may further include a case in which the electrode assembly is accommodated and has an opening located at one end thereof; and a cap assembly sealing the opening of the case and including a cap plate and a terminal, where the current collecting protrusion may be inserted into a through-hole of the terminal.

According to another aspect, the current collecting protrusion and the through-hole may be welded to each other at an end of the current collecting protrusion.

A secondary battery according to another aspect of the present disclosure may include an electrode assembly, a current collector, and a casing. The electrode assembly may include a plurality of electrode tabs extending outwardly therefrom; a current collector electrically coupled to the plurality of electrode tabs; and a casing receiving the electrode assembly and the current collector therein. The current collector may include a current collecting unit; a pole unit coupled to the current collecting unit; and a stopper. The current collecting unit may include a plate having a seating region coupled to the pole unit; and the pole unit may include a current collecting protrusion coupled to the current collecting unit so as to extend away from the current collecting unit along a central axis of the pole unit. The stopper may be positioned adjacent to the seating region, the stopper having an upper surface spaced above an upper surface of the plate along an axial direction parallel to the central axis of the pole unit. A distance between the upper surface of the stopper and the upper surface of the plate may be equal to or greater than a height of the plurality of electrode tabs. A portion of the plurality of electrode tabs stacked on the upper surface of the plate along the axial direction may define the height of the plurality of electrode tabs.

According to an aspect, the seating region may having an opening in the plate. The pole unit may further include a support portion coupled to a lower end of the current collecting protrusion and at least partially accommodated in the opening.

According to an aspect, the seating region may be recessed downward from the upper surface of the plate of the current collecting unit. A depth of the seating region may range from 30% to 50% of a height of the plate of the current collecting unit.

According to an aspect, the stopper may be provided by an upper surface of the support portion.

According to an aspect, an upper surface of the stopper may be flush with an upper surface of the support portion.

According to an aspect, the opening may define a through hole extending through the current collecting unit. The opening may communicate with a recessed region defined in a lower surface of the current collecting unit. For instance, the recessed region may have a larger cross-sectional area along a plane perpendicular to the central axis than the opening, and a cross-sectional area of the recessed region may be smaller than a cross-sectional area of the stopper.

According to an aspect, the stopper may be a portion of the current collector unit.

According to an aspect, the upper surface of the stopper may be provided by an upper surface of a portion of the current collecting unit that circumscribes the opening.

According to an aspect, the stopper may have a square plate shape, a rectangular plate shape, or a disc shape.

According to an aspect, a height of the stopper may range from 30% to 120% of a height of the plate of the current collecting unit.

According to an aspect, a height of the stopper may range from 1% to 5% of a thickness of the electrode assembly.

According to an aspect, the stopper may be provided by a portion of the plate of the current collecting unit bent upward from a current collecting portion of the plate. The current collecting portion may be coupled to the electrode tab of the electrode assembly.

According to an aspect, an upper surface of the seating region may be flush with the upper surface of the plate of the current collecting unit and may be coupled to a lower surface of the current collecting protrusion.

According to an aspect, the current collecting unit may include a first current collecting portion; a second current collecting portion; and a connection portion. The plurality of electrode tabs may include a plurality of first electrode tabs and a plurality of second electrode tabs. The first current collecting portion may be coupled to the plurality of first electrode tabs, the second current collecting portion may coupled to the plurality of second electrode tabs, and the connection portion may be connected to the first current collecting portion and may include the seating region on an upper surface thereof.

According to an aspect, a distance between the upper surface of the stopper and the upper surface of the plate may be equal to or greater than the height of the plurality of first electrode tabs and the height of the plurality of second electrode tabs.

According to an aspect, the stopper may be a portion of the pole unit.

According to an aspect, the stopper may be disposed between the current collecting protrusion and the support portion. For instance, a cross-sectional area of the stopper may be greater than a cross-sectional area of the protrusion portion and different than the cross-sectional area of the support portion along a plane perpendicular to the central axis.

According to an aspect, a cross-sectional area of the stopper may be greater than a cross-sectional area of the current collecting protrusion along a plane perpendicular to the central axis.

According to an aspect, a nickel plating layer may be formed on an upper end of the current collecting protrusion.

According to another aspect, the plurality of first electrode tabs may be bent toward an upper surface of the first current collecting portion, and the plurality of second electrode tabs may bent toward an upper surface of the second current collecting portion in a direction opposite to a direction in which the plurality of first electrode tabs are bent; and a separation distance between the plurality of first electrode tabs and the plurality of second electrode tabs may be 5% to 15% of a length of the current collector.

According to another aspect, the plurality of first electrode tabs may be welded to the first current collecting portion, and the plurality of second electrode tabs may be welded to the second current collecting portion.

According to another aspect, the secondary battery may further include a case in which the electrode assembly is accommodated and has an opening located at one end thereof; and a cap assembly sealing the opening of the case and including a cap plate and a terminal, where the current collecting protrusion may be inserted into a through-hole of the terminal.

According to another aspect, the current collecting protrusion and the through-hole may be welded to each other at an end of the current collecting protrusion.

### BRIEF DESCRIPTION OF THE DRAWINGS

FIG. 1 is a perspective view illustrating a secondary battery according to a first aspect of the present disclosure.

FIG. 2 is an exploded perspective view illustrating a cap assembly separated from the secondary battery according to the first aspect of the present disclosure.

FIG. 3 is a perspective view illustrating an electrode assembly in which a plurality of first electrode tabs and a plurality of second electrode tabs are formed on an electrode portion in the secondary battery according to the first aspect of the present disclosure.

FIGS. 4A and 4B are side elevation views illustrating a first electrode element and a second electrode element, respectively, in the secondary battery according to the first aspect of the present disclosure.

FIGS. 5A and 5B are side elevation views illustrating a third electrode element and a fourth electrode element, respectively, in the secondary battery according to the first aspect of the present disclosure.

FIG. 6 is an exploded perspective view illustrating a cap assembly separated from opposing sides of the secondary battery according to another example of the first aspect of the present disclosure.

FIG. 7 is a perspective view illustrating an electrode assembly in which a plurality of first electrode tabs and a plurality of second electrode tabs are formed on opposing sides of an electrode portion in the secondary battery according to the other example of the first aspect of the present disclosure.

FIG. 8 is an exploded perspective view illustrating the current collector spaced apart from the plurality of first electrode tabs that have been primarily welded and the plurality of second electrode tabs that have been primarily welded in the secondary battery according to the first aspect of the present disclosure.

FIG. 9 is a perspective view illustrating the first and second electrode tabs welded to the current collector in the secondary battery according to the first aspect the present disclosure.

FIG. 10 is a cross-sectional view of a secondary battery according to the first aspect of the present disclosure.

FIG. 11 is a perspective view illustrating a current collector in the secondary battery according to the first aspect of the present disclosure.

FIG. 12 is a side elevation view illustrating the current collector in the secondary battery according to the first aspect of the present disclosure.

FIG. 13 is a cross-sectional view taken along line A-A′ of FIG. 12.

FIG. 14 is a cross-sectional view illustrating a current collecting unit of the current collector of FIG. 13 according to the first aspect of the present disclosure.

FIG. 15A is a cross-sectional view illustrating a pole unit of the current collector of FIG. 13 according to the first aspect of the present disclosure.

FIG. 15B is a side elevation view of the pole unit of FIG. 15A, illustrating a nickel plating layer formed on an upper end of the current collecting protrusion.

FIG. 16 includes sequential cross-sectional views illustrating a process of assembling the current collecting unit with the pole unit in the first aspect of the present disclosure.

FIG. 17 is a bottom plan view illustrating a welding region on a lower surface of the current collecting unit in the secondary battery according to the first aspect of the present disclosure.

FIG. 18 is a bottom plan view illustrating a different example of a welding region on the lower surface of the current collecting unit in the secondary battery according to the first aspect of the present disclosure.

FIG. 19 is a perspective view illustrating a connection portion and a pole unit in a current collector of a secondary battery according to a second aspect of the present disclosure.

FIG. 20 is a cross-sectional view taken along line B-B′ of FIG. 19.

FIG. 21 is a cross-sectional view illustrating a current collecting unit of the current collector of FIG. 20 according to the second aspect of the present disclosure.

FIG. 22A is a cross-sectional view illustrating a pole unit of the current collector of FIG. 20 according to the second aspect of the present disclosure.

FIG. 22B is a side elevation view of the pole unit of FIG. 22A, illustrating a nickel plating layer formed on an upper end of the current collecting protrusion.

FIG. 23 includes sequential cross-sectional views illustrating a process of assembling the current collecting unit with the pole unit in the second aspect of the present disclosure.

FIG. 24 is a bottom plan view illustrating a welding region on a lower surface of the current collecting unit in the secondary battery according to the second aspect of the present disclosure.

FIG. 25 is a perspective view illustrating a current collector in a secondary battery according to a third aspect of the present disclosure.

FIG. 26 is a cross-sectional view taken along line C-C′ of FIG. 25.

FIG. 27 is a cross-sectional view illustrating a current collecting unit of the current collector of FIG. 26 according to the third aspect of the present disclosure.

FIG. 28A is a cross-sectional view illustrating a pole unit of the current collector of FIG. 26 according to the third aspect of the present disclosure.

FIG. 28B is a side elevation view of the pole unit of FIG. 28A, illustrating a nickel plating layer formed on an upper end of the current collecting protrusion.

FIG. 29 includes sequential cross-sectional views illustrating a process of assembling the current collecting unit with the pole unit in the third aspect of the present disclosure.

FIG. 30 is a bottom plan view illustrating a welding region on a lower surface of the current collecting unit in the secondary battery according to the third aspect of the present disclosure.

FIG. 31 is a side cross-sectional view illustrating a current collector in a secondary battery according to a fourth aspect of the present disclosure.

FIG. 32 is a side cross-sectional view illustrating a current collecting unit of the current collector of FIG. 31 according to the fourth aspect of the present disclosure.

FIG. 33A is a side cross-sectional view illustrating a pole unit of the current collector of FIG. 31 according to the fourth aspect of the present disclosure.

FIG. 33B is a side elevation view of the pole unit of FIG. 33A, illustrating a nickel plating layer formed on an upper end of the current collecting protrusion.

FIG. 34 includes sequential cross-sectional views illustrating a process of assembling the current collecting unit with the pole unit in the fourth aspect of the present disclosure.

FIG. 35 is a bottom plan view illustrating a welding region on a lower surface of the current collecting unit in the secondary battery according to the fourth aspect of the present disclosure.

FIG. 36 is a side cross-sectional view illustrating a current collector in a secondary battery according to a fifth aspect of the present disclosure.

FIG. 37 is a side cross-sectional view illustrating a current collecting unit of the current collector of FIG. 36 according to the fifth aspect of the present disclosure.

FIG. 38A is a side cross-sectional view illustrating a pole unit of the current collector of FIG. 36 according to the fifth aspect of the present disclosure.

FIG. 38B is a side elevation view of the pole unit of FIG. 38A, illustrating a nickel plating layer formed on an upper end of the current collecting protrusion.

FIG. 39 includes sequential cross-sectional views illustrating a process of assembling the current collecting unit with the pole unit in the fifth aspect of the present disclosure.

FIG. 40 is a bottom plan view illustrating a welding region on a lower surface of the current collecting unit in the secondary battery according to the fifth aspect of the present disclosure.

FIG. 41 is a perspective view illustrating a current collector in a secondary battery according to a sixth aspect of the present disclosure.

FIG. 42 is a side elevation view illustrating the current collector in the secondary battery according to the sixth aspect of the present disclosure.

FIG. 43 is a side elevation view illustrating a process of assembling a current collecting unit with a pole unit in the sixth aspect of the present disclosure.

FIG. 44 is a bottom plan view illustrating a welding region on a lower surface of the current collecting unit in the secondary battery according to the sixth aspect of the present disclosure.

FIG. 45 is a bottom plan view illustrating a different example of a welding region on the lower surface of the current collecting unit in the secondary battery according to the sixth aspect of the present disclosure.

FIG. 46 is a side cross-sectional view illustrating a current collector in a secondary battery according to a seventh aspect of the present disclosure.

FIG. 47 is a side cross-sectional view illustrating a current collecting unit of the current collector of FIG. 46 according to the seventh aspect of the present disclosure.

FIG. 48A is a side cross-sectional view illustrating a pole unit of the current collector of FIG. 46 according to the seventh aspect of the present disclosure.

FIG. 48B is a side elevation view of the pole unit of FIG. 48A, illustrating a nickel plating layer formed on an upper end of the current collecting protrusion.

FIG. 49 includes sequential side cross-sectional views illustrating a process of assembling the current collecting unit with the pole unit in the seventh aspect of the present disclosure.

FIG. 50 is an enlarged side cross-sectional view of an assembled relationship between the pole unit and the current collecting unit of FIG. 49.

FIG. 51 is a bottom plan view illustrating a welding region on a lower surface of the current collecting unit in the secondary battery according to the seventh aspect of the present disclosure.

FIG. 52 is a side cross-sectional view illustrating a current collector in a secondary battery according to a eighth aspect of the present disclosure.

FIG. 53 is a side cross-sectional view illustrating a current collecting unit of the current collector of FIG. 52 according to the eighth aspect of the present disclosure.

FIG. 54A is a side cross-sectional view illustrating a pole unit of the current collector of FIG. 52 according to the eighth aspect of the present disclosure.

FIG. 54B is a side elevation view of the pole unit of FIG. 54A, illustrating a nickel plating layer formed on an upper end of the current collecting protrusion.

FIG. 55 includes sequential side cross-sectional views illustrating a process of assembling the current collecting unit with the pole unit in the eighth aspect of the present disclosure.

FIG. 56 is a bottom plan view illustrating a welding region on a lower surface of the current collecting unit in the secondary battery according to the eighth aspect of the present disclosure.

FIG. 57 is a side cross-sectional view illustrating a current collector in a secondary battery according to a ninth aspect of the present disclosure.

FIG. 58 is a side cross-sectional view illustrating a current collecting unit of the current collector of FIG. 57 according to the ninth aspect of the present disclosure.

FIG. 59A is a side cross-sectional view illustrating a pole unit of the current collector of FIG. 57 according to the ninth aspect of the present disclosure.

FIG. 59B is a side elevation view of the pole unit of FIG. 59A, illustrating a nickel plating layer formed on an upper end of the current collecting protrusion.

FIG. 60 includes sequential cross-sectional views illustrating a process of assembling the current collecting unit with the pole unit in the ninth aspect of the present disclosure.

FIG. 61 is a side cross-sectional view illustrating a different example of a current collector in a secondary battery according to a ninth aspect of the present disclosure, in which a lower surface of the pole unit is recessed upwardly relative to the lower surface of the current collecting unit.

FIG. 62 is a bottom plan view illustrating a welding region on a lower surface of the current collecting unit in the secondary battery according to the ninth aspect of the present disclosure.

FIG. 63 is a side cross-sectional view illustrating a current collector in a secondary battery according to a tenth aspect of the present disclosure.

FIG. 64 is a side cross-sectional view illustrating a current collecting unit of the current collector of FIG. 62 according to the tenth aspect of the present disclosure.

FIG. 65A is a side cross-sectional view illustrating a pole unit of the current collector of FIG. 62 according to the tenth aspect of the present disclosure.

FIG. 65B is a side elevation view of the pole unit of FIG. 65A, illustrating a nickel plating layer formed on an upper end of the current collecting protrusion.

FIG. 66 includes sequential cross-sectional views illustrating a process of assembling the current collecting unit with the pole unit in the tenth aspect of the present disclosure.

FIG. 67 is a bottom plan view illustrating a welding region on a lower surface of the current collecting unit in the secondary battery according to the tenth aspect of the present disclosure.

FIG. 68 is a perspective view illustrating a current collector in a secondary battery according to a eleventh aspect of the present disclosure.

FIG. 69A is a perspective view illustrating the first and second electrode tabs welded to the current collector in the secondary battery according to the eleventh aspect of the present disclosure, in which the electrode tabs and current collector are disposed along a top surface of the secondary battery.

FIG. 69B is a perspective view illustrating the first and second electrode tabs welded to the current collector in the secondary battery according to the eleventh aspect of the present disclosure, in which the electrode tabs and current collector are disposed along a side surface of the secondary battery.

FIG. 70 is a cross-sectional view of a secondary battery according to the eleventh aspect of the present disclosure.

FIGS. 71A and 71B are perspective views illustrating different examples of a current collector in a secondary battery according to a twelfth aspect of the present disclosure.

FIG. 72A is a perspective view illustrating the current collector of FIG. 71A disposed along a top surface of a secondary battery and welded to the first and second electrode tabs.

FIG. 72B is a perspective view illustrating the current collector of FIG. 71B disposed along a side surface of a secondary battery and welded to the first and second electrode tabs.

FIG. 73 is a cross-sectional view of a secondary battery according to the twelfth aspect of the present disclosure.

FIG. 74A is a perspective view illustrating the current collector of FIG. 71A disposed along a side surface of the secondary battery and welded to the first and second electrode tabs.

FIG. 74B is a perspective view illustrating the current collector of FIG. 71B disposed along a side surface of the secondary battery and welded to the first and second electrode tabs.

FIG. 75 is a flowchart illustrating a method of manufacturing the secondary battery according to the first aspect of the present disclosure.

FIG. 76 is a top plan view of a portion of an electrode assembly illustrating a plurality of first electrode tabs and a plurality of second electrode tabs that are separately grouped in the secondary battery according to the first aspect of the present disclosure.

FIG. 77 is a perspective view of a portion of an electrode assembly illustrating the plurality of first electrode tabs that are primarily welded and the plurality of second electrode tabs that are primarily welded in the secondary battery according to the first aspect of the present disclosure.

FIG. 78 is a top plan view illustrating the current collector disposed between the plurality of first electrode tabs that are primarily welded and the plurality of second electrode tabs that are primarily welded in the secondary battery according to the first aspect of the present disclosure.

FIG. 79 is a perspective view illustrating the first and second electrode tabs welded to the current collector in the secondary battery according to the first aspect of the present disclosure.

FIG. 80 is a perspective view illustrating the cap assembly coupled to the electrode assembly in the secondary battery according to the first aspect of the present disclosure.

### DETAILED DESCRIPTION

Since the present disclosure may be modified in various forms, and may have various aspects, particular aspects will be illustrated in the accompanying drawings and described in detail with reference to the drawings. However, this is not intended to limit the present disclosure to particular modes of practice, and it is to be appreciated that all changes, equivalents, and substitutes that do not depart from the spirit and technical scope of the present disclosure are encompassed in the present disclosure.

The terminology used herein is for the purpose of describing particular aspects only and is not intended to be limiting the present disclosure. In the present disclosure, the singular forms are intended to include the plural forms as well, unless the context clearly indicates otherwise. It will be further understood that the terms “comprise”, “include”, “have”, etc. when used in this specification, are intended to specify the presence of stated features, integers, steps, operations, elements, components, and/or combinations of them but do not preclude the presence or addition of one or more other features, integers, steps, operations, elements, components, and/or combinations thereof.

Hereinafter, aspects of the present disclosure will be described in detail with reference to the accompanying drawings. It should be noted that like reference numerals refer to like elements throughout the attached drawings. Details of well-known configurations and functions may be omitted to avoid unnecessarily obscuring the gist of the present disclosure. For the same reason, in the accompanying drawings, some elements are enlarged, omitted, or depicted schematically.

Hereinafter, a secondary battery according to a first aspect of the present disclosure will be described.

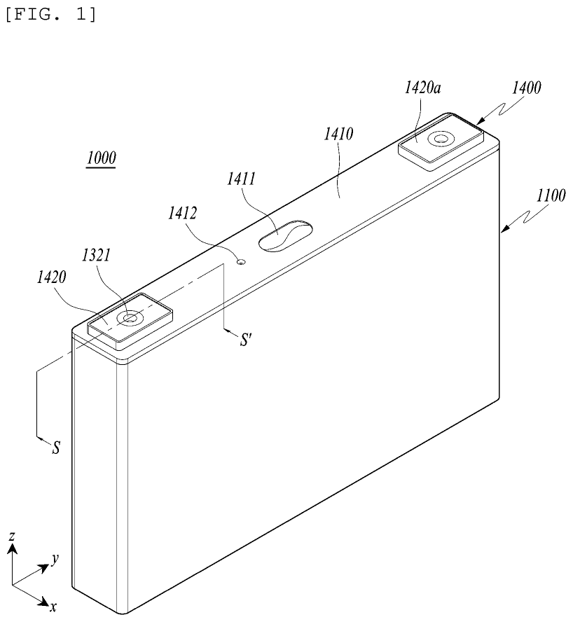

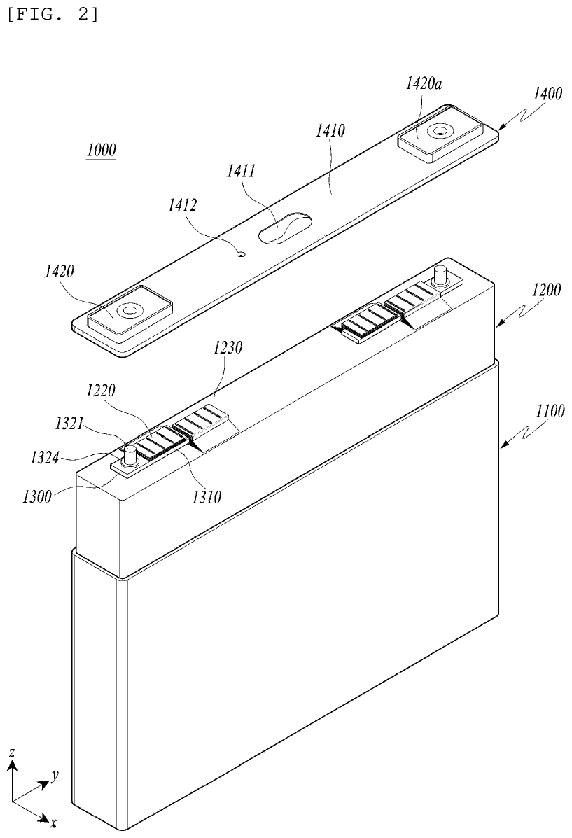

FIG. 1 is a view illustrating a secondary battery according to a first aspect of the present disclosure. FIG. 2 is a view illustrating a cap assembly separated from the secondary battery according to the first aspect of the present disclosure.

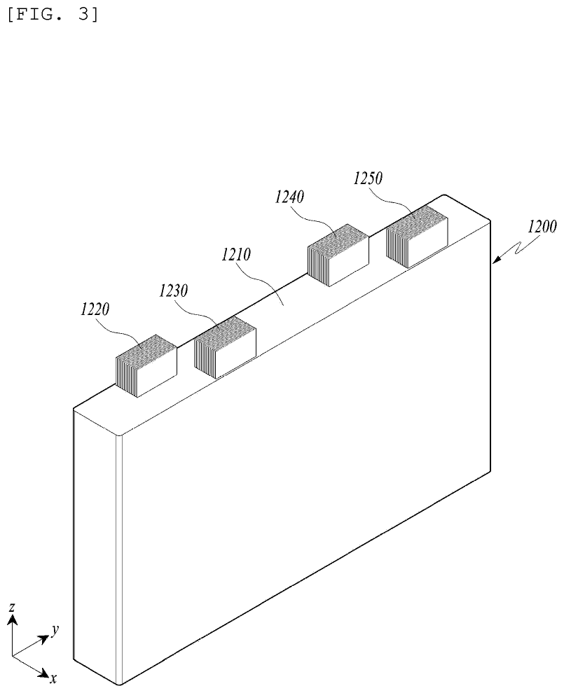

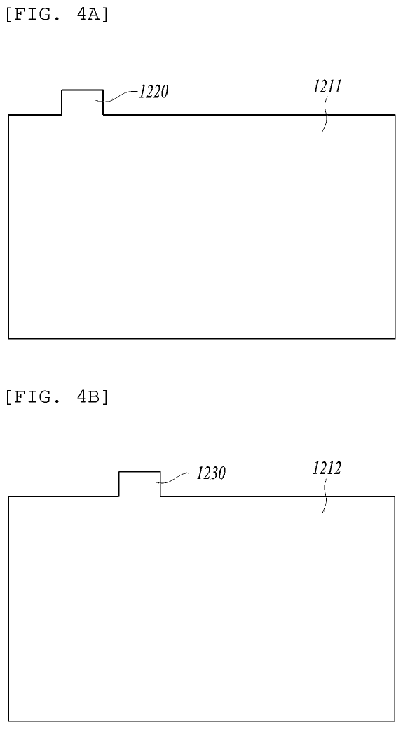

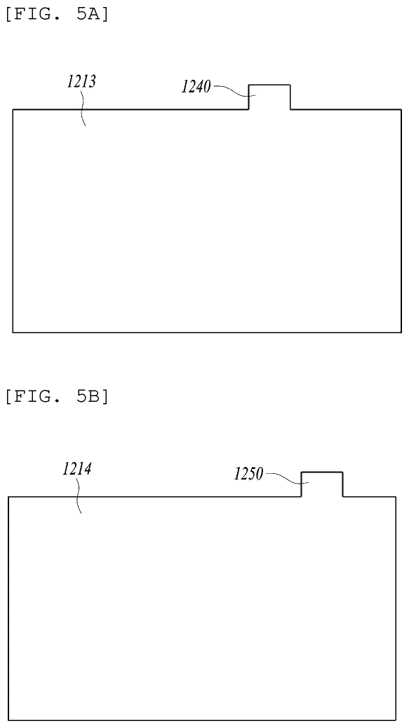

FIG. 3 is a view illustrating an electrode assembly in which a plurality of first electrode tabs and a plurality of second electrode tabs are formed on an electrode portion in the secondary battery according to the first aspect of the present disclosure. FIGS. 4A and 4B are views illustrating a first electrode element and a second electrode element in the secondary battery according to the first aspect of the present disclosure. FIGS. 5A and 5B are views illustrating a third electrode element and a fourth electrode element in the secondary battery according to the first aspect of the present disclosure.

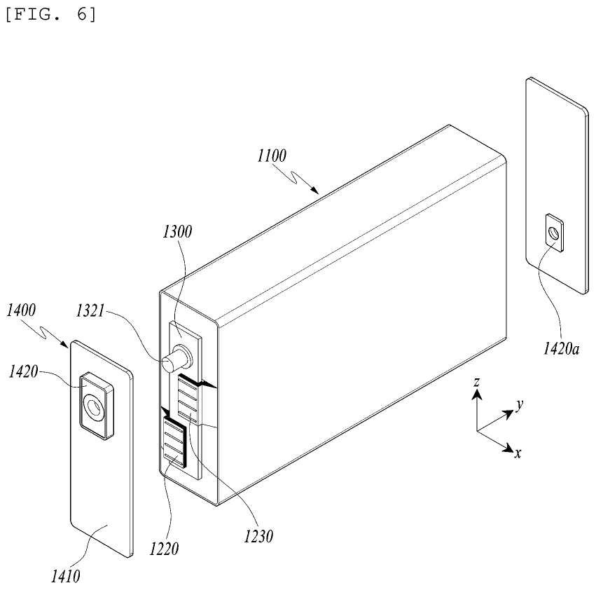

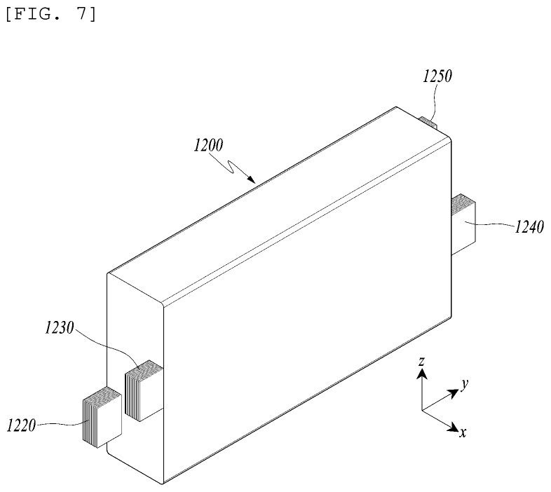

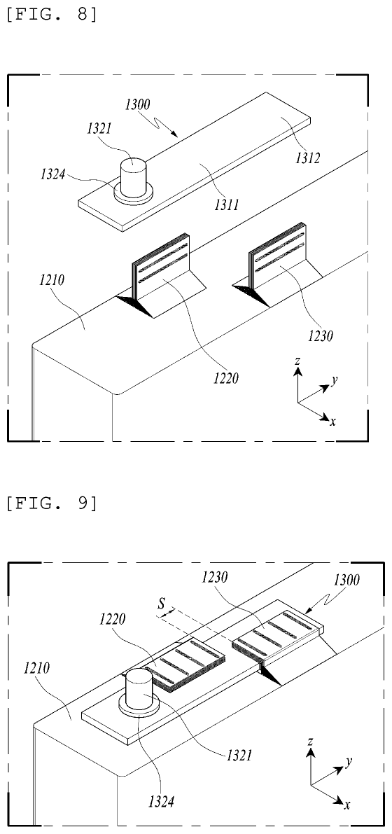

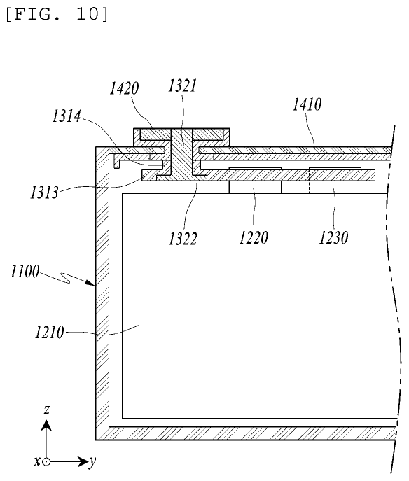

FIG. 6 is an exploded perspective view illustrating a cap assembly separated from opposing sides of the secondary battery according to example of the first aspect of the present disclosure. FIG. 7 is a perspective view illustrating an electrode assembly in which a plurality of first electrode tabs and a plurality of second electrode tabs are formed on opposing sides of an electrode portion in the secondary battery according to the other example of the first aspect of the present disclosure. FIG. 8 is an exploded perspective view illustrating the current collector spaced apart from the plurality of first electrode tabs that have been primarily welded and the plurality of second electrode tabs that have been primarily welded in the secondary battery according to the other orientation of the first aspect of the present disclosure. FIG. 9 is a perspective view illustrating the first and second electrode tabs welded to the current collector in the secondary battery according to the other orientation of the first aspect the present disclosure. FIG. 10 is a cross-sectional view of a secondary battery according to the first aspect of the present disclosure.

As illustrated in FIGS. 1 and 2, a secondary battery 1000 according to an aspect of the present disclosure includes a casing 1100, an electrode assembly 1200, a current collector 1300, and a cap assembly 1400.

The casing 1100 forms an outer shape of the secondary battery 1000. The casing 1100 may define a space capable of accommodating the electrode assembly 1200 therein, and may have an opening on one surface thereof. In the present aspect, the casing 1100 has a rectangular parallelepiped shape, but is not limited thereto and may be modified in various ways. The casing 1100 may be made of a rigid material capable of protecting the electrode assembly 1200 accommodated therein. For example, the casing 1100 may be made of metal such as aluminum or stainless steel.

Electrolyte may be received together with the electrode assembly 1200 in the casing 1100. The electrolyte may include a lithium salt such as LiPF₆ or LiBF₄ in an organic solvent such as ethylene carbonate (EC), propylene carbonate (PC), diethyl carbonate (DEC), ethyl methyl carbonate (EMC), or dimethyl carbonate (DMC). The electrolyte may be in a liquid, solid, or gel phase.

The electrode assembly 1200 is accommodated in the casing 1100. As illustrated in FIG. 3, the electrode assembly 1200 includes an electrode portion 1210, a plurality of first electrode tabs 1220, and a plurality of second electrode tabs 1230. The plurality of first electrode tabs 1220 and the plurality of second electrode tabs 1230 are placed on one end of the electrode portion 1210. The plurality of first electrode tabs 1220 are grouped and aligned with each other, and the plurality of second electrode tabs 1230 are grouped and aligned with each other. The plurality of first electrode tabs 1220 aligned with one another and the plurality of second electrode tabs 1230 aligned with one another are arranged so as not to overlap in a width direction (x direction) and a longitudinal direction (y direction) of the electrode assembly 1200.

Specifically, the electrode portion 1210 includes a plurality of first electrode elements 1211, a plurality of second electrode elements 1212, a plurality of third electrode elements 1213, a plurality of fourth electrode elements 1214, and a separator.

An active material may be applied to the plurality of first electrode elements 1211, the plurality of second electrode elements 1212, the plurality of third electrode elements 1213, and the plurality of fourth electrode elements 1214. The plurality of first electrode elements 1211 and the plurality of second electrode elements 1212 may each be formed by applying an active material such as a transition metal oxide to a metal plate such as an aluminum plate. The plurality of first electrode elements 1211 and the plurality of second electrode elements 1212 may have the same polarity, and may be positive electrode plates. The plurality of third electrode elements 1213 and the plurality of fourth electrode elements 1214 may each be formed by applying an active material such as graphite or carbon to a metal plate such as a copper or nickel plate. The plurality of third electrode elements 1213 and the plurality of fourth electrode elements 1214 may have the same polarity, and may be negative electrode plates.

The separators are positioned between the plurality of first to fourth electrode elements 1211, 1212, 1213, and 1214 to prevent a short circuit between the plurality of first to fourth electrode elements 1211, 1212, 1213, and 1214. The separators may be made of polyethylene, polypropylene, a composite material thereof, or the like.

The electrode portion 1210 may be formed by positioning separators between the first electrode elements 1211 and the third electrode elements 1213, which are alternately arranged, and between the second electrode elements 1212 and the fourth electrode elements 1214, which are alternately arranged. In other words, in an aspect, the electrode portion 1210 may be formed in such a way that one side of the electrode portion 1210 is formed by stacking the first electrode element 1211, the separator, the third electrode element 1213, and the separator in the listed order, tens to hundreds of times, and a remaining side of the electrode portion 1210 is formed by stacking the second electrode element 1212, the separator, the fourth electrode element 1214, and the separator in the listed order, tens to hundreds of times. In another aspect, the electrode portion 1210 may be formed by sequentially stacking the first electrode element 1211, the separator, the third electrode element 1213, the separator, the second electrode element 1212, the separator, the fourth electrode element 1214, and the separator in the listed order, and then winding the stacked structure.

Although, in the present aspect, the electrode assembly 1200 is illustrated as including the single electrode portion 1210, in another aspect, the electrode assembly 1200 may include a plurality of electrode portions 1210. The plurality of electrode portions 1210 may be electrically connected to one another.

The first to fourth electrode tabs 1220, 1230, 1240, and 1250, to which no active material is applied, are respectively positioned at one end of the plurality of first to fourth electrode elements 1211, 1212, 1213, and 1214. In an aspect, each of the electrode elements 1211, 1212, 1213, and 1214 and the corresponding electrode tab 1220, 1230, 1240, or 1250 may be integrally formed by cutting a predetermined portion of a single metal plate using a laser or the like, such that the electrode element 1211, 1212, 1213, or 1214 and the electrode tab 1220, 1230, 1240, or 1250 remain. The plurality of electrode tabs 1220, 1230, 1240, and 1250 may be arranged so as to project in a direction toward the cap assembly 1400.

Each of the first electrode tabs 1220 may be arranged at a first position of the corresponding first electrode element 1211, and each of the second electrode tabs 1230 may be arranged at a second position of the corresponding second electrode element 1212 (see FIGS. 4A and 4B). Similarly, each of the third electrode tabs 1240 may be arranged at a third position of the corresponding third electrode element 1213, and each of the fourth electrode tabs 1250 may be arranged at a fourth position of the corresponding fourth electrode element 1214 (see FIGS. 5A and 5B).

The plurality of first electrode elements 1211 and the plurality of third electrode elements 1213 may be alternately stacked with the corresponding separator interposed between adjacent electrode elements. A stack including the plurality of first electrode elements 1211 and the plurality of third electrode elements 1213 forms one half of the electrode portion 1210.

The plurality of second electrode elements 1212 and the plurality of fourth electrode elements 1214 may be alternately stacked with the corresponding separator interposed between adjacent electrode elements. A stack including the plurality of second electrode elements 1212 and the plurality of fourth electrode elements 1214 forms a remaining half of the electrode portion 1210.

The stack including the plurality of first electrode elements 1211 and the plurality of third electrode elements 1213 and the stack including the plurality of second electrode elements 1212 and the plurality of fourth electrode elements 1214 are connected in the width direction (x direction) of the electrode portion 1210. During formation of the electrode assembly 1200, the plurality of first electrode elements 1211 and the plurality of third electrode elements 1213 may be stacked before stacking the plurality of second electrode elements 1212 and the plurality of fourth electrode elements 1214.

When the plurality of first to fourth electrode elements 1211, 1212, 1213, and 1214 are stacked, the plurality of first electrode tabs 1220 overlap one another at the first position, and the plurality of second electrode tabs 1230 overlap one another at the second position. In other words, the plurality of first electrode tabs 1220 are grouped at the first position, and the plurality of second electrode tabs 1230 are grouped at the second position. The first position and the second position are spaced apart from each other on the electrode element. The plurality of first electrode tabs 1220 that are grouped and the plurality of second electrode tabs 1230 that are grouped may be spaced apart in the width direction (x direction) and the longitudinal direction (y direction) of the electrode assembly 1200.

The plurality of first electrode tabs 1220 that are grouped are primarily welded to each other, and the plurality of second electrode tabs 1230 that are grouped are primarily welded to each other.

The plurality of first electrode tabs 1220 and the plurality of second electrode tabs 1230 are electrode tabs having the same polarity, and are primarily welded at respective positions spaced apart in the width direction and the longitudinal direction of the electrode assembly 1200 to enable stable welding of a large number of electrode tabs, and are then secondarily welded on the current collector. In other words, although a single electrode tab is formed on each electrode element, two electrode tab groups having the same polarity but different positions are formed after stacking the electrode elements by varying the positions at which the electrode tabs are formed on the respective electrode elements. In another aspect, two or more electrode tabs may be formed at different positions on the same polarity side.

When the plurality of first to fourth electrode elements 1211, 1212, 1213, and 1214 are stacked, the plurality of third electrode tabs 1240 overlap one another at the third position, and the plurality of fourth electrode tabs 1250 overlap one another at the fourth position. In other words, the plurality of third electrode tabs 1240 are grouped at the third position, and the plurality of fourth electrode tabs 1250 are grouped at the fourth position. The third position and the fourth position are spaced apart from each other on the electrode element. The plurality of third electrode tabs 1240 that are grouped and the plurality of fourth electrode tabs 1250 that are grouped may be spaced apart in the width direction (x direction) and the longitudinal direction (y direction) of the electrode assembly 1200.

The plurality of third electrode tabs 1240 and the plurality of fourth electrode tabs 1250 are electrode tabs having the same polarity.

The plurality of electrode tabs 1220, 1230, 1240, and 1250, which overlap at the respective positions, may each be joined by ultrasonic welding, laser welding, or the like to facilitate current flow.

The current collector 1300 may be disposed on an upper end of the electrode portion 1210. The electrode tabs 1220 and 1230 may be bent onto and welded to an upper surface of the current collector 1300, so that the current collector 1300 can be connected to the electrode tabs 1220 and 1230.

In the related art, welding is performed after placing the current collector on the electrode tabs, and thus a high laser output is required to transmit heat to the electrode tabs located under the current collector. However, in the present disclosure, electrode tabs are disposed on the upper surface of the current collector, enabling welding with a relatively low output. Since, in the present disclosure, it is unnecessary to melt even a lower portion of the current collector, the thickness of the current collector may be increased to protect the separators provided in the electrode portion. Accordingly, damage to the separators may be prevented and durability of the secondary battery may be improved.

One side of the current collector 1300 may be connected to an electrode terminal. The electrode tabs 1220 and 1230 of the electrode portion 1210 may be electrically connected to the electrode terminal by the current collector 1300.

The current collector 1300 may be provided as two current collectors 1300. The material of each current collector 1300 may be the same as that of the first and second electrode tabs 1220 and 1230, or the third and fourth electrode tabs 1240 and 1250. In other words, each current collector 1300 may be made of aluminum, or may be made of copper or nickel.

Detailed explanation of the current collector 1300 will be provided later.

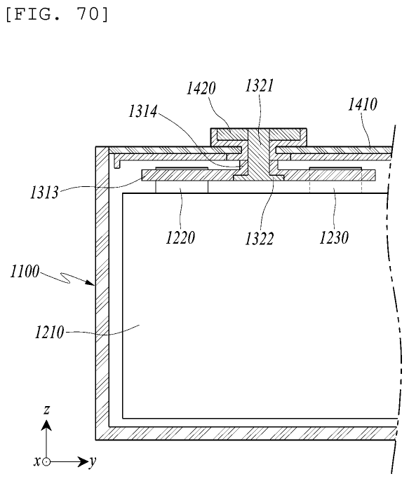

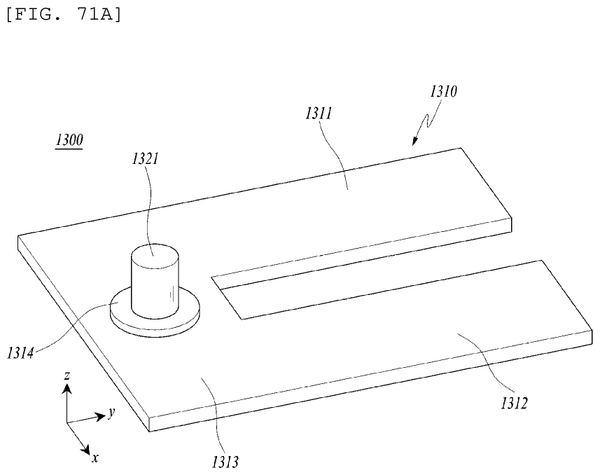

As illustrated in FIGS. 8-9, 69A-B, 72A-B, and 74A-B, a plurality of first and second electrode tabs 1220, 1230 can be grouped and welded together at one end of the electrode portion 1210. The plurality of groups of welded first and second electrode tabs 1220, 1230 can each be bent outward toward the electrode assembly 1200. The current collector 1300 may then be placed at one end of the electrode portion 1210, such that at least a portion of the surface of the current collector 1300 facing the electrode assembly 1200 comes into contact with the plurality of first and second electrode tabs 1220, 1230. The electrode tabs 1220, 1230 can then be connected to the current collector 1300 by bending and welding the electrode tabs 1220, 1230 to the opposing surface of the current collector 1300 that faces away from the electrode assembly 1200, as shown in FIGS. 6, 9, 69A-B, 72A-B, and 74A-B.

A plurality of first and second electrode tabs 1220, 1230 may be spaced apart by a predetermined interval in the longitudinal direction (y direction) of the current collector 1300 according to the positions of the first collecting portion and the second collecting portion 1312. The spacing S of the plurality of first and second electrode tabs 1220, 1230 may be 5 to 15% of the length of the current collector 1300. If the spacing S between multiple first and second electrode tabs 1220, 1230 is less than 5% of the length of the current collector 1300, there is a risk that welding burrs caused by the first and second electrode tabs will be concentrated between the first and second electrode tabs during secondary welding, resulting in a thicker and uneven weld thickness. If the spacing S between multiple first and second electrode tabs 1220, 1230 exceeds 15% of the length of the current collector 1300, the second electrode tab 1230 will be adjacent to the outer edge of the current collector 1300, which may affect the electrode portion during welding. This may apply to all aspects throughout the disclosure.

The cap assembly 1400 seals the opening of the casing 1100 in which the electrode assembly 1200 is accommodated. The cap assembly 1400 includes a cap plate 1410 and terminals 1420 and 1420a.

The cap plate 1410 may have a plate shape that covers the opening of the casing 1100. The cap plate 1410 may have a shape corresponding to that of the opening of the casing 1100. The cap plate 1410 may be made of the same material as the casing 1100, and may be fixed to the casing 1100 by a method such as laser welding.

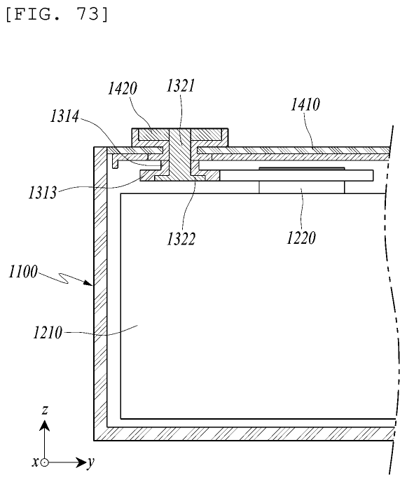

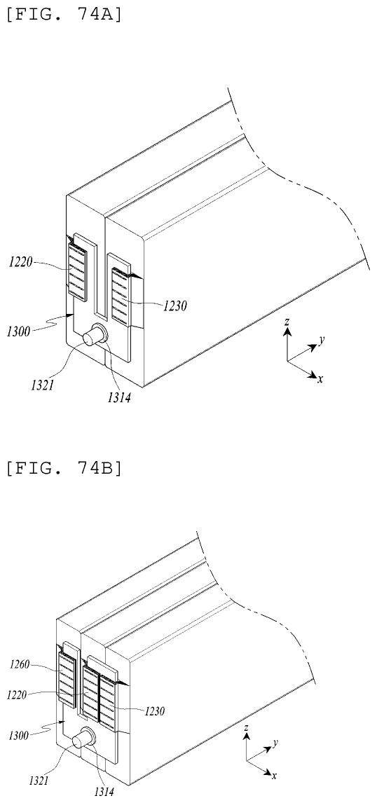

As illustrated in FIGS. 10, 70, and 73, when the cap assembly 1400 seals the opening of the case 1100, the current collecting protrusion 1321 of the current collector 1300 can pass through the opening of the cap plate 1410 and be inserted into the through hole of the electrode terminal 1420. The lower structure of the cap assembly 1400 can be supported by contacting the upper surface of the stopper 1314 of the current collector 1300. Accordingly, the cap assembly 1400 can maintain a stable distance from the electrode assembly 1200. This may apply to all aspects throughout the disclosure.

The cap plate 1410 may be formed with a vent hole 1411 and an electrolyte injection hole 1412. The vent hole 1411 opens when an internal pressure of the casing 1100 exceeds a reference value. In the present aspect, the vent hole 1411 is formed in the cap plate 1410, but in other aspects, the vent hole 1411 may be formed in the casing 1100. Electrolyte can be injected into the casing 1100 through the electrolyte injection hole 1412.

The terminals 1420 and 1420a may be formed to protrude from the cap plate 1410. The terminals 1420 and 1420a are respectively electrically connected to the corresponding electrode tabs 1220, 1230, 1240, and 1250 via the current collectors 1300. The terminals 1420 and 1420a may each have a plate shape in a circular or rectangular form.

A through hole may be formed in each of the terminals 1420 and 1420a. A current collecting protrusion 1321 may be inserted into the through hole. After the current collecting protrusion 1321 is inserted into the through hole, an outer peripheral surface of an end of the current collecting protrusion 1321 and an inner peripheral surface of an end of the through hole may be welded to each other.

Insulators may be respectively positioned between the terminals 1420 and 1420a and the cap plate 1410. The insulators electrically insulate the terminals 1420 and 1420a from the cap plate 1410.

In some examples, rather than being coupled to electrode tabs 1220, 1230 along the top of an electrode assembly 1200, as illustrated in FIGS. 9-10, the current collector 1300 may be utilized in connection with bidirectional battery cells, in which terminals 1420, 1420a of opposing polarities are positioned at opposing ends of the electrode assembly 1200 in a longitudinal (y axis) direction, as shown in FIG. 6. In such case, as illustrated in that figure, one current collector 1300 may be positioned along one end of the electrode assembly 1200, where it is coupled to terminal 1420 and electrode tabs 1220, 1230, and another current collector 1400 may be positioned along the opposite end of the electrode assembly 1200 in the longitudinal (y axis) direction, where it is coupled to terminal 1420a and electrode tabs 1240, 1250 (see FIG. 7). It is noted that, even if not shown in other figures herein, any of the current collectors of the present disclosure may similarly be utilized in connection with bidirectional battery cells.

Hereinafter, the current collector of the secondary battery according to the first aspect of the present disclosure will be described.

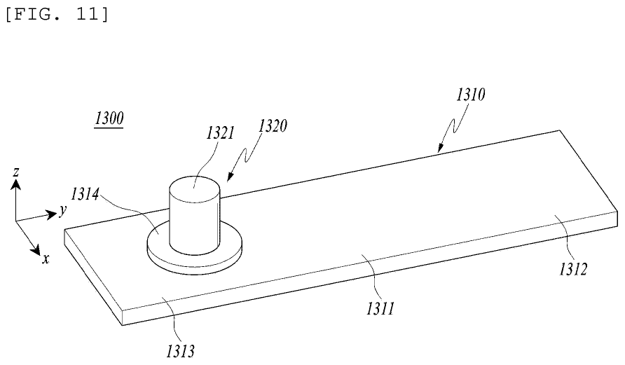

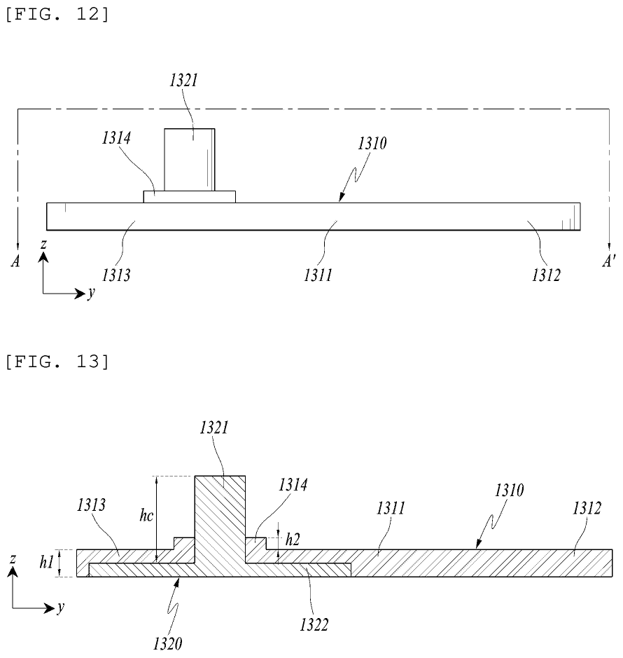

FIG. 11 is a perspective view illustrating the current collector in the secondary battery according to the first aspect of the present disclosure, and FIG. 12 is a side elevation view illustrating the current collector of FIG. 11. FIG. 13 is a cross-sectional view taken along line A-A′ of FIG. 12.

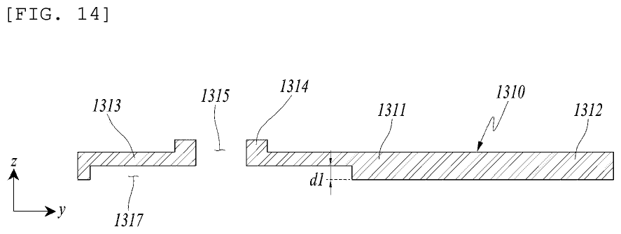

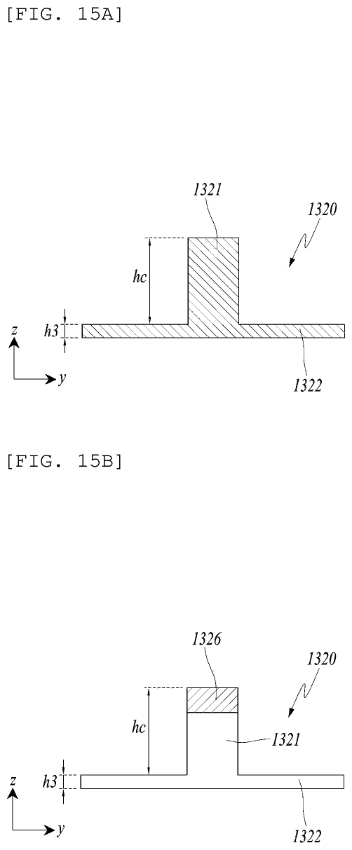

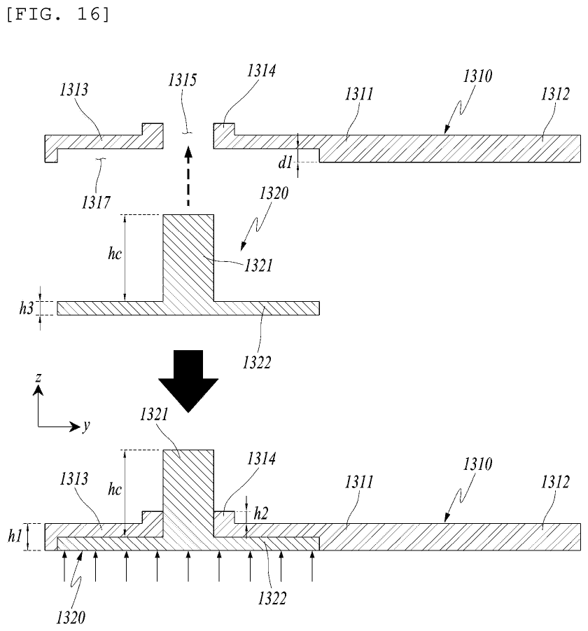

FIG. 14 is a view illustrating a current collecting unit in the secondary battery according to the first aspect of the present disclosure. FIGS. 15A and 15B are views illustrating a pole unit in the secondary battery according to the first aspect of the present disclosure. FIG. 16 is a view illustrating a process of assembling the current collecting unit with the pole unit in the first aspect of the present disclosure.

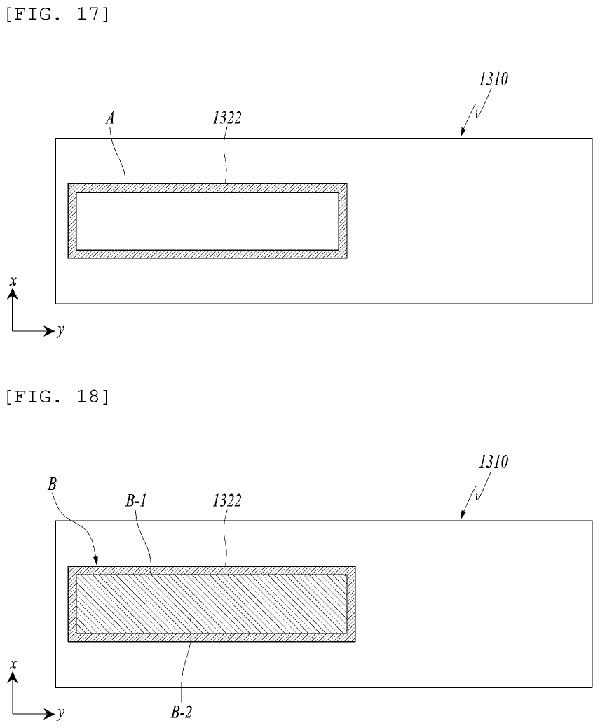

FIGS. 17 and 18 are views illustrating different examples of welding regions on a lower surface of the current collecting unit in the secondary battery according to the first aspect of the present disclosure.

As illustrated in FIGS. 11 to 13, the current collector 1300 may include a current collecting unit 1310 and a pole unit 1320. The current collecting unit 1310 may be connected to the plurality of electrode tabs 1220 and 1230. The pole unit 1320 may be connected to the corresponding electrode terminal.

The current collecting unit 1310 may have various shapes according to an arrangement of the electrode tabs and a connection configuration of the electrode portion.

For example, as illustrated in FIG. 11, the current collecting unit 1310 may have a rectangular shape extending in the longitudinal direction (y direction) of the electrode assembly 1200. The current collecting unit 1310 may include a connection portion 1313, a first current collecting portion 1311, and a second current collecting portion 1312 that are successively arranged in a longitudinal direction of the rectangular shape. The connection portion 1313, the first collecting portion 1311, and the second collecting portion 1312 may be made of the same material and may be integrally formed.

The first current collecting portion 1311 may be welded to the plurality of first electrode tabs 1220. The plurality of first electrode tabs 1220 may be bent onto and welded to an upper surface of the first current collecting portion 1311. The second current collecting portion 1312 may be welded to the plurality of second electrode tabs 1230. The plurality of second electrode tabs 1230 may be bent onto and welded to an upper surface of the second current collecting portion 1312. The first current collecting portion 1311 and the second current collecting portion 1312 may have a predetermined thickness h1. Specifically, the thickness of each of the first current collecting portion 1311 and the second current collecting portion 1312 may range from 0.5 mm to 3.0 mm.

The connection portion 1313 may be connected to one side of the first current collecting portion 1311. The second current collecting portion 1312 may be connected to a remaining side of the first current collecting portion 1311. Because the first current collecting portion 1311 and the second current collecting portion 1312 are disposed to be spaced apart from each other in the longitudinal direction, the plurality of first electrode tabs 1220 and the plurality of second electrode tabs 1230 do not interfere with each other when welded to the first current collecting portion 1311 and the second current collecting portion 1312, respectively.

The connection portion 1313 may be formed to have the same thickness as the first current collecting portion 1311 and the second current collecting portion 1312. The thickness of the connection portion 1313 may range from 0.5 mm to 3.0 mm. A curvature radius of an edge of the upper surface of the current collecting unit 1310 may range from 0.25 mm to 0.35 mm.

The connection portion 1313 may be coupled to the pole unit 1320.

An opening may be formed in the connection portion 1313.

A stopper 1314 may be disposed on an upper surface of the connection portion 1313. The stopper 1314 may protrude from the upper surface of the connection portion 1313 by a predetermined height h2. When the current collector 1300 is coupled to another component (e.g., a cap plate and/or a terminal), a lower limit position of the component to be coupled to the current collector 1300 may be defined by the stopper 1314. Because the electrode tabs are placed on and welded to the first current collecting portion 1311 and the second current collecting portion 1312 of the current collecting unit 1310, those welded portions each have a predetermined thickness. In cases where thicknesses of the welded portions on the first current collecting portion 1311 and the second current collecting portion 1312 are not equal to each other, the component coupled to the current collector 1300 may not be properly leveled. Such improper leveling may reduce airtightness of the assembled secondary battery or lead to an assembly defect. By providing the stopper 1314 on the upper surface of the current collector 1300, however, the component assembled to the current collector 1300 may be horizontally aligned.

The height h2 of the stopper 1314 may be equal to or greater than a height to which the plurality of first electrode tabs 1220 and the plurality of second electrode tabs 1230 are welded on the upper surface of the current collector 1300. As the numbers of first electrode tabs 1220 and second electrode tabs 1230 increase, that is, as the thickness of the electrode assembly 1200 (in the x direction in FIG. 2) increases, the height h2 of the stopper 1314 may also increase. The height h2 of the stopper 1314 may be 1% to 5% of the thickness of the electrode assembly 1200, and may be 2.5%, for example. When two current collectors 1300 are disposed on the electrode portion 1210, the stoppers 1314 may have the same height.

The height (h2) of the stopper 1314 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

In accordance with the present disclosure, a large number of electrode tabs can be welded onto a current collector by forming multiple groups, and the height of the stopper may decrease as the number of groups of electrode tabs of the same polarity increases

The stopper 1314 may have a square plate shape, a rectangular plate shape, or a disc shape. An upper surface of the stopper 1314 may be formed as a flat surface to support a component to be assembled thereto and may have a predetermined area. A cross-sectional area of the stopper 1314 may be 3% to 6% of the upper surface of the current collecting unit 1310. The stopper 1314 may be integrally formed with the connection portion 1313.

The stopper 1314 may protrude upward from the upper surface of the connection portion 1313, and the height h2 thereof may be smaller than the thickness of the current collecting unit 1310. Specifically, the height h2 of the stopper 1314 may be 30% to 50% of the thickness h1 of an end of the current collecting unit 1310, that is, an end of the first or second current collecting portion 1311 or 1312. Due to the stopper 1314, a stepped structure of the current collecting unit 1310 may be formed.

As illustrated in FIG. 14, an opening 1315 may be formed in the stopper 1314. The opening may be formed to pass through a center of the stopper 1314. In this case, the opening of the stopper 1314 may be connected to the opening of the connection portion 1313 to form a continuous opening 1315. The current collecting protrusion 1321 of the pole unit 1320 may be inserted through the opening 1315.

A recessed region 1317 may be formed in the lower surface of the current collecting unit 1310. The recessed region 1317 may have a rectangular plate shape and may define a vacant space above the lower surface of the current collecting unit 1310. The recessed region 1317 may be formed in a lower surface of the connection portion 1313 and a portion of a lower surface of the first current collecting portion 1311. A depth d1 of the recessed region 1317 may be 30% to 50% of the thickness h1 of the end of the current collecting unit 1310.

The pole unit 1320 may be coupled to the current collecting unit 1310. One side of the pole unit 1320 may be connected to the current collecting unit 1310, and a remaining side thereof may be connected to the corresponding electrode terminal. The electrode tabs 1220 and 1230 of the electrode portion 1210 may be electrically connected to the electrode terminal by the pole unit 1320.

The pole unit 1320 may be electrically connected to the corresponding electrode terminal. A material of the pole unit 1320 may be the same as or different from that of the current collecting unit 1310. For example, the current collecting unit 1310 and the pole unit 1320 may both be made of aluminum. Alternatively, the current collecting unit 1310 may be made of copper, and the pole unit 1320 may be made of aluminum. According to the present disclosure, as the current collecting unit 1310 and the pole unit 1320 are formed as separate components, flexibility in selecting materials and dimensions of components may be increased.

As illustrated in FIGS. 10A and 10B, the pole unit 1320 may include a current collecting protrusion 1321 and a support portion 1322. The current collecting protrusion 1321 may have a cylindrical shape having a predetermined height hc. The current collecting protrusion 1321 may be electrically connected to the corresponding electrode terminal. The current collecting protrusion 1321 may be inserted into the opening 1315 of the connection portion 1313 and the stopper 1314. In order for a component (e.g., a cap plate and/or a terminal) fitted over the current collecting protrusion 1321 to be stably supported on the stopper 1314, the stopper 1314 may have a predetermined area. An area of a horizontal cross section of the stopper 1314 may be 2 times to 5 times an area of a horizontal cross section of the current collecting protrusion 1321. Because a cross-sectional area of the stopper 1314 is formed to be larger than a cross-sectional area of the current collecting protrusion 1321, the component may be stably supported.

In order to facilitate coupling between the current collecting protrusion 1321 and the component, the height hc of the current collecting protrusion 1321 may be formed to be greater than the height h2 of the stopper 1314 within a predetermined range. Specifically, the height h2 of the stopper 1314 may be 10% to 20% of the height hc of the current collecting protrusion 1321, and may be 15%, for example. When the height h2 of the stopper 1314 is greater than 20% of the height hc of the current collecting protrusion 1321, a height difference between the upper surface of the stopper 1314 and the upper surfaces of the first and second current collecting portions 1311 and 1312 increases, thereby making it difficult to stably support the component.

In the case of a negative electrode current collector, an upper end of the current collecting protrusion 1321 made of copper may be plated with nickel (see FIG. 15B). A height of a nickel plating layer 1326 may be 1.5 mm to 2.5 mm from the upper end of the current collecting protrusion 1321. The height of the nickel plating layer 1326 may be 30% to 50% of the height of the current collecting protrusion 1321. A thickness of the nickel plating layer 1326 may range from 2 μm to 4 μm. As the upper end of the current collecting protrusion 1321 is plated with nickel, welding strength when the current collecting protrusion 1321 is welded to the electrode terminal may be further enhanced.

The support portion 1322 may be connected to a lower end of the current collecting protrusion 1321 and may have a rectangular plate shape. The support portion 1322 may support the current collecting protrusion 1321 such that the current collecting protrusion 1321 is perpendicular to the current collecting unit 1310 when the pole unit 1320 is connected to the current collecting unit 1310. The current collecting protrusion 1321 and the support portion 1322 may be integrally formed. The support portion 1322 may be received in the recessed region 1317 of the current collecting unit 1310. A height h3 of the support portion 1322 may be the same as the depth d1 of the recessed region. In other words, a lower surface of the support portion 1322 and a lower surface of the current collecting unit 1310 may be flush with each other (see FIG. 16).

After the support portion 1322 is fitted into the recessed region 1317 of the current collecting unit 1310, the support portion 1322 may be joined with the current collecting unit 1310 by welding. The welding may be performed on the lower surface of the support portion 1322. Due to the welding, a welding region A or B may be formed on the lower surface of the support portion 1322.

As illustrated in FIG. 17, in an aspect, the welding region may be formed on an outer periphery (region A) of the lower surface of the support portion 1322. The support portion 1322 overlaps the current collecting unit 1310. Although the plate-shaped current collecting unit 1310 has the predetermined thickness h1, in a portion in which the recessed region 1317 that receives the support portion 1322 is formed, the thickness of the current collecting unit 1310 is reduced. Accordingly, when laser output is relatively high during welding, a welding mark may be formed even on the upper surface of the current collecting unit 1310, and flatness of the upper surface may be degraded. In order to prevent the foregoing issue, the welding may be performed only on the outer periphery (region A) of the support portion 1322 in which the thickness of the current collecting unit 1310 is secured.

In a modified example, a welding region (region B) may be formed over an entire lower surface of the support portion 1322 (see FIG. 18). In order to stably fix the pole unit 1320 to the current collecting unit 1310, the entire lower surface of the support portion 1322 may be welded to increase a welding area. In this case, laser output on an outer periphery (region B-1) of the lower surface of the support portion 1322 may be higher than laser output on an inner side (region B-2) of the lower surface of the support portion 1322. Because a thickness of a portion of the current collecting unit 1310 that is adjacent to the inner side (region B-2) of the lower surface of the support portion 1322 is smaller than that at the outer periphery, the laser output may be adjusted to a lower level.

According to the present disclosure, a sufficient welding area may be secured by the rectangular support portion 1322, so that the current collecting protrusion 1321 may be stably connected to the current collecting unit 1310. In addition, because the support portion 1322 is formed in a rectangular plate shape and is received in the recessed region 1317, undesired rotation of the current collecting protrusion 1321 may be prevented.

A width of the current collector 1300 may be 0.3 times to 0.8 times a thickness of the electrode assembly 1200. The current collector 1300 may have a thickness of 0.5 mm to 3.0 mm.

An insulator may be disposed under the current collector 1300. The insulator may be an insulating plate or an insulating film. The insulator may more reliably protect the electrode tabs 1220 and 1230 and the electrode portion 1210.

The insulator may be applied or attached to a lower surface of the current collector 1300 with a predetermined thickness after the pole unit 1320 is welded to the current collecting unit 1310.

In the present aspect, a structure in which the connection portion 1313 is coupled to the pole unit 1320 has been described; however, the present disclosure is not limited thereto, and the connection portion 1313 that may have various shapes may be coupled to the pole unit 1320 in various manners.

Hereinafter, a current collector of a secondary battery according to a second aspect of the present disclosure will be described. Description of elements identical to those of the first aspect are omitted or briefly described.

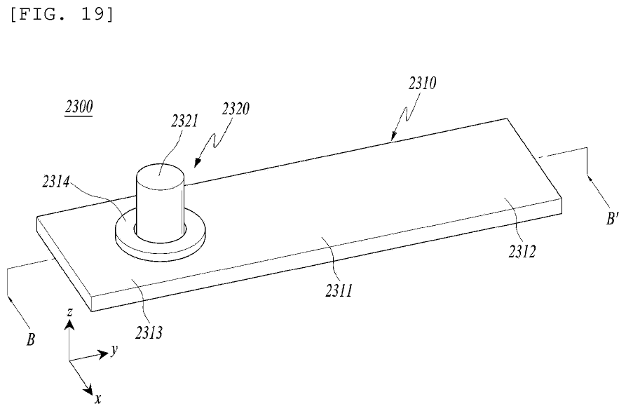

FIG. 19 is a view illustrating a connection portion and a pole unit in the current collector of the secondary battery according to the second aspect of the present disclosure. FIG. 20 is a cross-sectional view taken along line B-B′ of FIG. 19.

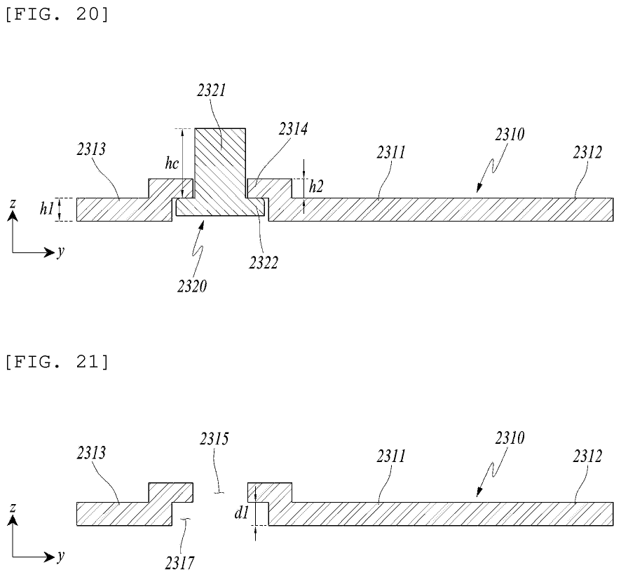

FIG. 21 is a view illustrating a current collecting unit in the secondary battery according to the second aspect of the present disclosure. FIGS. 17A and 17B are views illustrating the pole unit in the secondary battery according to the second aspect of the present disclosure. FIG. 23 is a view illustrating a process of assembling the current collecting unit with the pole unit in the second aspect of the present disclosure.

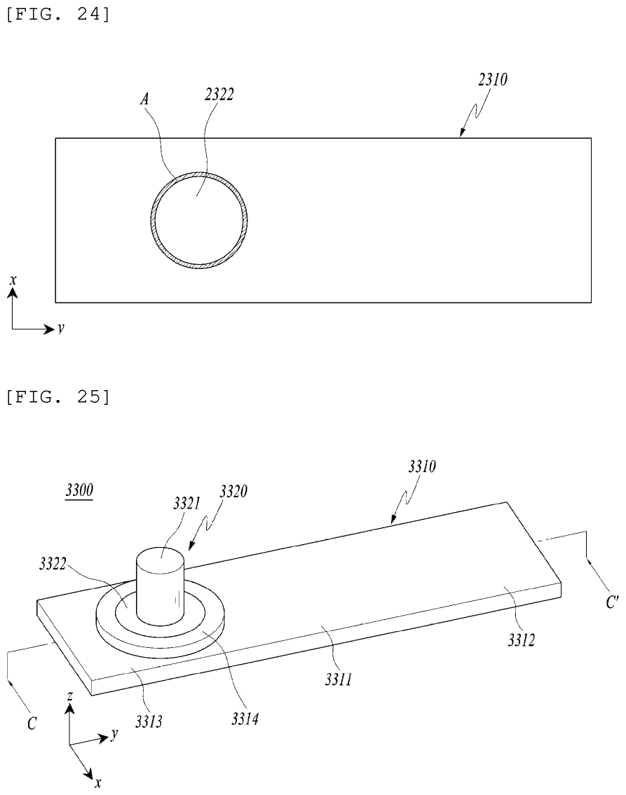

FIG. 24 is a view illustrating a welding region on a lower surface of the current collecting unit in the secondary battery according to the second aspect of the present disclosure.

As illustrated in FIG. 19, a current collector 2300 may include a current collecting unit 2310 and a pole unit 2320. The current collecting unit 2310 may be connected to the plurality of electrode tabs 1220 and 1230. The pole unit 2320 may be connected to the corresponding electrode terminal.

The current collecting unit 2310 may have a rectangular shape extending in the longitudinal direction (y direction) of the electrode assembly 1200, and may include a connection portion 2313, a first current collecting portion 2311, and a second current collecting portion 2312 that are successively arranged along a longitudinal direction. The connection portion 2313, the first current collecting portion 2311, and the second current collecting portion 2312 may be made of the same material and may be integrally formed.

The first current collecting portion 2311 may be welded to the plurality of first electrode tabs 1220. The second current collecting portion 2312 may be welded to the plurality of second electrode tabs 1230. The connection portion 2313 may be formed to have the same thickness as the first current collecting portion 2311 and the second current collecting portion 2312. The thickness of the connection portion 2313 may range from 0.5 mm to 3.0 mm. A radius of curvature of an edge of an upper surface of the current collector 2300 may range from 0.25 mm to 0.35 mm.

The connection portion 2313 may be coupled to the pole unit 2320.

A stopper 2314 may be disposed on an upper surface of the connection portion 2313. The stopper 2314 may protrude from the upper surface of the connection portion 2313 by a predetermined height h2. When the current collector 2300 is coupled to another component, a lower limit position of the component to be coupled to the current collector 2300 may be defined by the stopper 2314. With the stopper 2314 provided on the upper surface of the current collector 2300, the component assembled to the current collector 2300 may be horizontally aligned.

As noted above in connection with the first aspect, the height h2 of the stopper 2314 may be equal to or greater than a height to which the plurality of first electrode tabs 1220 and the plurality of second electrode tabs 1230 are welded on the upper surface of the current collector 1300. The height h2 of the stopper 2314 may be 1% to 5% of the thickness of the electrode assembly 1200, and may be 2.5%, for example. When two current collectors 2300 are disposed on the electrode portion 1210, the stoppers 2314 may have the same height.

The height (h2) of the stopper 2314 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

The stopper 2314 may have a square plate shape, a rectangular plate shape, or a disc shape. An upper surface of the stopper 2314 may be formed as a flat surface to support a component to be assembled thereto and may have a predetermined area. A cross-sectional area of the stopper 2314 may be 3% to 6% of the upper surface of the current collecting unit 2310. The stopper 2314 may be integrally formed with the connection portion 2313.

The stopper 2314 may protrude upward from the upper surface of the connection portion 2313, and the height h2 thereof may be equal to or smaller than the thickness of the current collecting unit 2310. Specifically, the height h2 of the stopper 2314 may be 30% to 100%, preferably 75% of the thickness h1 of an end of the current collecting unit 2310, that is, an end of the first or second current collecting portion 2311 or 2312. Due to the stopper 2314, a stepped structure of the current collecting unit 2310 may be formed.

As illustrated in FIG. 21, an opening 2315 may be formed in the stopper 2314. The opening 2315 may be formed to pass through a center of the stopper 2314. The current collecting protrusion 2321 of the pole unit 2320 may penetrate through the opening 2315.

A recessed region 2317 may be formed in a lower surface of the current collecting unit 2310. The recessed region 2317 may have a disc shape or a rectangular plate shape and may define a vacant space above the lower surface of the connection portion of the current collecting unit 2310. A position at which the recessed region 2317 is formed may be under the stopper 2314. A cross-sectional area of the recessed region 2317 may be smaller than a cross-sectional area of the stopper 2314. A depth d1 of the recessed region 2317 may be equal to or greater than the thickness h1 of the end of the current collecting unit 2310. Accordingly, the recessed region 2317 may be integrated with the opening formed in the connection portion 2313.

The cross-sectional area of the recessed region 2317 may be larger than a cross-sectional area of the opening 2315 of the stopper 2314. That is, an upper surface of the recessed region 2317 may be a lower surface of the stopper 2314. Under the opening 2315 of the stopper 2314, the recessed region 2317 may be formed to have a cross-sectional area larger than the opening 2315 of the stopper 2314.

The pole unit 2320 may be coupled to the current collecting unit 2310 and may electrically connect the electrode tabs 1220 and 1230 of the electrode portion 1210 to the corresponding electrode terminal. A material of the pole unit 2320 may be the same as or different from that of the current collecting unit 2310.

As illustrated in FIGS. 17A and 17B, the pole unit 2320 may include a current collecting protrusion 2321 and a support portion 2322. The current collecting protrusion 2321 may have a cylindrical shape having a predetermined height hc. The current collecting protrusion 2321 may be electrically connected to the corresponding electrode terminal. The current collecting protrusion 2321 may be inserted into the opening 2315 of the stopper 2314. A diameter of the current collecting protrusion 2321 may be smaller than an inner diameter of the opening 2315.

In order for a component (e.g., a cap plate and/or a terminal) fitted over the current collecting protrusion 2321 to be stably supported on the stopper 2314, the stopper 2314 may have a predetermined area. An area of a horizontal cross section of the stopper 2314 may be 10 times to 15 times, preferably 10 times an area of a horizontal cross section of the current collecting protrusion 2321. Because a cross-sectional area of the stopper 2314 is formed to be larger than a cross-sectional area of the current collecting protrusion 2321, the component may be stably supported.

In order to facilitate coupling between the current collecting protrusion 2321 and the component, the height hc of the current collecting protrusion 2321 may be formed to be greater than the height h2 of the stopper 2314 within a predetermined range. Specifically, the height h2 of the stopper 2314 may be 15% to 35%, of the height hc of the current collecting protrusion 2321, and may be 25%, for example. When the height h2 of the stopper 2314 is greater than 35% of the height hc of the current collecting protrusion 2321, a height difference between the upper surface of the stopper 2314 and the upper surfaces of first and second current collecting portions 2311 and 2312 increases, thereby making it difficult to stably support the component.

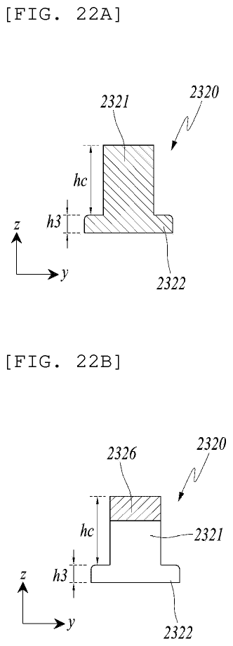

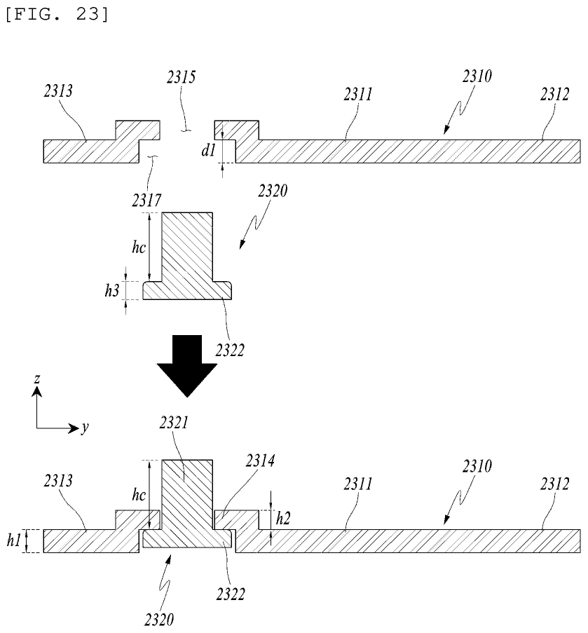

In the case of a negative electrode current collector, an upper end of a current collecting protrusion 2321 made of copper may be plated with nickel (see FIG. 22B). A height of a nickel plating layer 2326 may be 1.5 mm to 2.5 mm from the upper end of the current collecting protrusion 2321. The height of the nickel plating layer 2326 may be 30% to 50% of the height of the current collecting protrusion 2321. A thickness of the nickel plating layer 2326 may range from 2 μm to 4 μm. As the upper end of the current collecting protrusion 2321 is plated with nickel, welding strength when the current collecting protrusion 2321 is welded to the electrode terminal may be further enhanced.

The support portion 2322 may be connected to a lower end of a current collecting protrusion 2321 and may have a disc shape or a rectangular plate shape. A shape of the support portion 2322 may be the same as that of the recessed region 2317. The support portion 2322 may support the current collecting protrusion 2321 such that the current collecting protrusion 2321 is perpendicular to the current collecting unit 2310 when the pole unit 2320 is connected to the current collecting unit 2310. The current collecting protrusion 2321 and the support portion 2322 may be integrally formed. A peripheral edge of an upper end of the support portion 2322 may be rounded.

The support portion 2322 may be received in the recessed region 2317 of the current collecting unit 2310. A diameter of the support portion 2322 may be smaller than a diameter of the recessed region 2317. In addition, a height h3 of the support portion 2322 may be smaller than the depth d1 of the recessed region 2317. In other words, when the support portion 2322 is received in the recessed region 2317, a lower surface of the support portion 2322 may be positioned inside, that is, above, the lower surface of the current collecting unit 2310 (see FIG. 23).

Because the diameter of the current collecting protrusion 2321 is smaller than the inner diameter of the opening 2315 of the stopper 2314, and the diameter of the support portion 2322 is smaller than the diameter of the recessed region 2317, when the current collecting unit 2310 is coupled to the pole unit 2320, clearance may be formed between the current collecting protrusion 2321 and the opening 2315 and between the support portion 2322 and the recessed region 2317. In addition, the peripheral edge of the upper end of the support portion 2322 is rounded. Therefore, when the support portion 2322 is fitted into the recessed region 2317, insertion of the support portion 2322 may be facilitated.

In a variation of the second aspect, the diameter of the current collecting protrusion 2321 and the inner diameter of the opening 2315 of the stopper 2314 may be the same. Additionally, the diameter of the support portion 2322 may be the same as the diameter of the recessed region 2317. Accordingly, when the current collecting unit 2310 and the pole unit 2320 are combined, the current collecting protrusion 2321 may be fitted into the opening 2315 and the support portion 2322 may be fitted into the recessed region 2317.

After the support portion 2322 is fitted into the recessed region 2317 of the current collecting unit 2310, the support portion 2322 may be joined with the current collecting unit 2310 by welding. The welding may be performed on a peripheral region of the lower surface of the support portion 2322. Due to the welding, a welding region A may be formed on the lower surface of the support portion 2322.

As illustrated in FIG. 24, in an aspect, the welding region is formed at an outer periphery (region A) of the lower surface of the support portion 2322. The support portion 2322 may be positioned above a lower end of the connection portion 2313 by a predetermined distance, such that, even when a welding burr is generated, the welding burr does not protrude downward from the lower surface of the current collecting unit 2310.

According to the present disclosure, a sufficient welding area may be secured by a support portion 2322 having a disc shape or a rectangular shape, so that the current collecting protrusion 2321 may be stably connected to the current collecting unit 2310. Furthermore, in the case where the support portion 2322 is formed in a rectangular plate shape and is received in the recessed region 2317, undesired rotation of the current collecting protrusion 2321 may be prevented.

A width of the current collector 2300 may be 0.3 times to 0.8 times the thickness of the electrode assembly 1200. The current collector 2300 may have a thickness of 0.5 mm to 3.0 mm.

An insulator may be disposed under the current collector 2300. The insulator may be an insulating plate or an insulating film. The insulator may more reliably protect the electrode tabs 1220 and 1230 and the electrode portion 1210.

The insulator may be applied or attached to a lower surface of the current collector 2300 with a predetermined thickness after the pole unit 2320 is welded to the current collecting unit 2310.

Hereinafter, a current collector of a secondary battery according to a third aspect of the present disclosure will be described. Description of elements identical to those of the first aspect or the second aspect is omitted or simplified.

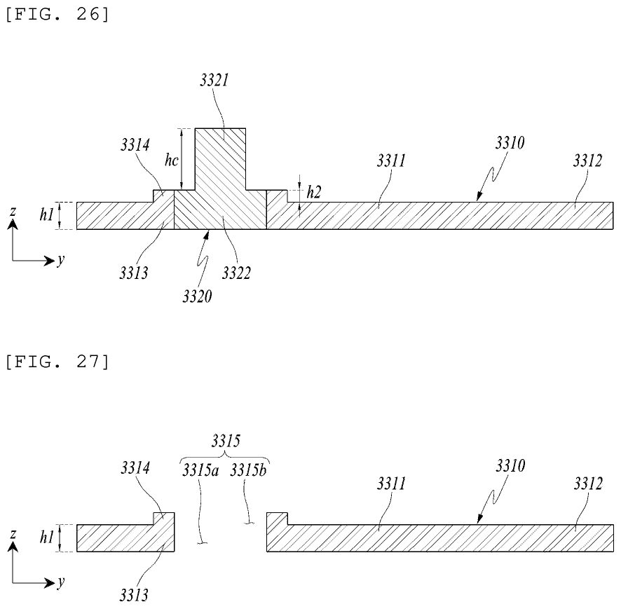

FIG. 25 is a view illustrating a current collector in a secondary battery according to a third aspect of the present disclosure. FIG. 26 is a cross-sectional view taken along line C-C′ of FIG. 25.

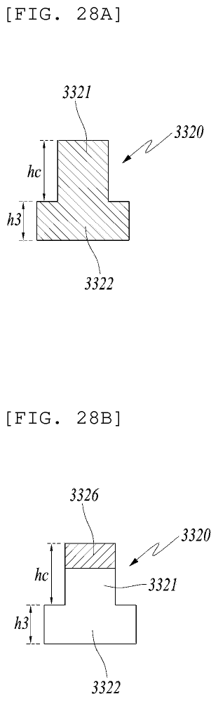

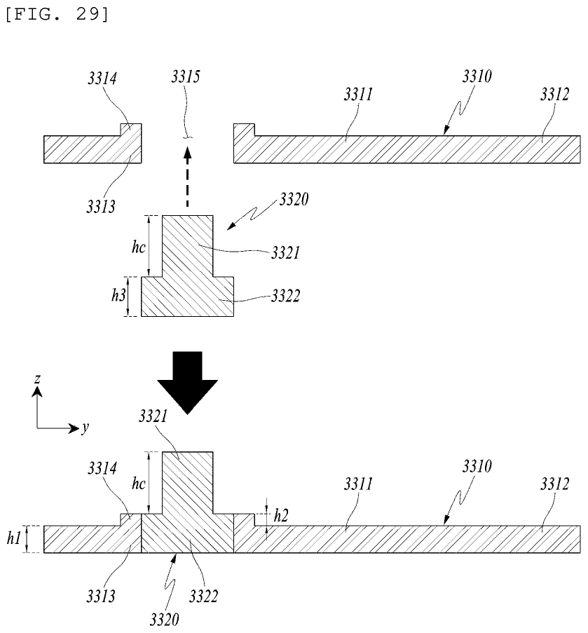

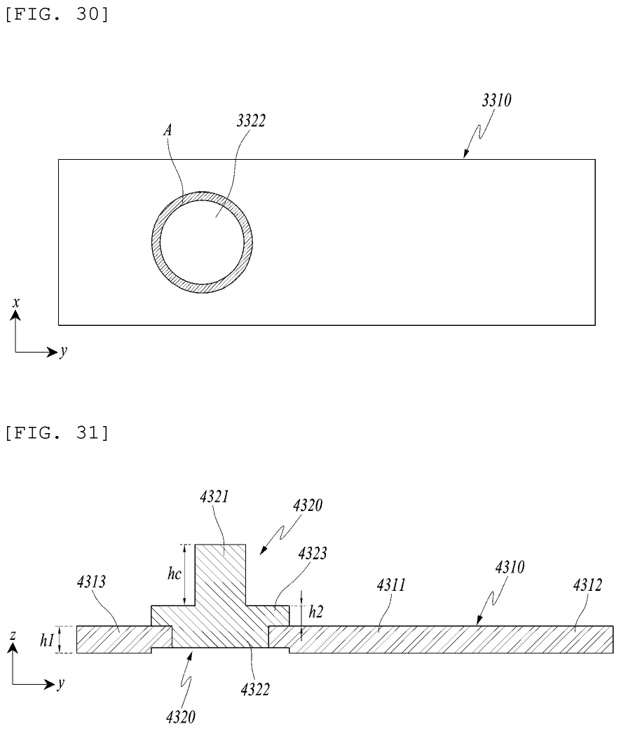

FIG. 27 is a view illustrating a current collecting unit in the secondary battery according to the third aspect of the present disclosure. FIG. 28A is a view illustrating a pole unit in the secondary battery according to the third aspect of the present disclosure. FIG. 29 is a view illustrating a process of assembling the current collecting unit with the pole unit in the third aspect of the present disclosure.

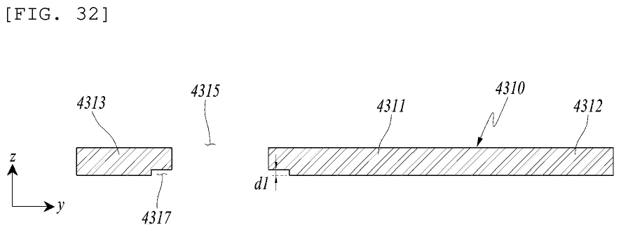

FIG. 30 is a view illustrating a welding region on a lower surface of the current collecting unit in the secondary battery according to the third aspect of the present disclosure.

As illustrated in FIGS. 20 and 21, a current collector 3300 may include a current collecting unit 3310 and a pole unit 3320. The current collecting unit 3310 may include a first current collecting portion 3311, a second current collecting portion 3312, and a connection portion 3313.

The current collecting unit 3310 may have a rectangular shape extending in the longitudinal direction (y direction) of the electrode assembly 1200. The current collecting unit 3310 may be configured such that the connection portion 3313, the first current collecting portion 3311, and the second current collecting portion 3312 are successively arranged in a longitudinal direction of the rectangular shape. A thickness of each of the first current collecting portion 3311 and the second current collecting portion 3312 may range from 0.5 mm to 3.0 mm. A curvature radius of an edge of an upper surface of the current collector 3300 may be 0.25 mm to 0.35 mm.

An opening 3315a may be formed in the connection portion 3313.

A stopper 3314 may be disposed on an upper surface of the connection portion 3313. The stopper 3314 may protrude from the upper surface of the connection portion 3313 by a predetermined height h2. The height h2 of the stopper 3314 may be equal to or greater than a height to which the plurality of first electrode tabs 1220 and the plurality of second electrode tabs 1230 are welded on the upper surface of the current collector 3300. As the numbers of first electrode tabs 1220 and second electrode tabs 1230 increase, that is, as the thickness of the electrode assembly 1200 (in the x direction in FIG. 2) increases, the height h2 of the stopper 3314 may also increase. The height h2 of the stopper 3314 may be 1% to 5% of the thickness of the electrode assembly 1200, and may be 2.5%, for example. When two current collectors 3300 are disposed on the electrode portion 1210, the stoppers 3314 may have the same height.

The height (h2) of the stopper 3314 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

In accordance with the present disclosure, a large number of electrode tabs can be welded onto a current collector by forming multiple groups, and the height of the stopper may decrease as the number of groups of electrode tabs of the same polarity increases.

The stopper 3314 may have a square plate shape, a rectangular plate shape, or a disc shape. In the present aspect, the case in which the stopper 3314 has a disc shape will be described. An upper surface of the stopper 3314 may be formed as a flat surface to support a component to be assembled thereto and may have a predetermined area. The stopper 3314 may be integrally formed with the connection portion 3313.

The stopper 3314 may protrude upward from the upper surface of the connection portion 3313, and the height h2 thereof may be smaller than the thickness of the current collecting unit 3310. Specifically, the height h2 of the stopper 3314 may be 30% to 50% of a thickness h1 of an end of the first current collecting portion 3311 or the second current collecting portion 3312. Due to the stopper 3314, a stepped structure of the current collecting unit 3310 may be formed (see FIG. 26).

As illustrated in FIG. 27, an opening 3315b may be formed in the stopper 3314. The opening 3315b may be formed to pass through a center of the stopper 3314. In this case, the opening 3315b of the stopper 3314 may be connected to the opening 3315a of the connection portion 3313 to form a continuous opening 3315. A support portion 3322 of the pole unit 3320 may be inserted through the opening 3315. In the present aspect, a recessed region may be formed to have the same diameter as the opening 3315, and accordingly, the recessed region may be integrated with the opening 3315 formed in the connection portion 3313.

The pole unit 3320 may be electrically connected to the corresponding electrode terminal. A material of the pole unit 3320 may be the same as or different from that of the current collecting unit 3310. For example, the current collecting unit 3310 and the pole unit 3320 may both be made of aluminum. Alternatively, the current collecting unit 3310 may be made of copper, and the pole unit 3320 may be made of aluminum. According to the present disclosure, as the current collecting unit 3310 and the pole unit 3320 are formed as separate components, flexibility in selecting materials and dimensions of components may be increased.

The pole unit 3320 may include a current collecting protrusion 3321 and a support portion 3322 (see FIG. 28A). The current collecting protrusion 3321 may have a cylindrical shape having a predetermined height hc. The current collecting protrusion 3321 may be electrically connected to the corresponding electrode terminal. The current collecting protrusion 3321 may be supported by the support portion 3322 and may be connected to the current collecting unit 3310. The support portion 3322 may be fitted into the opening 3315 of the connection portion 3313 and the stopper 3314 and may be fixed in close contact with an inner wall of the opening 3315. To allow a component fitted over the current collecting protrusion 3321 to be stably supported on the stopper 3314, the stopper 3314 may have a predetermined area.

In order to facilitate coupling between the current collecting protrusion 3321 and the component, the height hc of the current collecting protrusion 3321 may be formed to be greater than the height h2 of the stopper 3314 within a predetermined range. Specifically, the height h2 of the stopper 3314 may be 10% to 20% of the height hc of the current collecting protrusion 3321, and may be 15%, for example.

The support portion 3322 may be connected to a lower end of the current collecting protrusion 3321 and may have a square plate shape, a rectangular plate shape, or a disc shape. The support portion 3322 may have a shape corresponding to that of the opening 3315. A cross-sectional area of the opening 3315 may also be square, rectangular, or circular.

The support portion 3322 may extend from a lower surface of the connection portion 3313 to a height corresponding to the upper surface of the stopper 3314 disposed on the connection portion 3313. A lower surface of the support portion 3322 may be flush with the lower surface of the connection portion 3313. In addition, an upper surface of the support portion 3322 may be flush with the upper surface of the stopper 3314.

An area of a continuous surface formed by the upper surface of the stopper 3314 and the upper surface of the support portion 3322 may be 2 times to 5 times an area of a horizontal cross section of the current collecting protrusion 3321. As the continuous surface formed by the upper surface of the stopper 3314 and the upper surface of the support portion 3322 is formed to be larger than a cross-sectional area of the current collecting protrusion 3321, the component may be stably supported. The area of the continuous surface formed by the upper surface of the stopper 3314 and the upper surface of the support portion 3322 may be 3% to 6% of an upper surface of the current collecting unit 3310.

The support portion 3322 may support the current collecting protrusion 3321 such that the current collecting protrusion 3321 is perpendicular to the current collecting unit 3310 when the pole unit 3320 is connected to the current collecting unit 3310. The current collecting protrusion 3321 and the support portion 3322 may be integrally formed.

After the support portion 3322 is fitted into the opening 3315 of the current collecting unit 3310, the support portion 3322 and the current collecting unit 3310 may be joined by welding. The welding may be performed on the lower surface of the support portion 3322. Due to the welding, a welding region may be formed on the lower surface of the support portion 3322.

As illustrated in FIG. 30, in an aspect, the welding region may be formed on an outer periphery (region A) of the lower surface of the support portion 3322. The welding may be performed at a boundary surface between the support portion 3322 and the connection portion 3313.

In the case in which the support portion 3322 is formed in a square plate shape, undesired rotation of the current collecting protrusion 3321 may be prevented by fitting the support portion 3322 into the opening 3315 of the current collecting unit 3310.

A width of the current collector 3300 may be 0.3 times to 0.8 times the thickness of the electrode assembly 1200. The current collector 3300 may have a thickness of 0.5 mm to 3.0 mm.

An insulator may be disposed under the current collector 3300. The insulator may be an insulating plate or an insulating film. The insulator may more reliably protect the electrode tabs 1220 and 1230 and the electrode portion 1210.

The insulator may be applied or attached to a lower surface of the current collector 3300 with a predetermined thickness after the pole unit 3320 is welded to the current collecting unit 3310.

Hereinafter, a current collector of a secondary battery according to a fourth aspect of the present disclosure will be described. Description of elements identical to those of the first aspect to the third aspect is omitted or simplified.

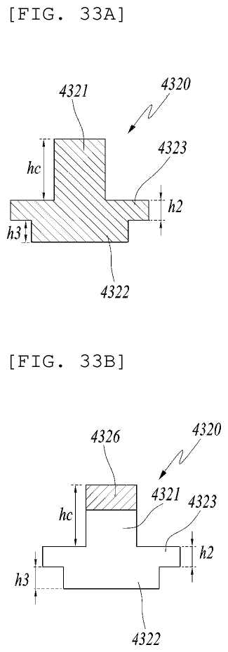

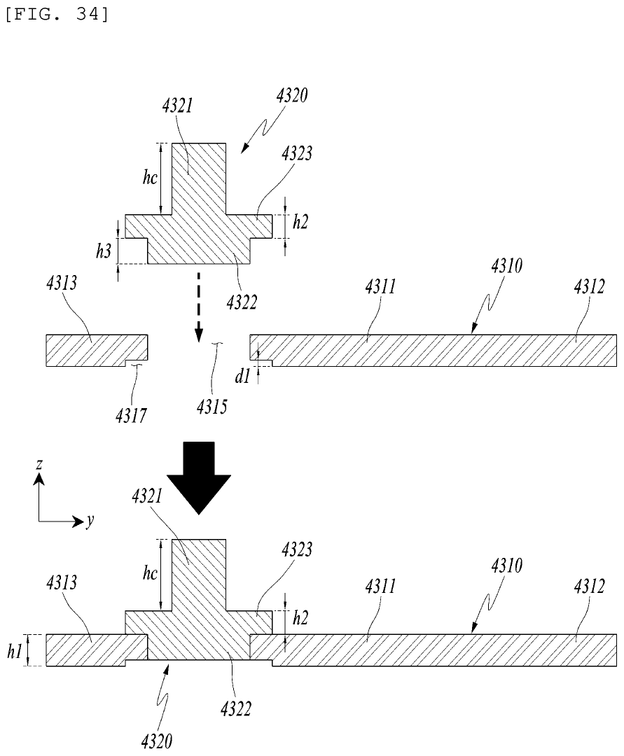

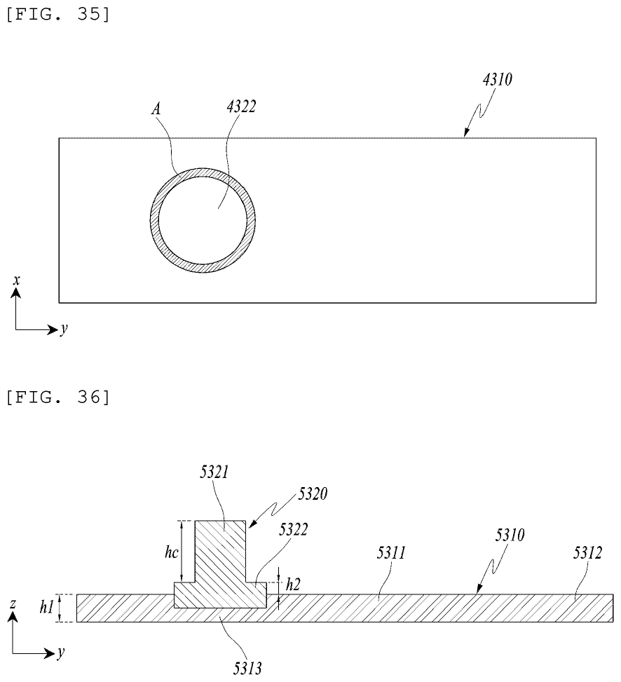

FIG. 31 is a view illustrating a current collector in the secondary battery according to the fourth aspect of the present disclosure. FIG. 32 is a view illustrating a current collecting unit in the secondary battery according to the fourth aspect of the present disclosure. FIG. 33A is a view illustrating a pole unit in the secondary battery according to the fourth aspect of the present disclosure. FIG. 34 is a view illustrating a process of assembling the current collecting unit with the pole unit in the fourth aspect of the present disclosure.

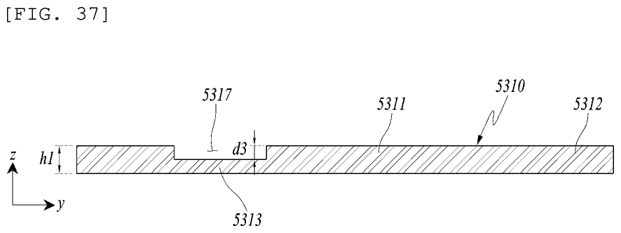

FIG. 35 is a view illustrating a welding region on a lower surface of the current collecting unit in the secondary battery according to the fourth aspect of the present disclosure.

As illustrated in FIG. 31, a current collector 4300 may include a current collecting unit 4310 and a pole unit 4320. The current collecting unit 4310 may be connected to the plurality of electrode tabs 1220 and 1230. The pole unit 4320 may be connected to a corresponding electrode terminal.

The current collecting unit 4310 may have a rectangular shape extending in the longitudinal direction (y direction) of the electrode assembly 1200, and may include a connection portion 4313, a first current collecting portion 4311, and a second current collecting portion 4312 that are successively arranged in a longitudinal direction of the rectangular shape. The connection portion 4313, the first current collecting portion 4311, and the second current collecting portion 4312 may be made of the same material and may be integrally formed.

The first current collecting portion 4311 may be welded to the plurality of first electrode tabs 1220. The second current collecting portion 4312 may be welded to the plurality of second electrode tabs 1230. The connection portion 4313 may be formed to have the same thickness as the first current collecting portion 4311 and the second current collecting portion 4312. A thickness of the connection portion 4313 may range from 0.5 mm to 3.0 mm. A curvature radius of an edge of an upper surface of the current collector 4300 may be 0.25 mm to 0.35 mm.

The connection portion 4313 may be coupled to the pole unit 4320.

As illustrated in FIG. 32, an opening 4315 may be formed in the connection portion 4313. The pole unit 4320 may be coupled to the connection portion 4313 through the opening 4315.

A recessed region 4317 may be formed in a lower surface of the current collecting unit 4310. The recessed region 4317 may have a disc shape, a square plate shape, or a rectangular plate shape, and may define an empty space extending upward from a lower surface of the connection portion 4313 of the current collecting unit 4310. A cross-sectional area of the recessed region 4317 may be larger than a cross-sectional area of the opening 4315. For example, when the opening 4315 and the recessed region 4317 are disc shapes, a diameter of the recessed region 4317 may be larger than that of the opening 4315. A depth d1 of the recessed region 4317 may be 5% to 15% of a thickness h1 of an end of the current collecting unit 4310.

The pole unit 4320 may be coupled to the current collecting unit 4310 and may electrically connect the electrode tabs 1220 and 1230 of the electrode portion 1210 to the corresponding electrode terminal. A material of the pole unit 4320 may be the same as or different from that of the current collecting unit 4310.

As illustrated in FIG. 33A, the pole unit 4320 may include a current collecting protrusion 4321, a support portion 4322, and a flange 4323. The current collecting protrusion 4321 may have a cylindrical shape having a predetermined height hc. The current collecting protrusion 4321 may be electrically connected to the corresponding electrode terminal.

The support portion 4322 and the flange 4323 may be connected to a lower end of the current collecting protrusion 4321 and may each have a disc shape or a rectangular plate shape. A shape of the support portion 4322 may be the same as that of the opening 4315 of the current collecting unit 4310. The support portion 4322 may be inserted into the opening 4315 of the current collecting unit 4310. The support portion 4322 may support the current collecting protrusion 4321 such that the current collecting protrusion 4321 is perpendicular to the current collecting unit 4310 when the pole unit 4320 is connected to the current collecting unit 4310.

A diameter of the support portion 4322 may be smaller than that of the recessed region 4317. In addition, a height h3 of the support portion 4322 may be the same as a length of the opening 4315. That is, when the support portion 4322 is inserted into the opening 4315, a lower surface of the support portion 4322 may be flush with an upper surface of the recessed region 4317 and may be positioned above the lower surface of the current collecting unit 4310 (as shown in FIG. 34).

The flange 4323 may be disposed between the current collecting protrusion 4321 and the support portion 4322. A cross-sectional area of the flange 4323 may be larger than that of the support portion 4322. Accordingly, the flange 4323 may contact the upper surface of the connection portion 4313 and may prevent the support portion 4322 from moving downward through the opening 4315 beyond a predetermined depth. When the support portion 4322 is inserted into the opening 4315, the flange 4323 may contact a peripheral surface surrounding the opening 4315, thereby enabling the current collecting protrusion 4321 to be supported more stably.

When the current collector 4300 is coupled to another component (e.g., cap plate and/or stopper), the flange 4323 may define a lower limit position of the component to be coupled to the current collector 4300. The flange 4323 may protrude by a predetermined height from the upper surface of the connection portion 4313. Due to the flange 4323, the component assembled to the current collector 4300 may be horizontally aligned.

A height h2 of the flange 4323 may be 1% to 5% of the thickness of the electrode assembly 1200, and may be 2.5%, for example. When two current collectors 4300 are disposed on the electrode portion 1210, the flanges 4323 may have the same height.

The height (h2) of the flange 4323 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

The flange 4323 may have a square plate shape, a rectangular plate shape, or a disc shape. An upper surface of the flange 4323 may be formed as a flat surface to support the component to be assembled thereto, and may have a predetermined area. The cross-sectional area of the flange 4323 may be 3% to 6% of the upper surface of the current collecting unit 4310.

In the case where the support portion 4322 and the flange 4323 each have a cylindrical shape, the diameter of the flange 4323 may be 1.2 times to 1.4 times that of the support portion 4322. In the case where the support portion 4322 and the flange 4323 each have a quadrangular column shape, a length of one side of the flange 4323 may be 1.2 times to 1.4 times that of one side of the support portion 4322. As the length and the area of the flange 4323 are secured, the pole unit 4320 may be stably fixed on the connection portion 4313, and the component coupled to the current collecting protrusion 4321 may be stably supported.

An area of a horizontal cross section of the flange 4323 may be 5 times to 15 times, preferably 10 times that of a horizontal cross section of the current collecting protrusion 4321. In addition, in the case where the flange 4323 has a cylindrical shape, the diameter of the current collecting protrusion 4321 may be 20% to 50%, preferably 30% of that of the flange 4323. As the cross-sectional area of the flange 4323 is formed to be larger than that of the current collecting protrusion 4321 and the diameter of the flange 4323 is formed to be larger than that of the current collecting protrusion 4321, the component connected thereto may be stably supported.

The flange 4323 may protrude upward from the upper surface of the connection portion 4313, and a height of the flange 4323 may be equal to or greater than the thickness of the current collecting unit 4310. Specifically, the height of the flange 4323 may be 100% to 120% of the height of an end of the current collecting unit 4310, that is, an end of the first current collecting portion 4311 or the second current collecting portion 4312. In the case where the height of the flange 4323 exceeds 120% of the thickness of the connection portion 4313, a spacing between the component coupled to the current collecting protrusion 4321 and the connection portion 4313 may increase, and airtightness may be degraded.

The height h2 of the flange 4323 may be equal to or greater than a height to which the plurality of first electrode tabs 1220 and the plurality of second electrode tabs 1230 are welded on the upper surface of the current collector 4310. As the numbers of first electrode tabs 1220 and second electrode tabs 1230 increase, that is, as the thickness of the electrode assembly 1200 (in the x direction in FIG. 2) increases, the height h2 of the flange 4323 may also increase. When two current collectors 1300 are disposed on the electrode portion 1210, the flange 4323 may have the same height. Accordingly, the flange 4323 may act in the same manner as a stopper as discussed in connection with other aspects herein, and indeed the flange 4323 may be referred to as a “stopper.”

Due to the flange 4323, a stepped structure of the current collector 4300 may be formed.

In order for the component (e.g., cap assembly and/or terminal) fitted over the current collecting protrusion 4321 to be stably supported on the flange 4323, the flange 4323 may have a predetermined area. The area of the horizontal cross section of the flange 4323 may be 2 times to 5 times that of the horizontal cross section of the current collecting protrusion 4321. As the cross-sectional area of the flange 4323 is formed to be larger than that of the current collecting protrusion 4321, the component may be stably supported.

In order to facilitate coupling between the current collecting protrusion 4321 and the component, a height hc of the current collecting protrusion 4321 may be formed to be greater than the height h2 of the flange 4323 within a predetermined range. Specifically, the height of the flange 4323 may be 30% to 50%, preferably 40% of the height hc of the current collecting protrusion 4321, and may be 15%, for example. In the case where the height of the flange 4323 is greater than 50% of the height hc of the current collecting protrusion 4321, a height difference between an upper surface of the flange 4323 and upper surfaces of the first and second current collecting portions 4311 and 4312 may increase, thereby making it difficult to stably support the component.

The current collecting protrusion 4321, the support portion 4322, and the flange 4323 may be integrally formed.

In the case of a negative current collector, an upper end of the current collecting protrusion 4321 made of copper may be plated with nickel. A height of a nickel plating layer may be 1.5 mm to 2.5 mm from the upper end of the current collecting protrusion 4321. The height of the nickel plating layer may be 30% to 50% of that of the current collecting protrusion 4321. A thickness of the nickel plating layer may range from 2 μm to 4 μm. As the upper end of the current collecting protrusion 4321 is plated with nickel, welding strength when the current collecting protrusion 4321 is welded to the electrode terminal may be further enhanced.

After the support portion 4322 is fitted into the opening 4315 of the current collecting unit 4310, the support portion 4322 and the current collecting unit 4310 may be joined by welding. The welding may be performed on a periphery of the lower surface of the support portion 4322. Due to the welding, a welding region A may be formed on the lower surface of the support portion 4322.

As illustrated in FIG. 35, in an aspect, the welding region may be formed on the outer periphery (region A) of the lower surface of the support portion 4322. The support portion 4322 may be positioned at a position spaced apart from the lower end of the connection portion 4313 by a predetermined distance, so that, even when welding burrs are generated, the welding burrs do not protrude below the lower surface of the current collecting unit 4310.

According to the present disclosure, a sufficient welding area may be secured by the support portion 4322 having a disc shape or a rectangular shape, so that the current collecting protrusion 4321 may be stably connected to the current collecting unit 4310. Furthermore, in the case where the support portion 4322 is formed in a square plate shape and is received in the opening 4315, undesired rotation of the current collecting protrusion 4321 may be prevented.

A width of the current collector 4300 may be 0.3 times to 0.8 times the thickness of the electrode assembly 1200. The current collector 4300 may have a thickness of 0.5 mm to 3.0 mm.

An insulator may be disposed under the current collector 4300. The insulator may be an insulating plate or an insulating film. The insulator may more reliably protect the electrode tabs 1220 and 1230 and the electrode portion 1210.

The insulator may be applied or attached to a lower surface of the current collector 4300 with a predetermined thickness after the pole unit 4320 is welded to the current collecting unit 4310.

Hereinafter, a current collector of a secondary battery according to a fifth aspect of the present disclosure will be described. Description of elements identical to those of the first to fourth aspects is omitted or simplified.

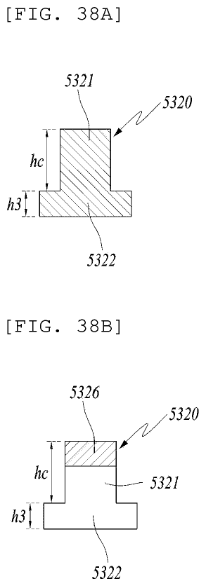

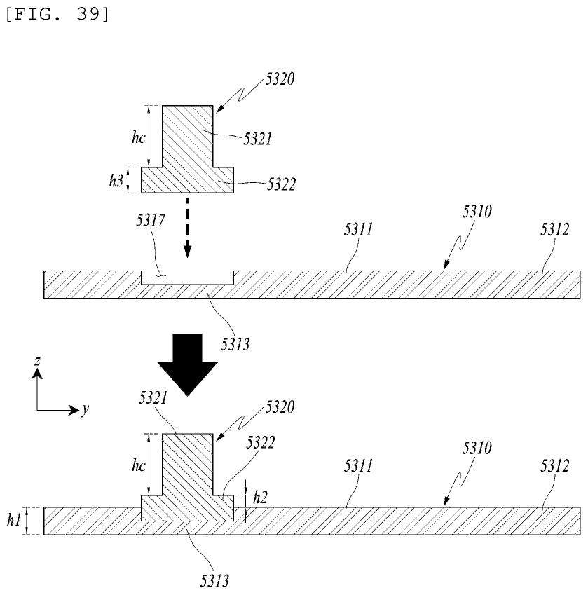

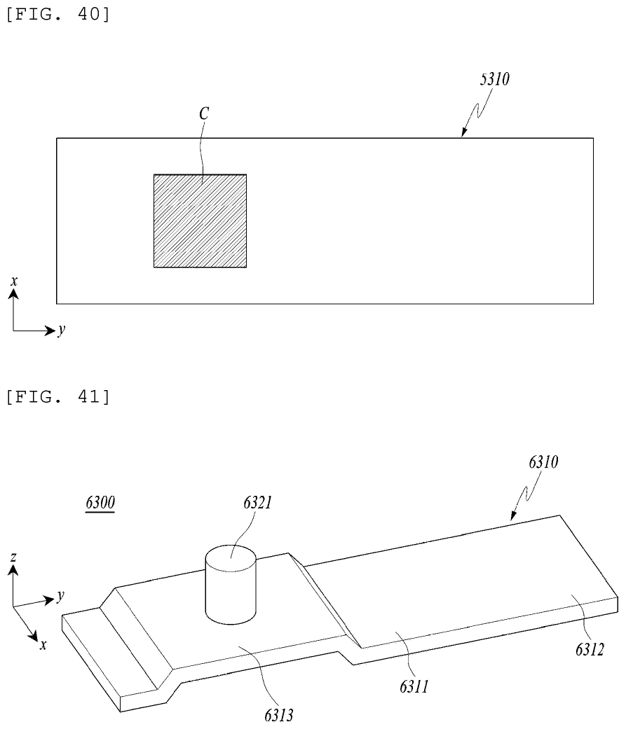

FIG. 36 is a view illustrating a current collector in a secondary battery according to a fifth aspect of the present disclosure. FIG. 37 is a view illustrating a current collecting unit in the secondary battery according to the fifth aspect of the present disclosure. FIG. 38A is a view illustrating a pole unit in the secondary battery according to the fifth aspect of the present disclosure. FIG. 39 is a view illustrating a process of assembling the current collecting unit with the pole unit in the fifth aspect of the present disclosure.

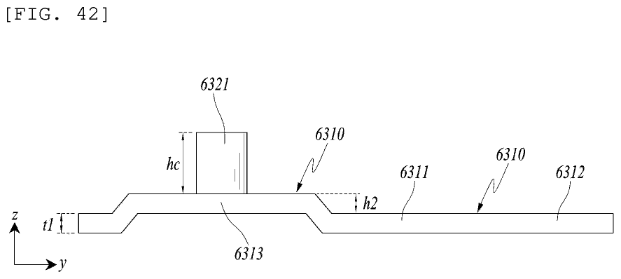

FIG. 40 is a view illustrating a welding region on a lower surface of the current collecting unit in the secondary battery according to the fifth aspect of the present disclosure.

As illustrated in FIG. 36, a current collector 5300 may include a current collecting unit 5310 and a pole unit 5320. The current collecting unit 5310 may include a first current collecting portion 5311, a second current collecting portion 5312, and a connection portion 5313.

The current collecting unit 5310 may have a rectangular shape extending in the longitudinal direction (y direction) of the electrode assembly 1200. The current collecting unit 5310 may be configured such that the connection portion 5313, the first current collecting portion 5311, and the second current collecting portion 5312 are successively arranged in a longitudinal direction of the rectangular shape. The first current collecting portion 5311 and the second current collecting portion 5312 may have a predetermined thickness h1. Specifically, the thickness h1 of each of the first current collecting portion 5311 and the second current collecting portion 5312 may range from 0.5 mm to 3.0 mm.

The connection portion 5313 may be connected to one side of the first current collecting portion 5311. The second current collecting portion 5312 may be connected to a remaining side of the first current collecting portion 5311. The connection portion 5313 may be formed with a seating region 5317. The seating region 5317 may be formed by recessing a portion of the connection portion 5313 to a predetermined depth d3. A depth d3 of the seating region 5317 may be 30% to 50% of a thickness h1 of an end of the current collecting unit 5310. A cross-sectional shape of the seating region 5317 may be a square shape, a rectangular shape, or a circular shape.

The pole unit 5320 may be electrically connected to the corresponding electrode terminal. A material of the pole unit 5320 may be the same as or different from that of the current collecting unit 5310. For example, the current collecting unit 5310 and the pole unit 5320 may both be made of aluminum. Alternatively, the current collecting unit 5310 may be made of copper, and the pole unit 5320 may be made of aluminum. According to the present disclosure, as the current collecting unit 5310 and the pole unit 5320 are formed as separate components, flexibility in selecting materials and dimensions of components may be increased.

The pole unit 5320 may include a current collecting protrusion 5321 and a support portion 5322 (see FIG. 38A). The current collecting protrusion 5321 may have a cylindrical shape having a predetermined height hc. The current collecting protrusion 5321 may be electrically connected to the corresponding electrode terminal.

The support portion 5322 may be connected to a lower end of the current collecting protrusion 5321 and may have a square plate shape, a rectangular plate shape, or a disc shape. A lower portion of the support portion 5322 may be received in the seating region 5317 of the connection portion 5313. A height h3 of the support portion 5322 may be greater than a depth d3 of the seating region 5317. Accordingly, when the support portion 5322 is seated in the seating region 5317, an upper surface of the support portion 5322 may protrude from an upper surface of the connection portion 5313 by a predetermined height h2.

The height h2 by which the support portion 5322 protrudes from the upper surface of the connection portion 5313, that is, an upper surface of the current collecting unit 5310, may be smaller than a thickness of an end of the current collecting unit 5310. Specifically, the height h2 by which the support portion 5322 protrudes from the upper surface of the connection portion 5313 may be 30% to 50% of the thickness h1 of an end of the first current collecting portion 5311 or the second current collecting portion 5312. Due to protrusion of the support portion 5322, a stepped structure of the current collector 5300 may be formed (see FIG. 39).

The height h2 of the protruding portion may be equal to or greater than a height to which the plurality of first electrode tabs 1220 and the plurality of second electrode tabs 1230 are welded on the upper surface of the current collector 5300. As a result, the upwardly protruding portion of the support portion 5322 may act as a stopper, like that discussed in connection with other aspects herein, and at least that protruding portion of the support portion 5322 may also be referred to as a “stopper” herein. As the numbers of first electrode tabs 1220 and second electrode tabs 1230 increase, that is, as the thickness of the electrode assembly 1200 (in the x direction in FIG. 2) increases, the height h2 of the protruding portion of the support portion 5322 may increase. The height h2 of the protruding portion of the support portion 5322 may be 1% to 5% of the thickness of the electrode assembly 1200, and may be 2.5%, for example. The height (h2) of the stopper 5322 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

In accordance with the present disclosure, a large number of electrode tabs can be welded onto a current collector by forming multiple groups, and the height of the stopper may decrease as the number of groups of electrode tabs of the same polarity increases.

When two current collectors 5300 are disposed on the electrode portion 1210, the protruding portions of the support portions 5322 may have the same height h2. In order for a component (e.g., cap plate and/or terminal) fitted over the current collecting protrusion 5321 to be stably supported on the protruding portion of the support portion 5322, the support portion 5322 may have a predetermined area. An area of a horizontal cross-section of the support portion 5322 may be 3 times to 5 times that of a horizontal cross-section of the current collecting protrusion 5321.

A shape of the support portion 5322 may be a square plate shape, a rectangular plate shape, or a disc shape. In the present aspect, the case in which the support portion 5322 has a square plate shape is described. The support portion 5322 and the seating region 5317 may have the same cross-sectional shape and may thus be matched to each other.

The upper surface of the support portion 5322 may be formed as a flat surface to support the component to be assembled thereto. The current collecting protrusion 5321 and the support portion 5322 may be integrally formed.

After the support portion 5322 is fitted into the seating region 5317 of the current collecting unit 5310, the support portion 5322 and the current collecting unit 5310 may be joined by welding. The welding may be performed on a lower surface of the connection portion 5313 in which the seating region 5317 is formed. By the welding, a welding region may be formed on the lower surface of the connection portion 5313.

As illustrated in FIG. 40, in an aspect, the welding region may be formed on the lower surface of the connection portion 5313 in a region (region C) corresponding to a lower surface of the support portion 5322. The welding may be performed on the lower surface of the connection portion 5313 so that the lower surface of the support portion 5322 is welded.

In the case where the support portion 5322 is formed in a square plate shape, undesired rotation of the current collecting protrusion 5321 may be prevented by fitting the support portion 5322 into the square-shaped seating region 5317 of the current collecting unit 5310.

A width of the current collector 5300 may be 0.3 times to 0.8 times the thickness of the electrode assembly 1200. The current collector 5300 may have a thickness of 0.5 mm to 3.0 mm. A curvature radius of an edge of an upper surface of the current collector 5300 may range from 0.25 mm to 0.35 mm.

An insulator may be disposed under the current collector 5300. The insulator may be an insulating plate or an insulating film. The insulator may more reliably protect the electrode tabs 1220 and 1230 and the electrode portion 1210.

The insulator may be applied or attached to a lower surface of the current collector 5300 with a predetermined thickness after the pole unit 5320 is welded to the current collecting unit 5310.

Hereinafter, a current collector of a secondary battery according to a sixth aspect of the present disclosure will be described. Description of elements identical to those of the first to fifth aspects is omitted or simplified.

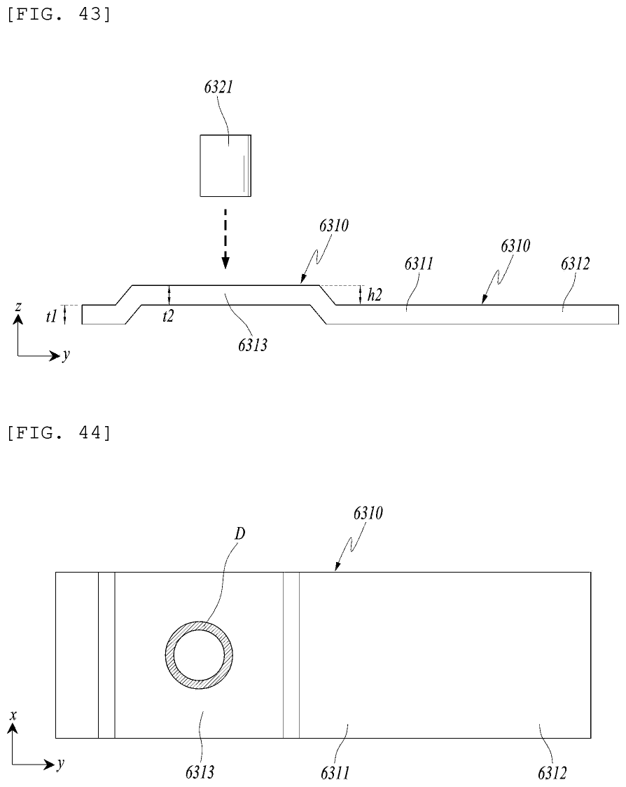

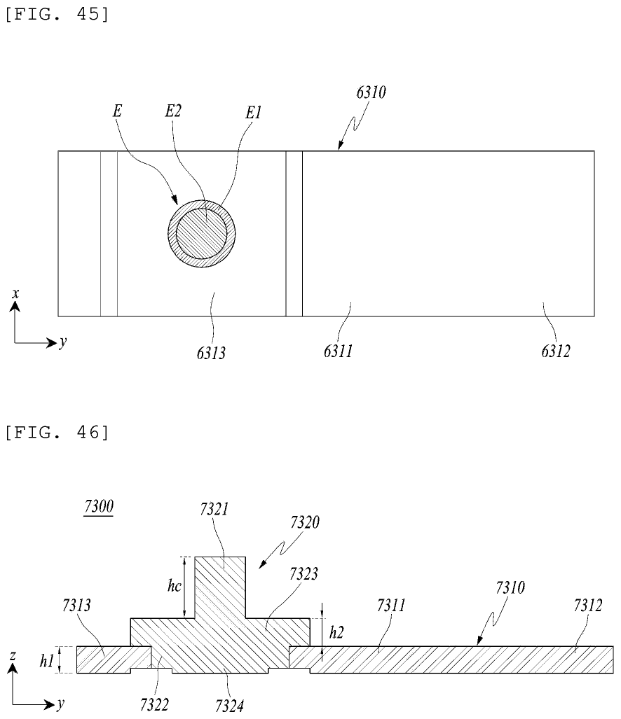

FIG. 41 is a view illustrating a current collector in a secondary battery according to a sixth aspect of the present disclosure. FIG. 42 is a view illustrating the current collector in the secondary battery according to the sixth aspect of the present disclosure. FIG. 43 is a view illustrating a process of assembling a current collecting unit with a pole unit in the sixth aspect of the present disclosure.

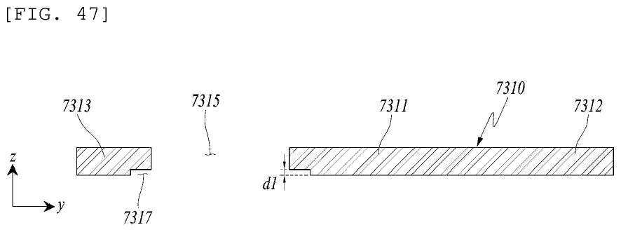

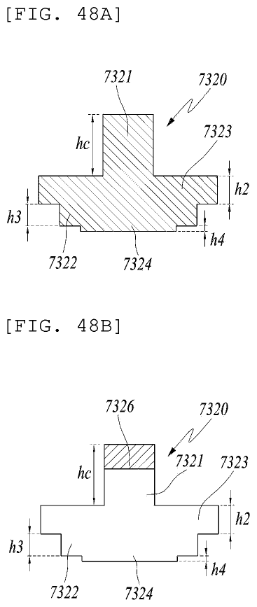

FIG. 44 is a view illustrating a welding region on a lower surface of the current collecting unit in the secondary battery according to the sixth aspect of the present disclosure. FIG. 45 is a view illustrating a welding region on the lower surface of the current collecting unit in the secondary battery according to an aspect of the present disclosure.

As illustrated in FIGS. 36 to 38, a current collector 6300 may include a current collecting unit 6310 and a pole unit 6320. The current collecting unit 6310 may include a first current collecting portion 6311, a second current collecting portion 6312, and a connection portion 6313.

The current collecting unit 6310 may have a rectangular shape extending in the longitudinal direction (y direction) of the electrode assembly 1200. The current collecting unit 6310 may be configured such that the connection portion 6313, the first current collecting portion 6311, and the second current collecting portion 6312 are successively arranged in a longitudinal direction of the rectangular shape. The first and second current collecting portions 6311 and 6312 and the connection portion 6313 may respectively have predetermined thicknesses t1 and t2. The thickness t2 of the connection portion 6313 may be the same as the thickness t1 of the first current collecting portion 6311 and the second current collecting portion 6312. Specifically, the thicknesses of the first current collecting portion 6311, the second current collecting portion 6312, and the connection portion 6313 may range from 0.5 mm to 3.0 mm.

The connection portion 6313 may be connected to one side of the first current collecting portion 6311. The second current collecting portion 6312 may be connected to a remaining side of the first current collecting portion 6311. The connection portion 6313 may protrude from the first current collecting portion 6311 and the second current collecting portion 6312. An upper surface of the connection portion 6313 may be positioned above upper surfaces of the first current collecting portion 6311 and the second current collecting portion 6312 by a predetermined height h2.

The protruding height h2 of the connection portion 6313 may be smaller than a height t1 of an end of the current collecting unit 6310. Specifically, the protruding height h2 of the connection portion 6313 may be 30% to 50% of the thickness h1 of an end of the first current collecting portion 6311 or the second current collecting portion 6312. Due to the connection portion 6313 having a protruding structure, a stepped structure of the current collecting unit 6310 may be formed (see FIG. 42).

The protruding height h2 of the connection portion 6313 may be equal to or greater than a height to which the plurality of first electrode tabs 1220 and the plurality of second electrode tabs 1230 are welded on the upper surface of the current collector 6300. As a result, the connection portion 5313 may act as a stopper, like that discussed in connection with other aspects herein, and the connection portion 5313 may also be referred to as a “stopper” herein. As the numbers of first electrode tabs 1220 and second electrode tabs 1230 increase, that is, as the thickness of the electrode assembly 1200 (in the x direction in FIG. 2) increases, the protruding height h2 of the connection portion 6313 may increase. The protruding height h2 of the connection portion 6313 may be 1% to 5% of the thickness of the electrode assembly 1200, and may be 2.5%, for example.

The height (h2) of the stopper 5313 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

When two current collectors 6300 are disposed on the electrode portion 1210, the connection portions 6313 may protrude by the same height.

The upper surface of the connection portion 6313 may be formed as a flat surface to support a component (e.g., cap plate and/or terminal) to be assembled thereto. A seating region may be formed on the upper surface of the connection portion 6313. An upper surface of the seating region may be flush with the upper surface of the connection portion 6313. The pole unit 6320 may be connected on the surface of the seating region.

The connection portion 6313 may be formed by bending the current collecting unit 6310 such that one end of the current collecting unit 6310 protrudes. As the current collecting unit 6310 is bent, a surface to which the connection portion 6313 and the first current collecting portion 6311 are connected may form an inclination.

The pole unit 6320 may be electrically connected to the corresponding electrode terminal. A material of the pole unit 6320 may be the same as or different from that of the current collecting unit 6310. For example, the current collecting unit 6310 and the pole unit 6320 may both be made of aluminum. Alternatively, the current collecting unit 6310 may be made of copper, and the pole unit 6320 may be made of aluminum. According to the present disclosure, as the current collecting unit 6310 and the pole unit 6320 are formed as separate components, flexibility in selecting materials and dimensions of components may be increased.

The pole unit 6320 may include a current collecting protrusion 6321. The current collecting protrusion 6321 may have a cylindrical shape having a predetermined height hc. The current collecting protrusion 6321 may be electrically connected to the corresponding electrode terminal. The current collecting protrusion 6321 may be joined to the seating region formed on the upper surface of the connection portion 6313.

The current collecting protrusion 6321 and the current collecting unit 6310 may be joined to each other by welding. The welding may be performed on a lower surface of the connection portion 6313. By the welding, a welding region may be formed on the lower surface of the connection portion 6313. As illustrated in FIG. 44, in an aspect, the welding region may be formed in a region (region D) corresponding to an outer periphery of the current collecting protrusion 6321. In an aspect, the welding region may be formed over an entire region (region E, see FIG. 45) corresponding to a bottom surface of the current collecting protrusion 6321. In this case, laser output for welding in the region corresponding to the outer periphery of the current collecting protrusion 6321 may be greater than laser output in the region corresponding to an inner side of the current collecting protrusion 6321.

In order to facilitate coupling between the current collecting protrusion 6321 and the component, a height hc of the current collecting protrusion 6321 may be formed to be greater than the protruding height h2 of the connection portion 6313 within a predetermined range. Specifically, the protruding height h2 of the connection portion 6313 may be 10% to 20% of the height hc of the current collecting protrusion 6321, and may be 15%, for example.

A width of the current collector 6300 may be 0.3 times to 0.8 times the thickness of the electrode assembly 1200. The current collector 6300 may have a thickness of 0.5 mm to 3.0 mm. A curvature radius of an edge of the upper surface of the current collector 6300 may range from 0.25 mm to 0.35 mm.

An insulator may be disposed under the current collector 6300. The insulator may be an insulating plate or an insulating film. The insulator may more reliably protect the electrode tabs 1220 and 1230 and the electrode portion 1210.

The insulator may be applied or attached to a lower surface of the current collector 6300 with a predetermined thickness after the pole unit 6320 is welded to the current collecting unit 6310.

A coupling structure between the connection portion and the pole unit of the present disclosure may be applied to various types of current collectors.

Hereinafter, a current collector of a secondary battery according to a seventh aspect of the present disclosure will be described. Description of elements identical to those of the first aspect to the sixth aspect is omitted or simplified.

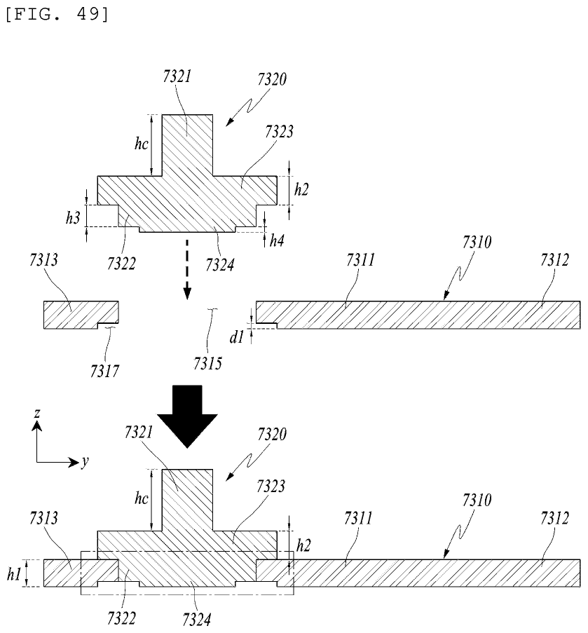

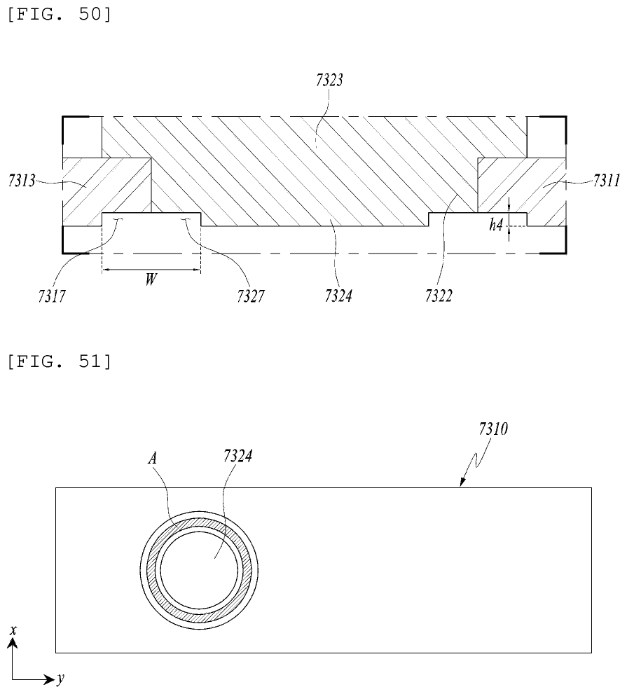

FIG. 46 is a side cross-sectional view illustrating a current collector in a secondary battery according to a seventh aspect of the present disclosure. FIG. 47 is a side cross-sectional view illustrating a current collecting unit of the current collector of FIG. 46 according to the seventh aspect of the present disclosure. FIG. 48A is a side cross-sectional view illustrating a pole unit of the current collector of FIG. 46. FIG. 48B is a side elevation view of the pole unit of FIG. 48A, illustrating a nickel plating layer formed on an upper end of the current collecting protrusion. FIG. 49 includes sequential side cross-sectional views illustrating a process of assembling the current collecting unit with the pole unit in the seventh aspect of the present disclosure. FIG. 50 is an enlarged side cross-sectional view of an assembled relationship between the pole unit and the current collecting unit of FIG. 49. FIG. 51 is a bottom plan view illustrating a welding region on a lower surface of the current collecting unit in the secondary battery according to the seventh aspect of the present disclosure.

As illustrated in FIG. 46, a current collector 7300 may include a current collecting unit 7310 and a pole unit 7320. The current collecting unit 7310 may be connected to the plurality of electrode tabs 1220 and 1230. The pole unit 7320 may be connected to a corresponding electrode terminal.

The current collecting unit 7310 may have a rectangular shape extending in the longitudinal direction (y direction) of the electrode assembly 1200, and may include a connection portion 7313, a first current collecting portion 7311, and a second current collecting portion 7312 that are successively arranged in a longitudinal direction of the rectangular shape. The connection portion 7313, the first current collecting portion 7311, and the second current collecting portion 7312 may be made of the same material and may be integrally formed.

The first current collecting portion 7311 may be welded to the plurality of first electrode tabs 1220. The second current collecting portion 7312 may be welded to the plurality of second electrode tabs 1230. The connection portion 7313 may be formed to have the same thickness as the first current collecting portion 7311 and the second current collecting portion 7312. A thickness of the connection portion 7313 may range from 0.5 mm to 3.0 mm. A curvature radius of an edge of an upper surface of the current collector 7300 may be 0.25 mm to 0.35 mm.

The connection portion 7313 may be coupled to the pole unit 7320.

As illustrated in FIG. 47, an opening 7315 may be formed in the connection portion 7313. The pole unit 7320 may be coupled to the connection portion 7313 through the opening 7315.

A recessed region 7317 may be formed in a lower surface of the current collecting unit 7310. The recessed region 7317 may have a disc shape, a square plate shape, or a rectangular plate shape, and may define an empty space extending upward from a lower surface of the connection portion 7313 of the current collecting unit 7310. A cross-sectional area of the recessed region 7317 may be larger than a cross-sectional area of the opening 7315. For example, when the opening 7315 and the recessed region 7317 are disc shapes, a diameter of the recessed region 7317 may be larger than that of the opening 7315. A depth d1 of the recessed region 7317 may be 5% to 15% of a thickness h1 of an end of the current collecting unit 7310.

The pole unit 7320 may be coupled to the current collecting unit 7310 and may electrically connect the electrode tabs 1220 and 1230 of the electrode portion 1210 to the corresponding electrode terminal. A material of the pole unit 7320 may be the same as or different from that of the current collecting unit 7310.

As illustrated in FIG. 48A, the pole unit 7320 may include a current collecting protrusion 7321, a support portion 7322, and a flange 7323. The current collecting protrusion 7321 may have a cylindrical shape having a predetermined height hc. The current collecting protrusion 7321 may be electrically connected to the corresponding electrode terminal.

The support portion 7322 and the flange 7323 may be connected to a lower end of the current collecting protrusion 7321 and may each have a disc shape or a rectangular plate shape. A shape of the support portion 7322 may be the same as that of the opening 7315 of the current collecting unit 4310. The support portion 7322 may be inserted into the opening 7315 of the current collecting unit 7310. The support portion 7322 may support the current collecting protrusion 7321 such that the current collecting protrusion 7321 is perpendicular to the current collecting unit 7310 when the pole unit 7320 is connected to the current collecting unit 7310.

A diameter of the support portion 7322 may be smaller than that of the recessed region 7317. In addition, a height h3 of the support portion 7322 may be the same as a length of the opening 7315. That is, when the support portion 7322 is inserted into the opening 7315, a lower surface of a portion of the support portion 7322 may be flush with an upper surface of the recessed region 7317 and may be positioned above the lower surface of the current collecting unit 7310 (as shown in FIG. 49).

More particularly, as shown in FIG. 50, the lower end of the support portion 7322 may include a central protruding region 7324 and a peripheral recessed region 7327. The central protruding region 7324 may be positioned lower than the peripheral recessed region 7327. Or, stated another way, the peripheral recessed region 7327 may be recessed upwards relative to the central protruding region 7324. The height h4 represents the difference in vertical position between the central protruding region 7324 and the peripheral recessed region 7327. That height h4 may be the same as the depth d1 of the recessed region 7317, such that the lower surface of the support portion 7322 in the central protruding region 7324 is coplanar with the lower surface of the current collecting unit 7310. Moreover, the lower surface of the support portion 7322 in the peripheral recessed region 7327 may be flush with the upper surface of the recessed region 7317. That arrangement may result in the recessed region 7317 and the peripheral recessed region 7327 collectively defining an annular recess having a width W. Such recess may, for example, accommodate welding burrs, as discussed below.

The flange 7323 may be disposed between the current collecting protrusion 7321 and the support portion 7322. A cross-sectional area of the flange 7323 may be larger than that of the support portion 7322. Accordingly, the flange 7323 may contact the upper surface of the connection portion 7313 and may prevent the support portion 7322 from moving downward through the opening 7315 beyond a predetermined depth. When the support portion 7322 is inserted into the opening 7315, the flange 7323 may contact a peripheral surface surrounding the opening 7315, thereby enabling the current collecting protrusion 7321 to be supported more stably.

When the current collector 7300 is coupled to another component (e.g., cap plate and/or stopper), the flange 7323 may define a lower limit position of the component to be coupled to the current collector 7300. The flange 7323 may protrude by a predetermined height from the upper surface of the connection portion 7313. Due to the flange 7323, the component assembled to the current collector 7300 may be horizontally aligned.

A height h2 of the flange 7323 may be 1% to 5% of the thickness of the electrode assembly 1200, and may be 2.5%, for example.

The height (h2) of the flange 7323 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

In accordance with the present disclosure, a large number of electrode tabs can be welded onto a current collector by forming multiple groups, and the height of the stopper may decrease as the number of groups of electrode tabs of the same polarity increases.

When two current collectors 7300 are disposed on the electrode portion 1210, the flanges 7323 may have the same height.

The flange 7323 may have a square plate shape, a rectangular plate shape, or a disc shape. An upper surface of the flange 7323 may be formed as a flat surface to support the component to be assembled thereto, and may have a predetermined area. The cross-sectional area of the flange 7323 may be 3% to 6% of the upper surface of the current collecting unit 7310.

In the case where the support portion 7322 and the flange 7323 each have a cylindrical shape, the diameter of the flange 7323 may be 1.2 times to 1.4 times that of the support portion 7322. In the case where the support portion 7322 and the flange 7323 each have a quadrangular column shape, a length of one side of the flange 7323 may be 1.2 times to 1.4 times that of one side of the support portion 7322. As the length and the area of the flange 7323 are secured, the pole unit 7320 may be stably fixed on the connection portion 7313, and the component coupled to the current collecting protrusion 7321 may be stably supported.

An area of a horizontal cross section of the flange 7323 may be 5 times to 15 times that of a horizontal cross section of the current collecting protrusion 7321, preferably 10 times. In addition, in the case where the flange 7323 has a cylindrical shape, the diameter of the current collecting protrusion 7321 may be 20% to 50% of that of the flange 7323, preferably 30%. As the cross-sectional area of the flange 7323 is formed to be larger than that of the current collecting protrusion 7321 and the diameter of the flange 7323 is formed to be larger than that of the current collecting protrusion 7321, the component connected thereto may be stably supported.

The flange 7323 may protrude upward from the upper surface of the connection portion 7313, and a height of the flange 7323 may be smaller than the thickness of the current collecting unit 4310. Specifically, the height of the flange 7323 may be 100% to 120% of the height of an end of the current collecting unit 7310, that is, an end of the first current collecting portion 7311 or the second current collecting portion 7312. In the case where the height of the flange 7323 exceeds 120% of the thickness of the connection portion 7313, a spacing between the component coupled to the current collecting protrusion 7321 and the connection portion 7313 may increase, and airtightness may be degraded.

The height h2 of the flange 7323 may be equal to or greater than a height to which the plurality of first electrode tabs 1220 and the plurality of second electrode tabs 1230 are welded on the upper surface of the current collector 7310. As the numbers of first electrode tabs 1220 and second electrode tabs 1230 increase, that is, as the thickness of the electrode assembly 1200 (in the x direction in FIG. 2) increases, the height h2 of the flange 7323 may also increase. When two current collectors 1300 are disposed on the electrode portion 1210, the flange 7323 may have the same height. Accordingly, the flange 4323 may act in the same manner as a stopper as discussed in connection with other aspects herein, and indeed the flange 4323 may be referred to as a “stopper.”

Due to the flange 7323, a stepped structure of the current collector 7300 may be formed.

In order for the component (e.g., cap plate and/or terminal) fitted over the current collecting protrusion 7321 to be stably supported on the flange 7323, the flange 7323 may have a predetermined area. The area of the horizontal cross section of the flange 7323 may be 2 times to 5 times that of the horizontal cross section of the current collecting protrusion 7321. As the cross-sectional area of the flange 7323 is formed to be larger than that of the current collecting protrusion 7321, the component may be stably supported.

In order to facilitate coupling between the current collecting protrusion 7321 and the component, a height hc of the current collecting protrusion 7321 may be formed to be greater than the height h2 of the flange 7323 within a predetermined range. Specifically, the height of the flange 7323 may be 30% to 50% of the height hc of the current collecting protrusion 7321, and may be 40%, for example. In the case where the height of the flange 7323 is greater than 50% of the height hc of the current collecting protrusion 7321, a height difference between an upper surface of the flange 7323 and upper surfaces of the first and second current collecting portions 7311 and 7312 may increase, thereby making it difficult to stably support the component.

The current collecting protrusion 7321, the support portion 7322, and the flange 7323 may be integrally formed.

In the case of a negative current collector, an upper end of the current collecting protrusion 7321 made of copper may be plated with nickel. A height of a nickel plating layer may be 1.5 mm to 2.5 mm from the upper end of the current collecting protrusion 7321. The height of the nickel plating layer may be 30% to 50% of that of the current collecting protrusion 7321. A thickness of the nickel plating layer may range from 2 μm to 4 μm. As the upper end of the current collecting protrusion 7321 is plated with nickel, welding strength when the current collecting protrusion 7321 is welded to the electrode terminal may be further enhanced.

After the support portion 7322 is fitted into the opening 7315 of the current collecting unit 7310, the support portion 7322 and the current collecting unit 7310 may be joined by welding. The welding may be performed on a periphery of the lower surface of the support portion 7322. Due to the welding, a welding region A may be formed on the lower surface of the support portion 7322.

As illustrated in FIG. 51, in an aspect, the welding region may be formed on the outer periphery (region A) of the lower surface of the support portion 7322. Moreover, as discussed above, at least the peripheral recessed region 7327 of the support portion 7322 may be positioned at a position spaced apart from the lower end of the connection portion 7313 by a predetermined distance, so that, even when welding burrs are generated, the welding burrs do not protrude below the lower surface of the current collecting unit 7310.

According to the present disclosure, a sufficient welding area may be secured by the support portion 7322 having a disc shape or a rectangular shape, so that the current collecting protrusion 7321 may be stably connected to the current collecting unit 7310. Furthermore, in the case where the support portion 7322 is formed in a square plate shape and is received in the opening 7315, undesired rotation of the current collecting protrusion 7321 may be prevented.

A width of the current collector 7300 may be 0.3 times to 0.8 times the thickness of the electrode assembly 1200. The current collector 7300 may have a thickness of 0.5 mm to 3.0 mm.

An insulator may be disposed under the current collector 7300. The insulator may be an insulating plate or an insulating film. The insulator may more reliably protect the electrode tabs 1220 and 1230 and the electrode portion 1210.

The insulator may be applied or attached to a lower surface of the current collector 7300 with a predetermined thickness after the pole unit 7320 is welded to the current collecting unit 7310.

Hereinafter, a current collector of a secondary battery according to an eighth aspect of the present disclosure will be described. Description of elements identical to those of the first aspect to the seventh aspect is omitted or simplified.

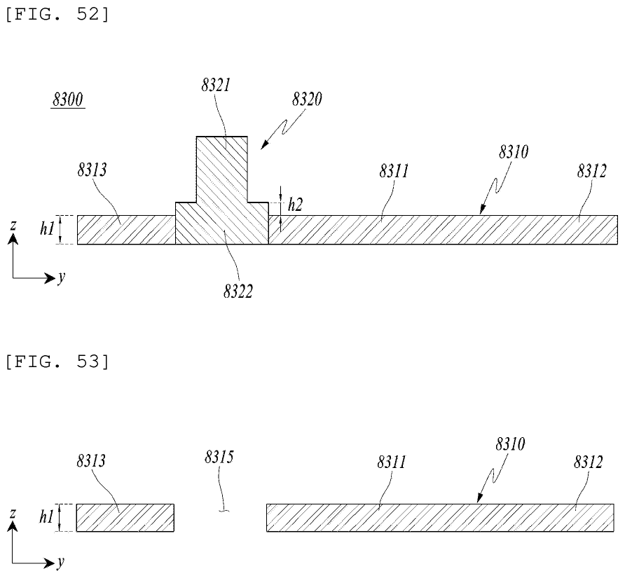

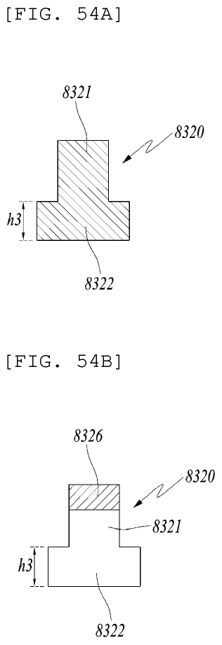

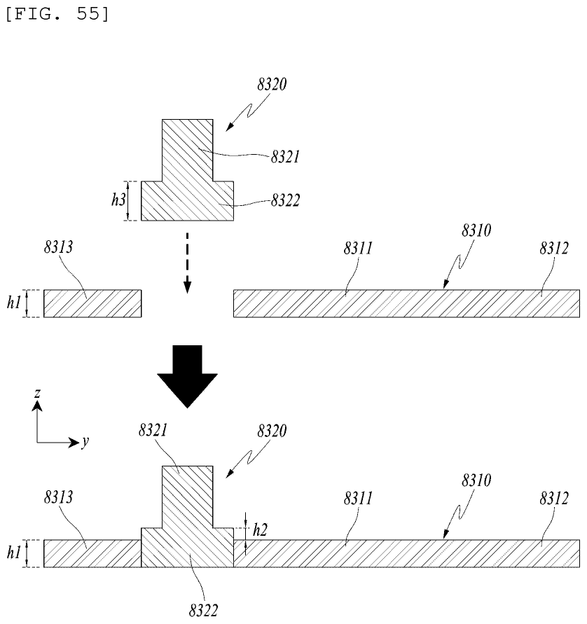

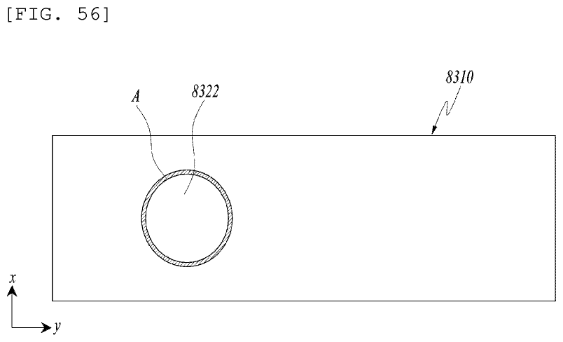

FIG. 52 is a side cross-sectional view illustrating a current collector in a secondary battery according to a eighth aspect of the present disclosure. FIG. 53 is a side cross-sectional view illustrating a current collecting unit of the current collector of FIG. 52 according to the eighth aspect of the present disclosure. FIG. 54A is a side cross-sectional view illustrating a pole unit of the current collector of FIG. 52 according to the eighth aspect of the present disclosure. FIG. 54B is a side elevation view of the pole unit of FIG. 54A, illustrating a nickel plating layer formed on an upper end of the current collecting protrusion. FIG. 55 includes sequential side cross-sectional views illustrating a process of assembling the current collecting unit with the pole unit in the eighth aspect of the present disclosure. FIG. 56 is a bottom plan view illustrating a welding region on a lower surface of the current collecting unit in the secondary battery according to the eighth aspect of the present disclosure.

As illustrated in FIGS. 47 and 48, a current collector 8300 may include a current collecting unit 8310 and a pole unit 8320. The current collecting unit 8310 may include a first current collecting portion 8311, a second current collecting portion 8312, and a connection portion 8313.

The current collecting unit 8310 may have a rectangular shape extending in the longitudinal direction (y direction) of the electrode assembly 1200. The current collecting unit 8310 may be configured such that the connection portion 8313, the first current collecting portion 8311, and the second current collecting portion 8312 are successively arranged in a longitudinal direction of the rectangular shape. The first current collecting portion 8311 and the second current collecting portion 8312 may have a predetermined thickness h1. Specifically, the thickness h1 of each of the first current collecting portion 8311 and the second current collecting portion 8312 may range from 0.5 mm to 3.0 mm. A curvature radius of an edge of an upper surface of the current collector 8300 may be 0.25 mm to 0.35 mm.

An opening 8315 may be formed in the connection portion 8313.

The pole unit 8320 may be electrically connected to the corresponding electrode terminal. A material of the pole unit 8320 may be the same as or different from that of the current collecting unit 8310. For example, the current collecting unit 8310 and the pole unit 8320 may both be made of aluminum. Alternatively, the current collecting unit 8310 may be made of copper, and the pole unit 8320 may be made of aluminum. According to the present disclosure, as the current collecting unit 8310 and the pole unit 8320 are formed as separate components, flexibility in selecting materials and dimensions of components may be increased.

The pole unit 8320 may include a current collecting protrusion 8321 and a support portion 8322 (see FIG. 54A). The current collecting protrusion 8321 may have a cylindrical shape having a predetermined height hc. The current collecting protrusion 8321 may be electrically connected to the corresponding electrode terminal.

The support portion 8322 may be connected to a lower end of the current collecting protrusion 8321 and may have a square plate shape, a rectangular plate shape, or a disc shape. The support portion 8322 may have a shape corresponding to that of the opening 8315. A cross-sectional area of the opening 8315 may also be square, rectangular, or circular.

A height h3 of the support portion 8322 may be greater than a thickness h1 of the connection portion 8313 of the current collecting unit 8310. Accordingly, when the support portion 8322 is received within the opening 8315, with a lower surface of the support portion 8322 being flush with the lower surface of the connection portion 8313, an upper surface of the support portion 8322 may protrude above an upper surface of the connection portion 8313 by a predetermined height h2.

The height h2 by which the support portion 8322 protrudes from the upper surface of the connection portion 8313, that is, an upper surface of the current collecting unit 8310, may be smaller than a thickness of an end of the current collecting unit 8310. Specifically, the height h2 by which the support portion 8322 protrudes from the upper surface of the connection portion 8313 may be 30% to 50% of the thickness h1 of an end of the first current collecting portion 8311 or the second current collecting portion 8312. Due to protrusion of the support portion 8322, a stepped structure of the current collector 8300 may be formed (see FIG. 55).

The height h2 of the protruding portion may be equal to or greater than a height to which the plurality of first electrode tabs 1220 and the plurality of second electrode tabs 1230 are welded on the upper surface of the current collector 8300. As a result, the upwardly protruding portion of the support portion 8322 may act as a stopper, like that discussed in connection with other aspects herein, and at least that protruding portion of the support portion 5322 may also be referred to as a “stopper” herein. As the numbers of first electrode tabs 1220 and second electrode tabs 1230 increase, that is, as the thickness of the electrode assembly 1200 (in the x direction in FIG. 2) increases, the height h2 of the protruding portion of the support portion 8322 may increase. The height h2 of the protruding portion of the support portion 8322 may be 1% to 5% of the thickness of the electrode assembly 1200, and may be 2.5%, for example.

The height (h2) of the stopper 8322 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

When two current collectors 8300 are disposed on the electrode portion 1210, the protruding portions of the support portions 8322 may have the same height h2. In order for a component (e.g., cap plate and/or terminal) fitted over the current collecting protrusion 8321 to be stably supported on the protruding portion of the support portion 8322, the support portion 8322 may have a predetermined area. An area of a horizontal cross-section of the support portion 8322 may be 3 times to 5 times that of a horizontal cross-section of the current collecting protrusion 8321.

The support portion 8322 may support the current collecting protrusion 8321 such that the current collecting protrusion 8321 is perpendicular to the current collecting unit 8310 when the pole unit 8320 is connected to the current collecting unit 8310. The current collecting protrusion 8321 and the support portion 8322 may be integrally formed.

After the support portion 8322 is fitted into the opening 8315 of the current collecting unit 8310, the support portion 8322 and the current collecting unit 8310 may be joined by welding. The welding may be performed on the lower surface of the support portion 8322. Due to the welding, a welding region may be formed on the lower surface of the support portion 8322.

As illustrated in FIG. 56, in an aspect, the welding region may be formed on an outer periphery (region A) of the lower surface of the support portion 8322. The welding may be performed at a boundary surface between the support portion 8322 and the connection portion 8313.

In the case in which the support portion 8322 is formed in a square plate shape, undesired rotation of the current collecting protrusion 8321 may be prevented by fitting the support portion 8322 into the opening 8315 of the current collecting unit 8310.

A width of the current collector 8300 may be 0.3 times to 0.8 times the thickness of the electrode assembly 1200. The current collector 8300 may have a thickness of 0.5 mm to 3.0 mm.

An insulator may be disposed under the current collector 8300. The insulator may be an insulating plate or an insulating film. The insulator may more reliably protect the electrode tabs 1220 and 1230 and the electrode portion 1210.

The insulator may be applied or attached to a lower surface of the current collector 8300 with a predetermined thickness after the pole unit 8320 is welded to the current collecting unit 8310.

Hereinafter, a current collector of a secondary battery according to a ninth aspect of the present disclosure will be described. Description of elements identical to those of the first aspect to the eighth aspect is omitted or simplified.

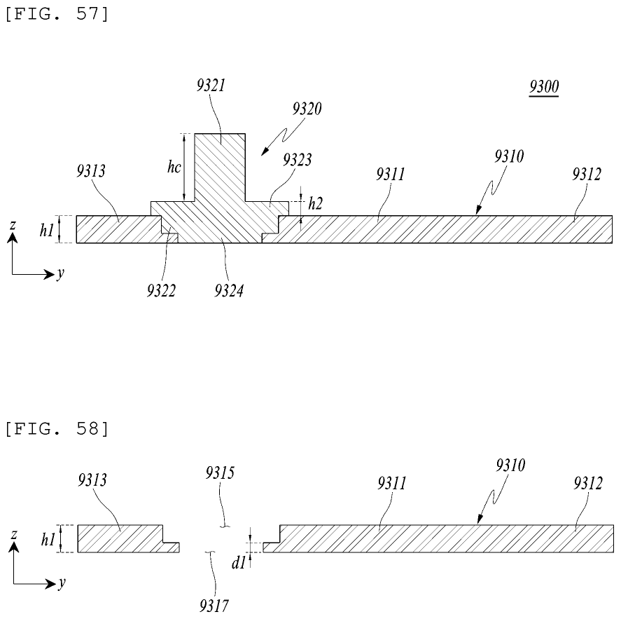

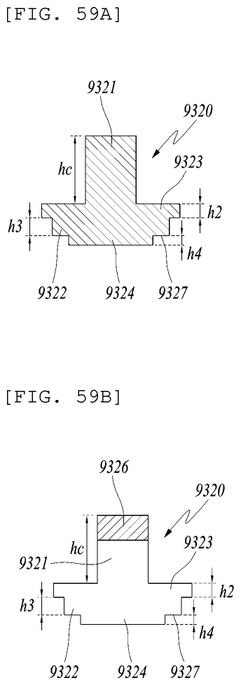

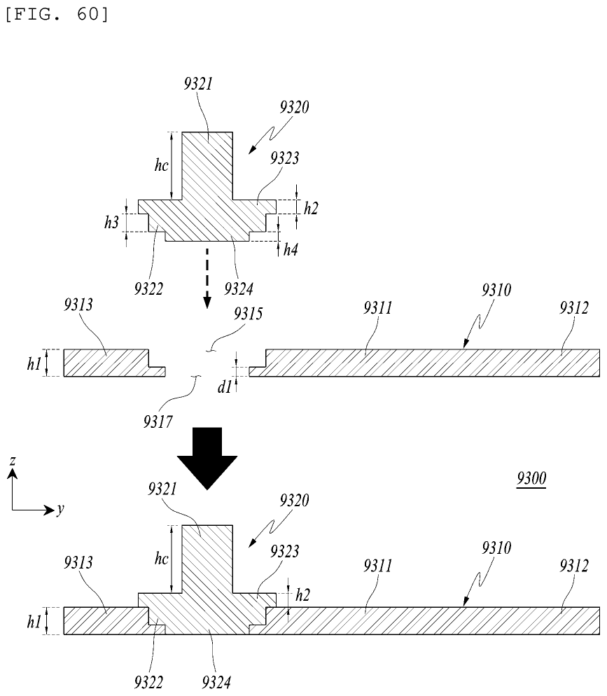

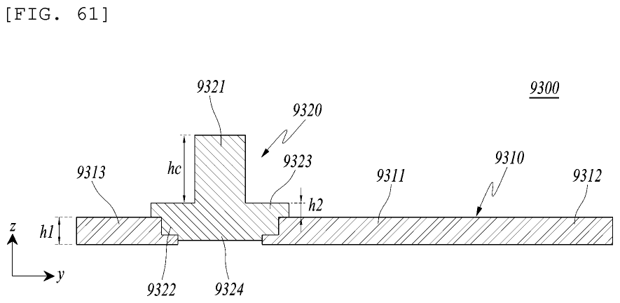

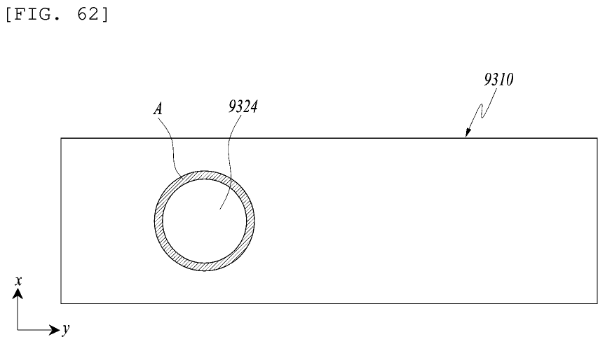

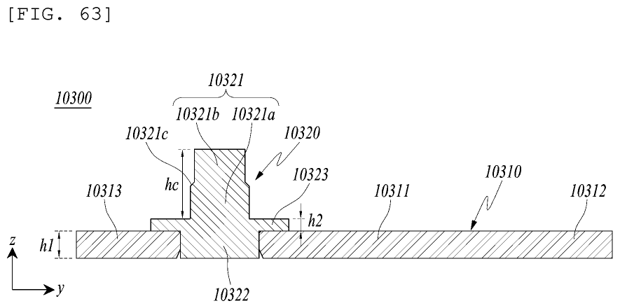

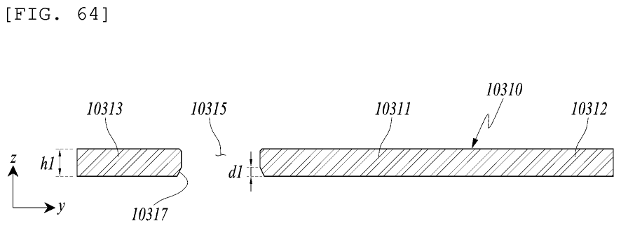

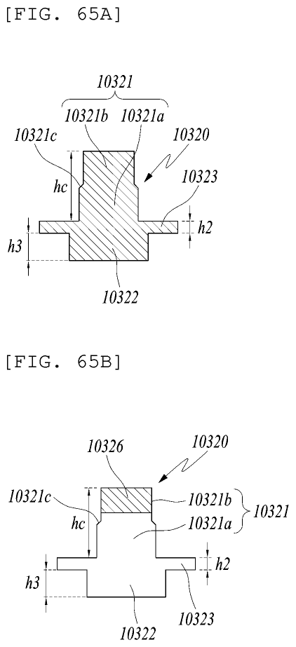

FIG. 57 is a side cross-sectional view illustrating a current collector in a secondary battery according to a ninth aspect of the present disclosure. FIG. 58 is a side cross-sectional view illustrating a current collecting unit of the current collector of FIG. 57 according to the ninth aspect of the present disclosure. FIG. 59A is a side cross-sectional view illustrating a pole unit of the current collector of FIG. 57 according to the ninth aspect of the present disclosure. FIG. 59B is a side elevation view of the pole unit of FIG. 59A, illustrating a nickel plating layer formed on an upper end of the current collecting protrusion. FIG. 60 includes sequential cross-sectional views illustrating a process of assembling the current collecting unit with the pole unit in the ninth aspect of the present disclosure. FIG. 61 is a side cross-sectional view illustrating a different example of a current collector in a secondary battery according to a ninth aspect of the present disclosure, in which a lower surface of the pole unit is recessed upwardly relative to the lower surface of the current collecting unit. FIG. 62 is a bottom plan view illustrating a welding region on a lower surface of the current collecting unit in the secondary battery according to the ninth aspect of the present disclosure.

As illustrated in FIG. 57, a current collector 9300 may include a current collecting unit 9310 and a pole unit 9320. The current collecting unit 9310 may be connected to the plurality of electrode tabs 1220 and 1230. The pole unit 9320 may be connected to a corresponding electrode terminal.

The current collecting unit 9310 may have a rectangular shape extending in the longitudinal direction (y direction) of the electrode assembly 1200, and may include a connection portion 9313, a first current collecting portion 9311, and a second current collecting portion 9312 that are successively arranged in a longitudinal direction of the rectangular shape. The connection portion 9313, the first current collecting portion 9311, and the second current collecting portion 9312 may be made of the same material and may be integrally formed.

The first current collecting portion 9311 may be welded to the plurality of first electrode tabs 1220. The second current collecting portion 9312 may be welded to the plurality of second electrode tabs 1230. The connection portion 9313 may be formed to have the same thickness as the first current collecting portion 9311 and the second current collecting portion 9312. A thickness of the connection portion 9313 may range from 0.5 mm to 3.0 mm. A curvature radius of an edge of an upper surface of the current collector 9300 may be 0.25 mm to 0.35 mm.

The connection portion 9313 may be coupled to the pole unit 9320.

As illustrated in FIG. 58, an opening 9315 may be formed in the connection portion 9313. The pole unit 9320 may be coupled to the connection portion 9313 through the opening 9315.

As further illustrated in FIG. 58, a recessed region 9317 may be formed in a lower surface of the current collecting unit 9310. The recessed region 9317 may have a disc shape, a square plate shape, or a rectangular plate shape, and may define an empty space above the lower surface of the connection portion 9313 of the current collecting unit 9310. A cross-sectional area of the recessed region 9317 may be smaller than a cross-sectional area of the opening 9315. For example, when the opening 9315 and the recessed region 9317 are disc shapes, a diameter of the recessed region 9317 may be smaller than that of the opening 9315. A depth d1 of the recessed region 9317 may be 5% to 15% of a thickness h1 of an end of the current collecting unit 9310.

The pole unit 9320 may be coupled to the current collecting unit 9310 and may electrically connect the electrode tabs 1220 and 1230 of the electrode portion 1210 to the corresponding electrode terminal. A material of the pole unit 9320 may be the same as or different from that of the current collecting unit 9310.

As illustrated in FIG. 59A, the pole unit 9320 may include a current collecting protrusion 9321, a support portion 9322, and a flange 9323. The current collecting protrusion 9321 may have a cylindrical shape having a predetermined height hc. The current collecting protrusion 9321 may be electrically connected to the corresponding electrode terminal.

The support portion 9322 and the flange 9323 may be connected to a lower end of the current collecting protrusion 9321 and may each have a disc shape or a rectangular plate shape. A shape of the support portion 9322 may correspond to the opening 9315 and the recessed region 9317 of the current collecting unit 9310. The support portion 9322 may be inserted into the opening 9315 of the current collecting unit 9310. The support portion 9322 may support the current collecting protrusion 9321 such that the current collecting protrusion 9321 is perpendicular to the current collecting unit 9310 when the pole unit 9320 is connected to the current collecting unit 9310.

A diameter of the support portion 9322 may be larger than that of the recessed region 9317. In addition, a height h3 of the support portion 9322 may be the same as a length of the opening 9315.

As shown in FIG. 59A, the lower end of the support portion 9322 may include a central protruding region 9324 and a peripheral recessed region 9327. The central protruding region 9324 may be positioned lower than the peripheral recessed region 9327. Or, stated another way, the peripheral recessed region 9327 may be recessed upwards relative to the central protruding region 9324. The height h4 represents the difference in vertical position between the central protruding region 9324 and the peripheral recessed region 9327. That height h4 may be the same as the depth d1 of the recessed region 9317, such that the lower surface of the support portion 9322 in the central protruding region 9324 is flush with the lower surface of the current collecting unit 9310. Moreover, the lower surface of the support portion 9322 in the peripheral recessed region 9327 may abut the upwardly facing surface of the bottom of the opening 9315 around the perimeter of the recessed region 9317.

The flange 9323 may be disposed between the current collecting protrusion 9321 and the support portion 9322. A cross-sectional area of the flange 9323 may be larger than that of the support portion 9322. Accordingly, the flange 9323 may contact the upper surface of the connection portion 9313 and may prevent the support portion 9322 from moving downward through the opening 9315 beyond a predetermined depth. When the support portion 9322 is inserted into the opening 9315, the flange 9323 may contact a peripheral surface surrounding the opening 9315, thereby enabling the current collecting protrusion 9321 to be supported more stably.

When the current collector 9300 is coupled to another component (e.g., cap plate and/or stopper), the flange 9323 may define a lower limit position of the component to be coupled to the current collector 9300. The flange 9323 may protrude by a predetermined height from the upper surface of the connection portion 9313. Due to the flange 9323, the component assembled to the current collector 9300 may be horizontally aligned.

A height h2 of the flange 9323 may be 1% to 5% of the thickness of the electrode assembly 1200, and may be 2.5%, for example.

The height (h2) of the flange 9323 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

When two current collectors 9300 are disposed on the electrode portion 1210, the flanges 9323 may have the same height.

The flange 9323 may have a square plate shape, a rectangular plate shape, or a disc shape. An upper surface of the flange 9323 may be formed as a flat surface to support the component to be assembled thereto, and may have a predetermined area. The cross-sectional area of the flange 9323 may be 3% to 6% of the upper surface of the current collecting unit 9310.

In the case where the support portion 9322 and the flange 9323 each have a cylindrical shape, the diameter of the flange 9323 may be 1.2 times to 1.4 times that of the support portion 9322. In the case where the support portion 9322 and the flange 9323 each have a quadrangular column shape, a length of one side of the flange 9323 may be 1.2 times to 1.4 times that of one side of the support portion 9322. As the length and the area of the flange 9323 are secured, the pole unit 9320 may be stably fixed on the connection portion 9313, and the component coupled to the current collecting protrusion 9321 may be stably supported.

An area of a horizontal cross section of the flange 9323 may be 5 times to 15 times that of a horizontal cross section of the current collecting protrusion 9321, preferably 10 times. In addition, in the case where the flange 9323 has a cylindrical shape, the diameter of the current collecting protrusion 9321 may be 20% to 50% of that of the flange 9323, preferably 30%. As the cross-sectional area of the flange 9323 is formed to be larger than that of the current collecting protrusion 9321 and the diameter of the flange 9323 is formed to be larger than that of the current collecting protrusion 9321, the component connected thereto may be stably supported.

The flange 9323 may protrude upward from the upper surface of the connection portion 9313, and a height of the flange 9323 may be smaller than the thickness of the current collecting unit 9310. Specifically, the height of the flange 9323 may be 100% to 120% of the height of an end of the current collecting unit 9310, that is, an end of the first current collecting portion 9311 or the second current collecting portion 9312. In the case where the height of the flange 9323 exceeds 120% of the thickness of the connection portion 9313, a spacing between the component coupled to the current collecting protrusion 9321 and the connection portion 9313 may increase, and airtightness may be degraded.

The height h2 of the flange 9323 may be equal to or greater than a height to which the plurality of first electrode tabs 1220 and the plurality of second electrode tabs 1230 are welded on the upper surface of the current collector 9310. As the numbers of first electrode tabs 1220 and second electrode tabs 1230 increase, that is, as the thickness of the electrode assembly 1200 (in the x direction in FIG. 2) increases, the height h2 of the flange 9323 may also increase. When two current collectors 1300 are disposed on the electrode portion 1210, the flange 9323 may have the same height. Accordingly, the flange 9323 may act in the same manner as a stopper as discussed in connection with other aspects herein, and indeed the flange 9323 may be referred to as a “stopper.”

Due to the flange 9323, a stepped structure of the current collector 9300 may be formed.

In order for the component (e.g., cap plate and/or terminal) fitted over the current collecting protrusion 9321 to be stably supported on the flange 9323, the flange 9323 may have a predetermined area. The area of the horizontal cross section of the flange 9323 may be 2 times to 5 times that of the horizontal cross section of the current collecting protrusion 9321. As the cross-sectional area of the flange 9323 is formed to be larger than that of the current collecting protrusion 9321, the component may be stably supported.

In order to facilitate coupling between the current collecting protrusion 9321 and the component, a height hc of the current collecting protrusion 9321 may be formed to be greater than the height h2 of the flange 9323 within a predetermined range. Specifically, the height of the flange 9323 may be 30% to 50% of the height hc of the current collecting protrusion 9321, and may be 40%, for example. In the case where the height of the flange 9323 is greater than 50% of the height hc of the current collecting protrusion 9321, a height difference between an upper surface of the flange 9323 and upper surfaces of the first and second current collecting portions 9311 and 9312 may increase, thereby making it difficult to stably support the component.

The current collecting protrusion 9321, the support portion 9322, and the flange 9323 may be integrally formed.

In the case of a negative current collector, an upper end of the current collecting protrusion 9321 made of copper may be plated with nickel (see FIG. 59B). A height of a nickel plating layer 9326 may be 1.5 mm to 2.5 mm from the upper end of the current collecting protrusion 9321. The height of the nickel plating layer 9326 may be 30% to 50% of that of the current collecting protrusion 9321. A thickness of the nickel plating layer 9326 may range from 2 μm to 4 μm. As the upper end of the current collecting protrusion 7321 is plated with nickel, welding strength when the current collecting protrusion 9321 is welded to the electrode terminal may be further enhanced.

After the support portion 9322 is fitted into the opening 9315 of the current collecting unit 9310, the support portion 9322 and the current collecting unit 9310 may be joined by welding. The welding may be performed on a periphery of the lower surface of the support portion 9322. Due to the welding, a welding region A may be formed on the lower surface of the support portion 9322.

As illustrated in FIG. 62, in an aspect, the welding region may be formed on the outer periphery (region A) of the lower surface of the support portion 9322. As illustrated in FIG. 60 and discussed above, the central protruding region 9324 of the support portion 9322 may be flush with the lower surface of the current collecting unit 9310. In a different example, however, as illustrated in FIG. 61, the central protruding region 9324 of the support portion 9322 may be positioned at a position spaced apart from the lower end of the connection portion 9313 by a predetermined distance, so that, even when welding burrs are generated, the welding burrs do not protrude below the lower surface of the current collecting unit 9310.

According to the present disclosure, a sufficient welding area may be secured by the support portion 9322 having a disc shape or a rectangular shape, so that the current collecting protrusion 9321 may be stably connected to the current collecting unit 9310. Furthermore, in the case where the support portion 9322 is formed in a square plate shape and is received in the opening 9315, undesired rotation of the current collecting protrusion 9321 may be prevented.

A width of the current collector 9300 may be 0.3 times to 0.8 times the thickness of the electrode assembly 1200. The current collector 9300 may have a thickness of 0.5 mm to 3.0 mm.

An insulator may be disposed under the current collector 9300. The insulator may be an insulating plate or an insulating film. The insulator may more reliably protect the electrode tabs 1220 and 1230 and the electrode portion 1210. The insulator may be applied or attached to a lower surface of the current collector 9300 with a predetermined thickness after the pole unit 9320 is welded to the current collecting unit 9310.

Hereinafter, a current collector of a secondary battery according to a tenth aspect of the present disclosure will be described. Description of elements identical to those of the first aspect to the ninth aspect is omitted or simplified.

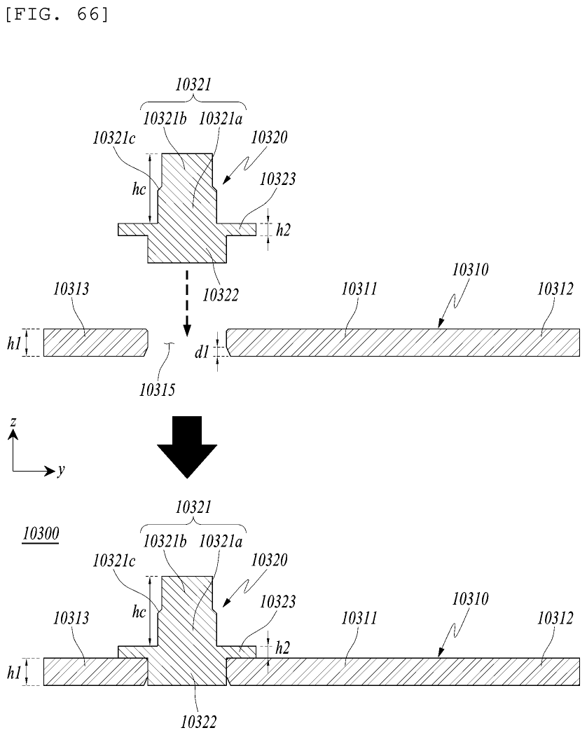

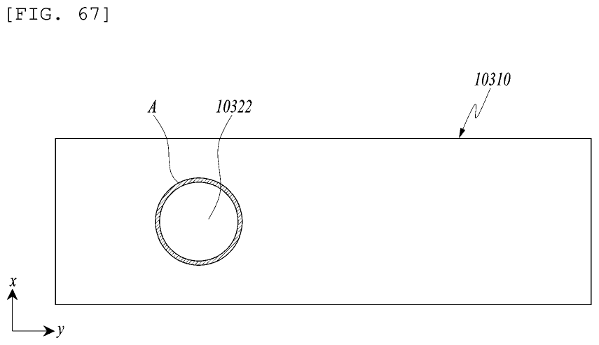

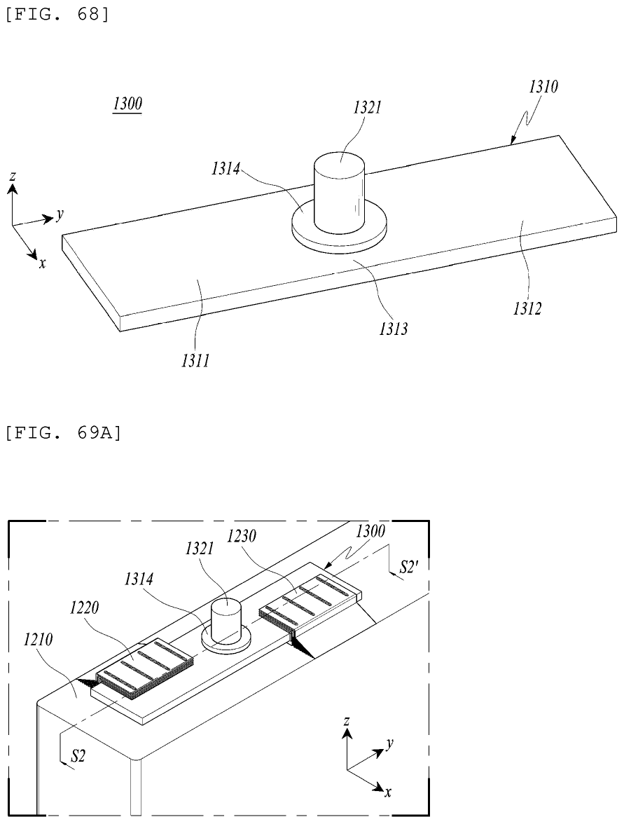

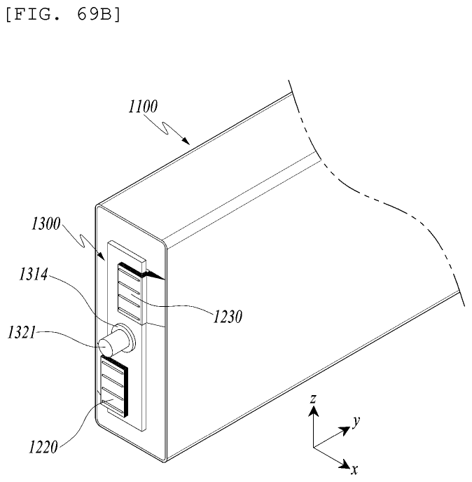

FIG. 63 is a side cross-sectional view illustrating a current collector in a secondary battery according to a tenth aspect of the present disclosure. FIG. 64 is a side cross-sectional view illustrating a current collecting unit of the current collector of FIG. 62 according to the tenth aspect of the present disclosure. FIG. 65A is a side cross-sectional view illustrating a pole unit of the current collector of FIG. 62 according to the tenth aspect of the present disclosure. FIG. 65B is a side elevation view of the pole unit of FIG. 65A, illustrating a nickel plating layer formed on an upper end of the current collecting protrusion. FIG. 66 includes sequential cross-sectional views illustrating a process of assembling the current collecting unit with the pole unit in the tenth aspect of the present disclosure. FIG. 67 is a bottom plan view illustrating a welding region on a lower surface of the current collecting unit in the secondary battery according to the tenth aspect of the present disclosure.

As illustrated in FIG. 63, a current collector 10300 may include a current collecting unit 10310 and a pole unit 10320. The current collecting unit 10310 may be connected to the plurality of electrode tabs 1220 and 1230. The pole unit 10320 may be connected to a corresponding electrode terminal.

The current collecting unit 10310 may have a rectangular shape extending in the longitudinal direction (y direction) of the electrode assembly 1200, and may include a connection portion 10313, a first current collecting portion 10311, and a second current collecting portion 10312 that are successively arranged in a longitudinal direction of the rectangular shape. The connection portion 10313, the first current collecting portion 10311, and the second current collecting portion 10312 may be made of the same material and may be integrally formed.

The first current collecting portion 10311 may be welded to the plurality of first electrode tabs 1220. The second current collecting portion 10312 may be welded to the plurality of second electrode tabs 1230. The connection portion 10313 may be formed to have the same thickness as the first current collecting portion 10311 and the second current collecting portion 10312. A thickness of the connection portion 10313 may range from 0.5 mm to 3.0 mm. A curvature radius of an edge of an upper surface of the current collector 10300 may be 0.25 mm to 0.35 mm.

The connection portion 10313 may be coupled to the pole unit 10320.

As illustrated in FIG. 64, an opening 10315 may be formed in the connection portion 10313. The pole unit 10320 may be coupled to the connection portion 10313 through the opening 10315.

A recessed region 10317 may be formed in a lower surface of the current collecting unit 10310. The recessed region 10317 may have the same shape as the opening 10315 (e.g., a disc shape, a square plate shape, a rectangular plate shape) and may define an empty space extending upward from a lower surface of the connection portion 10313 of the current collecting unit 10310. A cross-sectional area of the recessed region 10317 may be slightly larger than a cross-sectional area of the opening 10315 and a perimeter of the recessed region 10317 may taper inwardly to meet the cross-section of the opening 10315, so as to define an interior chamfer with a depth d1. The depth d1 of the recessed region 10317 may be 5% to 15% of a thickness h1 of an end of the current collecting unit 10310.

The pole unit 10320 may be coupled to the current collecting unit 10310 and may electrically connect the electrode tabs 1220 and 1230 of the electrode portion 1210 to the corresponding electrode terminal. A material of the pole unit 10320 may be the same as or different from that of the current collecting unit 10310.

As illustrated in FIG. 65A, the pole unit 10320 may include a current collecting protrusion 10321, a support portion 10322, and a flange 10323. The current collecting protrusion 10321 may have a generally cylindrical shape having a predetermined height hc. The current collecting protrusion 7321 may be electrically connected to the corresponding electrode terminal. The current collecting protrusion 10321 may include a first region 10321a and a second region 10321b. The first region 10321a may be disposed closer to the support portion 10322 than second region 10321b. In an aspect, a cross-sectional area of the first region 10321a may be greater than that of second region 10321b, with a tapered region 10321c defined therebetween. For instance, this can better facilitate coupling with another component (e.g., terminal or cap assembly).

The support portion 10322 and the flange 10323 may be connected to a lower end of the current collecting protrusion 10321 and may each have a disc shape or a rectangular plate shape. A shape of the support portion 10322 may be the same as that of the opening 10315 of the current collecting unit 10310. The support portion 10322 may be inserted into the opening 10315 of the current collecting unit 10310. The support portion 10322 may support the current collecting protrusion 10321 such that the current collecting protrusion 10321 is perpendicular to the current collecting unit 10310 when the pole unit 10320 is connected to the current collecting unit 10310.

A diameter of the support portion 10322 may be smaller than that of the recessed region 10317. In addition, a height h3 of the support portion 10322 may be the same as a length of the opening 10315. That is, when the support portion 10322 is inserted into the opening 10315, a lower surface of the support portion 10322 may be generally coplanar with the lower surface of the current collecting unit 10310.

The flange 10323 may be disposed between the current collecting protrusion 10321 and the support portion 10322. A cross-sectional area of the flange 10323 may be larger than that of the support portion 10322. Accordingly, the flange 10323 may contact the upper surface of the connection portion 10313 and may prevent the support portion 10322 from moving downward through the opening 10315 beyond a predetermined depth. When the support portion 10322 is inserted into the opening 10315, the flange 10323 may contact a peripheral surface surrounding the opening 10315, thereby enabling the current collecting protrusion 10321 to be supported more stably.

When the current collector 10300 is coupled to another component, the flange 10323 may define a lower limit position of the component to be coupled to the current collector 10300. The flange 10323 may protrude by a predetermined height from the upper surface of the connection portion 10313. Due to the flange 10323, the component assembled to the current collector 10300 may be horizontally aligned.

A height h2 of the flange 10323 may be 1% to 5% of the thickness of the electrode assembly 1200, and may be 2.5%, for example.

The height (h2) of the stopper 10323 can be determined by the following equation:

h2=A×0.005×B/C (Equation 1)

(where A is the thickness of the electrode assembly, B is the length of the electrode tab, and C is the number of groups of electrode tabs of the same polarity aligned with electrode tabs at the same location.)

In accordance with the present disclosure, a large number of electrode tabs can be welded onto a current collector by forming multiple groups, and the height of the stopper may decrease as the number of groups of electrode tabs of the same polarity increases.

When two current collectors 10300 are disposed on the electrode portion 1210, the flanges 10323 may have the same height.

The flange 10323 may have a square plate shape, a rectangular plate shape, or a disc shape. An upper surface of the flange 10323 may be formed as a flat surface to support the component to be assembled thereto, and may have a predetermined area. The cross-sectional area of the flange 10323 may be 3% to 6% of the upper surface of the current collecting unit 7310.

In the case where the support portion 10322 and the flange 10323 each have a cylindrical shape, the diameter of the flange 10323 may be 1.2 times to 1.4 times that of the support portion 10322. In the case where the support portion 10322 and the flange 10323 each have a quadrangular column shape, a length of one side of the flange 10323 may be 1.2 times to 1.4 times that of one side of the support portion 10322. As the length and the area of the flange 10323 are secured, the pole unit 10320 may be stably fixed on the connection portion 10313, and the component coupled to the current collecting protrusion 10321 may be stably supported.

An area of a horizontal cross section of the flange 10323 may be 10 times to 15 times that of a horizontal cross section of the current collecting protrusion 10321, preferably 10 times. In addition, in the case where the flange 10323 has a cylindrical shape, the diameter of the current collecting protrusion 10321 may be 20% to 50% of that of the flange 10323, preferably 30%. As the cross-sectional area of the flange 10323 is formed to be larger than that of the current collecting protrusion 10321 and the diameter of the flange 10323 is formed to be larger than that of the current collecting protrusion 10321, the component connected thereto may be stably supported.

The flange 10323 may protrude upward from the upper surface of the connection portion 10313, and a height of the flange 10323 may be smaller than the thickness of the current collecting unit 10310. Specifically, the height of the flange 10323 may be 100% to 120% of the height of an end of the current collecting unit 10310, that is, an end of the first current collecting portion 10311 or the second current collecting portion 10312. In the case where the height of the flange 10323 exceeds 120% of the thickness of the connection portion 10313, a spacing between the component coupled to the current collecting protrusion 10321 and the connection portion 10313 may increase, and airtightness may be degraded.

The height h2 of the flange 10323 may be equal to or greater than a height to which the plurality of first electrode tabs 1220 and the plurality of second electrode tabs 1230 are welded on the upper surface of the current collector 10310. As the numbers of first electrode tabs 1220 and second electrode tabs 1230 increase, that is, as the thickness of the electrode assembly 1200 (in the x direction in FIG. 2) increases, the height h2 of the flange 10323 may also increase. When two current collectors 1300 are disposed on the electrode portion 1210, the flange 10323 may have the same height. Accordingly, the flange 10323 may act in the same manner as a stopper as discussed in connection with other aspects herein, and indeed the flange 10323 may be referred to as a “stopper.”

Due to the flange 10323, a stepped structure of the current collector 10300 may be formed.

In order for the component (e.g., cap assembly and/or terminal) fitted over the current collecting protrusion 10321 to be stably supported on the flange 10323, the flange 10323 may have a predetermined area. The area of the horizontal cross section of the flange 10323 may be 2 times to 5 times that of the horizontal cross section of the current collecting protrusion 10321. As the cross-sectional area of the flange 10323 is formed to be larger than that of the current collecting protrusion 10321, the component may be stably supported.

In order to facilitate coupling between the current collecting protrusion 10321 and the component, a height hc of the current collecting protrusion 10321 may be formed to be greater than the height h2 of the flange 10323 within a predetermined range. Specifically, the height of the flange 10323 may be 30% to 50% of the height hc of the current collecting protrusion 10321, and may be 40%, for example. In the case where the height of the flange 10323 is greater than 20% of the height hc of the current collecting protrusion 10321, a height difference between an upper surface of the flange 10323 and upper surfaces of the first and second current collecting portions 10311 and 10312 may increase, thereby making it difficult to stably support the component.

The current collecting protrusion 10321, the support portion 10322, and the flange 10323 may be integrally formed.

In the case of a negative current collector, an upper end of the current collecting protrusion 10321 made of copper may be plated with nickel (see FIG. 65B). A height of a nickel plating layer 10326 may be 1.5 mm to 2.5 mm from the upper end of the current collecting protrusion 10321. The height of the nickel plating layer 10326 may be 30% to 50% of that of the current collecting protrusion 10321. A thickness of the nickel plating layer 10326 may range from 2 μm to 4 μm. As the upper end of the current collecting protrusion 10321 is plated with nickel, welding strength when the current collecting protrusion 10321 is welded to the electrode terminal may be further enhanced.

After the support portion 10322 is fitted into the opening 10315 of the current collecting unit 10310, the support portion 10322 and the current collecting unit 10310 may be joined by welding. The welding may be performed on a periphery of the lower surface of the support portion 10322. Due to the welding, a welding region A may be formed on the lower surface of the support portion 10322.

As illustrated in FIG. 62, in an aspect, the welding region may be formed along the outer periphery (region A) of the lower surface of the support portion 10322. The support portion 10322 may be spaced apart from the perimeter of the recessed region 10317 in the lower surface of the support portion 10322 due to the interior chamfer discussed above. Such chamfer may define a sufficient space to receive any welding burst that are generated, such that the welding burrs do not protrude below the lower surface of the current collecting unit 10310.

According to the present disclosure, a sufficient welding area may be secured by the support portion 10322 having a disc shape or a rectangular shape, so that the current collecting protrusion 10321 may be stably connected to the current collecting unit 10310. Furthermore, in the case where the support portion 10322 is formed in a square plate shape and is received in the opening 10315, undesired rotation of the current collecting protrusion 10321 may be prevented.

A width of the current collector 10300 may be 0.3 times to 0.8 times the thickness of the electrode assembly 1200. The current collector 10300 may have a thickness of 0.5 mm to 3.0 mm.

An insulator may be disposed under the current collector 10300. The insulator may be an insulating plate or an insulating film. The insulator may more reliably protect the electrode tabs 1220 and 1230 and the electrode portion 1210.

The insulator may be applied or attached to a lower surface of the current collector 10300 with a predetermined thickness after the pole unit 10320 is welded to the current collecting unit 10310.

FIG. 68 is a perspective view illustrating a current collector in a secondary battery according to an eleventh aspect of the present disclosure. FIGS. 64A and 64B are views illustrating a current collector in a secondary battery according to a twelfth aspect of the present disclosure.

The current collector 1300 may include a current collecting unit 1310 and a pole unit 1320. The current collecting unit 1310 illustrated in FIG. 68 may have a rectangular shape extending in the longitudinal direction (y direction) of the electrode assembly 1200. The current collecting unit 1310 may be configured such that a first current collecting portion 1311, a connection portion 1313, and a second current collecting portion 1312 are successively arranged in a longitudinal direction of the rectangular shape. The first current collecting portion 1311, the connection portion 1313, and the second current collecting portion 1312 may all be formed of the same material and may be integrally formed.

The first current collecting portion 1311 may be welded to the plurality of first electrode tabs 1220. The plurality of first electrode tabs 1220 may be bent onto and welded to the first current collecting portion 1311. The second current collecting portion 1312 may be welded to the plurality of second electrode tabs 1230. The plurality of second electrode tabs 1230 may be bent onto and welded to the second current collecting portion 1312. The first current collecting portion 1311 and the second current collecting portion 1312 may have a predetermined thickness h1. Specifically, the thickness of each of the first current collecting portion 1311 and the second current collecting portion 1312 may range from 0.5 mm to 3.0 mm.

The connection portion 1313 may be disposed between the first current collecting portion 1311 and the second current collecting portion 1312. The first current collecting portion 1311 and the second current collecting portion 1312 may be respectively connected to one side and a remaining side of the connection portion 1313. As the first current collecting portion 1311 and the second current collecting portion 1312 are disposed to be spaced apart from each other by the connection portion 1313, the plurality of first electrode tabs 1220 and the plurality of second electrode tabs 1230 do not interfere with each other when welded to the first current collecting portion 1311 and the second current collecting portion 1312, respectively.

The current collecting unit 1310 illustrated in FIGS. 64A and 64B may have a ‘U’ shape formed by two rectangular structures connected to each other and extending in the longitudinal direction (y direction) of the electrode assembly 1200. The first current collecting portion 1311 may be connected to an upper portion of one side of the rectangular connection portion 1313, and the second current collecting portion 1312 may be connected to a lower portion of the one side of the connection portion 1313. That is, the first current collecting portion 1311 and the second current collecting portion 1312 may be perpendicularly connected to the connection portion 1313, and the first current collecting portion 1311 and the second current collecting portion 1312 may be disposed parallel to each other.

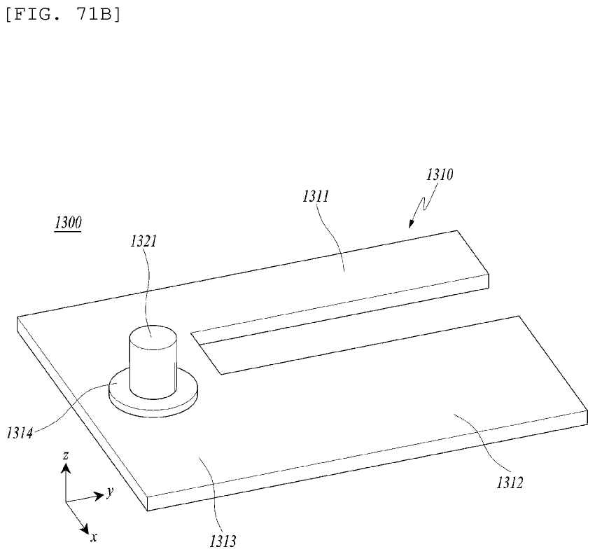

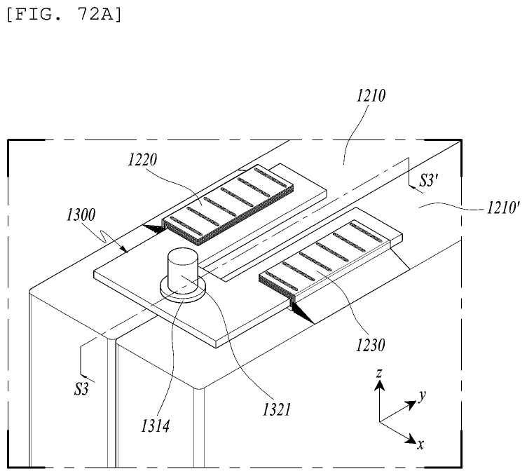

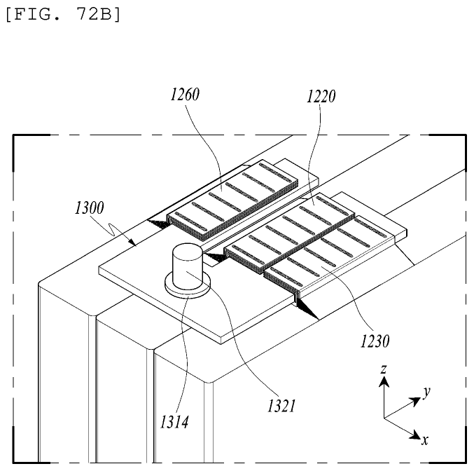

The first current collecting portion 1311 and the second current collecting portion 1312 may be spaced apart from each other by a predetermined distance. The first current collecting portion 1311 and the second current collecting portion 1312 may have the same length and width (see FIG. 71A). However, the present disclosure is not limited thereto, and depending on an arrangement of electrode tabs and a thickness of the electrode portion, the first current collecting portion 1311 and the second current collecting portion 1312 may have different widths (see FIG. 71B). The connection portion 1313, the first current collecting portion 1311, and the second current collecting portion 1312 may all be formed of the same material and may be integrally formed.

The first current collecting portion 1311 may be welded to the plurality of first electrode tabs 1220. The plurality of first electrode tabs 1220 may be bent onto and welded to the first current collecting portion 1311. The second current collecting portion 1312 may be welded to the plurality of second electrode tabs 1230. The plurality of second electrode tabs 1230 may be bent onto and welded to the second current collecting portion 1312. The first current collecting portion 1311 and the second current collecting portion 1312 may have a predetermined thickness h1. Specifically, the thickness of each of the first current collecting portion 1311 and the second current collecting portion 1312 may range from 0.5 mm to 3.0 mm.

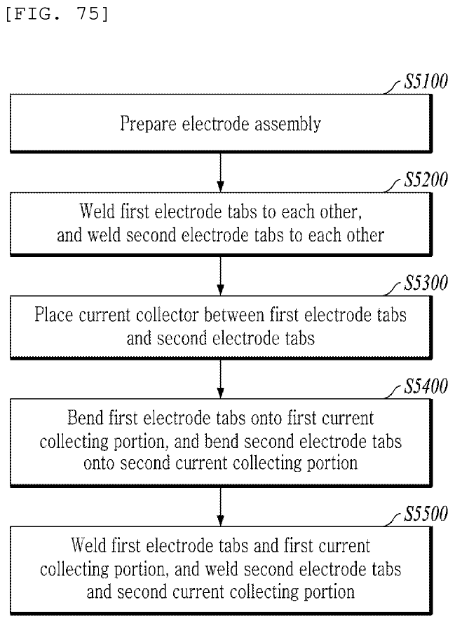

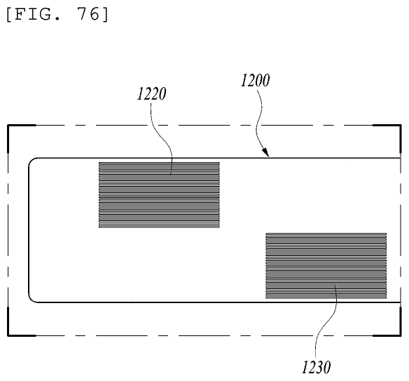

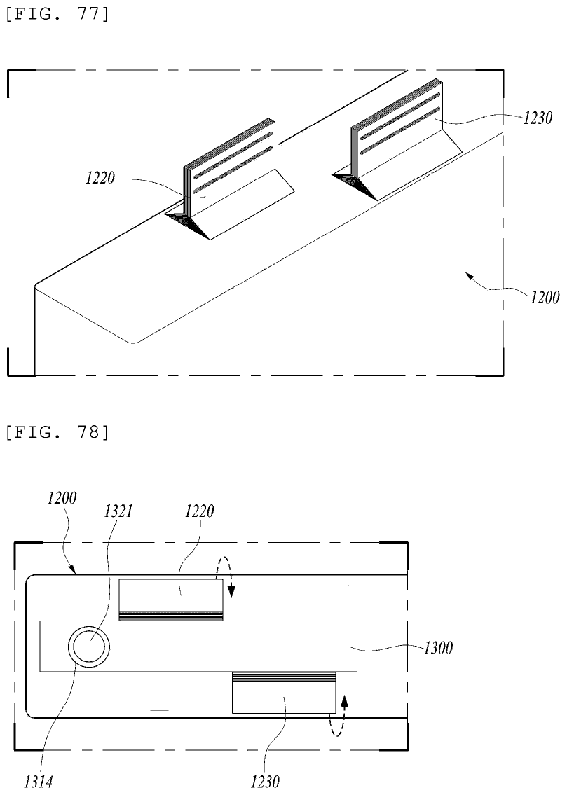

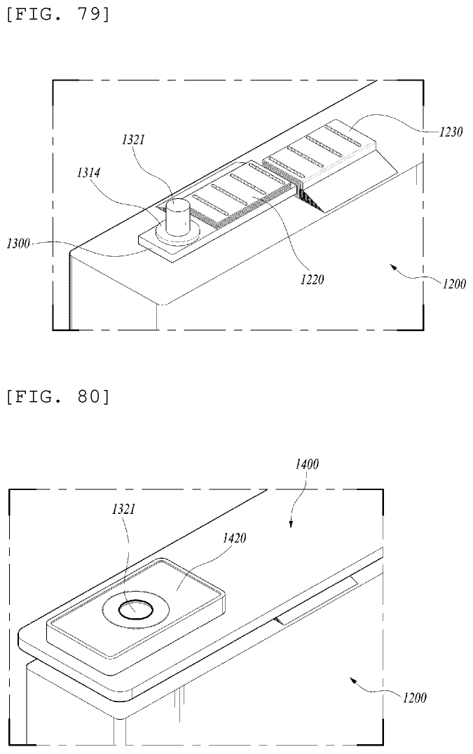

FIG. 75 is a flowchart illustrating a method of manufacturing the secondary battery according to the first aspect of the present disclosure. FIG. 76 is a top plan view of a portion of an electrode assembly illustrating the plurality of first electrode tabs and the plurality of second electrode tabs that are separately grouped in the secondary battery according to the first aspect of the present disclosure. FIG. 77 is a perspective view of a portion of an electrode assembly illustrating the plurality of first electrode tabs that are primarily welded and the plurality of second electrode tabs that are primarily welded in the secondary battery according to the first aspect of the present disclosure. FIG. 78 is a top plan view illustrating the current collector disposed between the plurality of first electrode tabs that are primarily welded and the plurality of second electrode tabs that are primarily welded in the secondary battery according to the first aspect of the present disclosure. FIG. 79 is a perspective view illustrating the first and second electrode tabs welded to the current collector in the secondary battery according to the first aspect of the present disclosure. FIG. 80 is a perspective view illustrating the cap assembly coupled to the electrode assembly in the secondary battery according to the first aspect of the present disclosure.

As illustrated in FIG. 75, in order to manufacture a secondary battery according to the first aspect of the present disclosure, the electrode assembly is prepared (S5100). The electrode assembly 1200 includes the electrode portion 1210, and the plurality of first electrode tabs 1220 and the plurality of second electrode tabs 1230 that are formed at one end of the electrode portion.

The plurality of first electrode tabs 1220 and the plurality of second electrode tabs 1230 are disposed at one end of the electrode portion 1210. When the plurality of electrode elements that form the electrode portion are stacked, the plurality of first electrode tabs 1220 overlap each other at the first position, and the plurality of second electrode tabs 1230 overlap each other at the second position. That is, the plurality of first electrode tabs 1220 are grouped at the first position, and the plurality of second electrode tabs 1230 are grouped at the second position. The first position and the second position are spaced apart from each other on the electrode elements, and the plurality of first electrode tabs 1220 that are grouped and the plurality of second electrode tabs 1230 that are grouped may be spaced apart from each other in the width direction and the longitudinal direction of the electrode assembly 1200. As illustrated in FIG. 76, the plurality of first electrode tabs 1220 that are grouped may be disposed at one end of the electrode assembly 1200 in the width direction, and the plurality of second electrode tabs 1230 that are grouped may be disposed at a remaining end of the electrode assembly 1200 in the width direction.

Next, the plurality of first electrode tabs 1220 are welded to each other, and the plurality of second electrode tabs 1230 are welded to each other (S5200). The plurality of first electrode tabs 1220 and the plurality of second electrode tabs 1230 are aligned to be spaced apart from each other in the longitudinal direction of the electrode assembly 1200. The plurality of electrode tabs that are grouped and aligned are primarily welded such that the first electrode tabs 1220 are welded to each other and the second electrode tabs 1230 are welded to each other (see FIG. 77).

The current collector 1300 is disposed between the plurality of first electrode tabs 1220 and the plurality of second electrode tabs 1230 that are primarily welded (S5300). In order to connect the plurality of electrode tabs 1220 and 1230 to the current collector 1300, in the present aspect, the electrode tabs 1220 and 1230 having the same polarity are divided into two groups and welded to the current collector 1300.

At the one end of the electrode portion 1210, a space is formed between the plurality of first electrode tabs 1220 and the plurality of second electrode tabs 1230 that are primarily welded. In order to facilitate placement of the current collector 1300, the plurality of first electrode tabs 1220 that are welded and the plurality of second electrode tabs 1230 that are welded may be respectively bent toward outer sides of the electrode assembly 1200. The current collector 1300 is placed between the first electrode tabs 1220 and the second electrode tabs 1230.

The first electrode tabs 1220 and the second electrode tabs 1230 are each bent toward the upper surface of the current collector 1300 (S5400). The plurality of first electrode tabs 1220 are bent toward an upper surface of the first current collecting portion 1311 of the current collector 1300. The plurality of second electrode tabs 1230 are bent toward an upper surface of the second current collecting portion 1312 of the current collector 1300. The plurality of first electrode tabs 1220 and the plurality of second electrode tabs 1230 are bent in opposite directions.

The current collector 1300 is welded to the first and second electrode tabs 1220 and 1230 placed on the current collector 1300 (S5500). The plurality of first electrode tabs 1220 are welded to the first current collecting portion 1311, and the plurality of second electrode tabs 1230 are welded to the second current collecting portion 1312. The welding may be performed from above the plurality of first electrode tabs 1220 and the plurality of second electrode tabs 1230. The welding may be performed using ultrasonic welding, laser welding, or the like.

During welding, in the first current collecting portion 1311 of the current collector 1300, the welding may be performed toward the first current collecting portion 1311 from the plurality of first electrode tabs 1220. In the second current collecting portion 1312 of the current collector 1300, the welding may be performed toward the second current collecting portion 1312 from the plurality of second electrode tabs 1230.

In the present aspect, after the plurality of electrode tabs are primarily welded such that the first electrode tabs 1220 are welded to each other and the second electrode tabs 1230 are welded to each other, the electrode tabs are welded to the current collector 1300. However, in other aspects, the plurality of electrode tabs 1220 and 1230 may be bent onto and directly welded to the current collector 1300 without performing the primary welding.

The electrode assembly 1200 to which the current collector 1300 is welded is accommodated in the casing 1100. The cap assembly 1400 seals the opening of the casing 1100. As illustrated in FIG. 80, after the current collecting protrusion 1321 is inserted into the through hole of the terminal 1420 of the cap assembly 1400, the outer circumferential surface of the end of the current collecting protrusion 1321 may be welded to the inner circumferential surface of the end of the through hole.

Conventionally, in the case where the current collector is welded to upper portions of the electrode tabs, the current collector is required to be relatively thin to transmit heat to the electrode tabs located under the current collector, thus leading to deterioration in durability. However, according to the present disclosure, since the plurality of electrode tabs are bent onto and welded to the current collector, a sufficient thickness of the current collector may be secured, and the electrode tabs may be more efficiently welded to the current collector.

Furthermore, in the present disclosure, since the plurality of electrode tabs having the same polarity are divided into two groups and welded, the electrode tabs may be stably welded without any unwelded portions.

According to the present disclosure, because electrode tabs are positioned on the current collector 1300 and welding is performed from above the electrode tabs, the current collector 1300 may have a relatively large thickness, and a risk of damage to the separators provided in the electrode portion may be reduced. Accordingly, durability of the secondary battery may also be improved.

A battery module may be configured by including a plurality of secondary batteries according to an aspect of the preset disclosure. The plurality of secondary batteries may be connected to each other by a bus bar or the like to configure the battery module. In addition, a battery pack may be configured by including a plurality of battery modules. The battery pack may be configured by disposing the plurality of battery modules in an upper pack housing and a lower pack housing constituting a pack housing. In addition, the battery pack may be provided in a vehicle that transports or moves loads or people, or that moves while performing operations. Such a vehicle may include bicycles, heavy equipment, agricultural and fishery equipment, automobiles, buses, and airplanes. Here, the automobile may be an electric vehicle, a hybrid vehicle, or a plug-in hybrid vehicle. The automobile may include a four-wheel automobile or a two-wheel automobile. The vehicle may operate by receiving power from the battery pack.

A secondary battery according to an aspect of the present disclosure may be configured such that welding of electrode tabs to a current collector does not affect an electrode assembly.

In addition, the secondary battery according to an aspect of the present disclosure may be configured such that a large number of electrode tabs may be stably welded to the current collector when the electrode tabs and the current collector are welded.

Furthermore, the secondary battery according to an aspect of the present disclosure may be configured such that a current collecting protrusion may be stably coupled to the current collector.

In addition, the secondary battery according to an aspect of the present disclosure may be configured such that an assembly process may be simplified.

While the present disclosure has been described with respect to the specific aspects, it will be apparent to those skilled in the art that various changes or modifications of the present disclosure are possible by adding, changing, or deleting components without departing from the spirit of the present disclosure as defined in the following claims. It should be noted that these changes or modifications also fall within the scope of the present disclosure.

1. A secondary battery comprising:
an electrode assembly comprising at least one electrode tab extending outwardly therefrom;
a current collector electrically coupled to the at least one electrode tab; and
a casing receiving the electrode assembly and the current collector therein,
wherein the current collector comprises: a current collecting unit and a pole unit coupled together,
wherein the current collecting unit comprises a plate having an opening therein,
wherein the pole unit comprises: a current collecting protrusion; and a support portion coupled to an end of the current collecting protrusion,
wherein the current collecting protrusion extends away from the support portion along a central axis of the pole unit,
wherein a cross-sectional area of the support portion is greater than a cross-sectional area of the current collecting protrusion along a plane perpendicular to the central axis, and
wherein the support portion is at least partially accommodated in the opening and secured within the opening by a welding region disposed between a periphery of the support portion and a perimeter of the opening.

2. The secondary battery according to claim 1, wherein the welding region is disposed along an entirety of the perimeter of the opening.

3. The secondary battery according to claim 1, wherein the opening defines a through hole extending through the current collecting unit.

4. The secondary battery according to claim 3, wherein the opening communicates with a recessed region defined in a lower surface of the current collecting unit, the recessed region having a larger cross-sectional area along a plane perpendicular to the central axis than the opening.

5. The secondary battery according to claim 4, wherein the support portion is at least partially accommodated within the recessed region.

6. The secondary battery according to claim 4, wherein the support portion is fully accommodated within the recessed region.

7. The secondary battery according to claim 4, wherein a depth of the recessed region ranges from 30% to 50% of a height of the plate of the current collecting unit.

8. The secondary battery according to claim 1, wherein the opening defines a blind hole terminating within the current collecting unit.

9. The secondary battery according to claim 1, wherein the current collector further comprises a stopper adjacent to the opening, the stopper having an upper surface spaced above an upper surface of the plate along an axial direction parallel to the central axis of the pole unit.

10. The secondary battery according to claim 9, wherein the stopper is a portion of the current collector unit.

11. The secondary battery according to claim 10, wherein the upper surface of the stopper is provided by an upper surface of a portion of the current collecting unit that circumscribes the opening.

12. The secondary battery according to claim 10, wherein an upper surface of the stopper is flush with an upper surface of the support portion.

13. The secondary battery according to claim 10,
wherein the opening defines a through hole extending through the current collecting unit, the opening communicating with a recessed region defined in a lower surface of the current collecting unit, the recessed region having a larger cross-sectional area along a plane perpendicular to the central axis than the opening, and
wherein a cross-sectional area of the recessed region is smaller than a cross-sectional area of the stopper.

14. The secondary battery according to claim 13, wherein a depth of the recessed region is equal to or greater than a height of an end of the current collecting unit.

15. The secondary battery according to claim 13, wherein a lower surface of the support portion is positioned above the lower surface of the current collecting unit.

16. The secondary battery according to claim 9 wherein the stopper is a portion of the pole unit.

17. The secondary battery according to claim 16, wherein the upper surface of the stopper is provided by an upper surface of the support portion.

18. The secondary battery according to claim 16, wherein the stopper is disposed between the current collecting protrusion and the support portion, wherein a cross-sectional area of the stopper is greater than a cross-sectional area of the protrusion portion and different than the cross-sectional area of the support portion along a plane perpendicular to the central axis.

19. The secondary battery according to claim 1, wherein a lower surface of the current collecting unit is flush with a lower surface of the support portion.

20. The secondary battery according to claim 1, wherein a nickel plating layer is formed on an upper end of the current collecting protrusion.

21. The secondary battery according to claim 1, wherein the current collecting unit further comprises: a first current collecting portion; a second current collecting portion; and a connection portion,
wherein the first current collecting portion is coupled to a plurality of first electrode tabs,
wherein the second current collecting portion is coupled to a plurality of second electrode tabs, and
wherein the connection portion is connected to the first current collecting portion and includes the opening.

22. The secondary battery according to claim 21,
wherein the plurality of first electrode tabs are bent toward an upper surface of the first current collecting portion, and the plurality of second electrode tabs are bent toward an upper surface of the second current collecting portion in a direction opposite to a direction in which the plurality of first electrode tabs are bent, and
wherein a separation distance between the plurality of first electrode tabs and the plurality of second electrode tabs is 5% to 15% of a length of the current collector.
